(19) United States
(12) Patent Application Publication
(10) Pub. No.: US 2026/0267245 A1
(43) Pub. Date: Sep. 10, 2026

(54) COMPOSITION FOR IMAGE RECORDING AND METHOD OF PRODUCING THE SAME

(71) Applicant: CANON KABUSHIKI KAISHA, Tokyo (JP)

(72) Inventors: TETSUYA KOSUGE, Kanagawa (JP); MAYU HARADA, Tokyo (JP); TAKESHI OTA, Kanagawa (JP); HIROMITSU KISHI, Kanagawa (JP); KENTA OHTSUKA, Kanagawa (JP)

(21) Appl. No.: 19/666,005

(22) Filed: May 1, 2026

Related U.S. Application Data
(63) Continuation of application No. PCT/JP2024/039580, filed on Nov. 7, 2024.

(30) Foreign Application Priority Data
Nov. 8, 2023 (JP) 2023-191075
Nov. 8, 2023 (JP) 2023-191077
Nov. 6, 2024 (JP) 2024-194366

(51) Int. Cl. G03G 5/06; C09B 67/20; C09D 11/322; C09D 11/38

(52) U.S. Cl. CPC G03G 5/0677; C09B 67/0065; C09D 11/322; C09D 11/38

(57) ABSTRACT

A composition for image recording, which is capable of recording an image having high color developability and high chroma, and is excellent in storage stability. The composition for image recording includes a pigment composition containing a yellow monoazo pigment and a compound represented by the general formula (1-1) or (2-1) different from the yellow monoazo pigment.

### CROSS-REFERENCE TO RELATED APPLICATIONS

This application is a Continuation of International Patent Application No. PCT/JP2024/039580, filed Nov. 7, 2024, which claims the benefit of Japanese Patent Application No. 2023-191077, filed Nov. 8, 2023, Japanese Patent Application No. 2023-191075, filed Nov. 8, 2023, and Japanese Patent Application No. 2024-194366, filed Nov. 6, 2024, all of which are hereby incorporated by reference herein in their entirety.

### BACKGROUND

### Field of the Technology

The present disclosure relates to a composition for image recording and a method of producing the same.

### Description of the Related Art

A pigment has heretofore been widely used as a coloring material for image recording, such as ink jet recording, electrophotography, and thermal transfer recording, from the viewpoint of fastness. In addition, a yellow azo pigment has been widely used as a yellow pigment. It is known that when the yellow azo pigment is micronized by a method such as solvent salt milling, heat resistance and light resistance are improved in addition to various physical properties, such as color developability, a color tone, a coloring power, and transparency. In particular, in the case of an ink for ink jet, various characteristics are remarkably improved by micronizing the pigment.

When the yellow azo pigment is micronized, a pigment derivative (synergist) having a similar chemical structure is sometimes used in combination with the pigment in order to suppress the crystal growth of the pigment. As the pigment derivative, for example, it has been proposed to use a monoazo compound having various substituents, such as an alkyl group and a sulfonic acid group (Japanese Patent Laid-Open No. H05-70725). In addition, it has been proposed to use, as the pigment derivative, a monoazo compound in which an N-phenylcarbamoyl group is introduced into the diazo side (Japanese Patent Laid-Open No. 2010-260997). In addition, it has been proposed to use, as a pigment derivative to be added to a disazo pigment, a monoazo compound having a substituent, such as an alkoxy group or a halogen (Japanese Patent Laid-Open No. S57-126856).

The inventors have made investigations on micronizing a yellow monoazo pigment in the presence of a pigment derivative. As a result, it has been found that when a pigment derivative in which the kind and substitution position of a substituent are not optimized is used, the pigment is insufficiently micronized, or a pigment particle is liable to be grown by treatment such as heating, and hence it becomes difficult to maintain its particle diameter. It has been found that when a pigment which is insufficiently micronized or whose particle is liable to grow is used, the color developability and transparency of an image to be recorded are lowered, and its color tone is liable to be changed. Thus, the quality of the image is easily lowered. In particular, in the case of an ink for ink jet, it has been found that when an insufficiently micronized pigment is used, the color developability and chroma of an image are remarkably lowered.

In addition, the inventors have prepared a pigment composition using a pigment micronized in the presence of the pigment derivative proposed in Japanese Patent Laid-Open No. H05-70725 and Japanese Patent Laid-Open No. 2010-260997, and have made investigations on an image recorded with an ink for ink jet containing the pigment composition. As a result, it has been found that the pigment is insufficiently micronized, and hence the color developability and chroma of the image to be recorded are lowered, and the particle diameter of the pigment in the ink after its storage increases.

### SUMMARY

Accordingly, the present disclosure is directed to providing a composition for image recording, which is capable of recording an image having high color developability and high chroma, and is excellent in storage stability. The present disclosure is also directed to providing a method of producing a composition for image recording, which is capable of recording an image having high color developability and high chroma, and is excellent in storage stability.

The above-mentioned composition and method are provided by the present disclosure described below.

That is, according to the present disclosure, there is provided a composition for image recording including a pigment composition containing a yellow monoazo pigment and a compound represented by the following general formula (1-1) or (2-1) different from the yellow monoazo pigment:

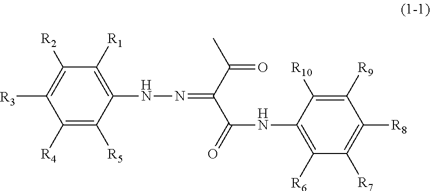

in the general formula (1-1), R₁ to R₁₀ each independently represent a hydrogen atom, an alkyl group, a halogenated alkyl group, an alkoxy group, an acyl group, a halogen atom, a nitro group, an alkoxycarbonyl group, or an acyloxy group, provided that R₃ or R₄ represents a substituent represented by the following general formula (1-2):

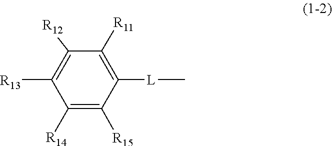

in the general formula (1-2), L represents a single bond, an ether bond (—O—), an ester bond (—O—C(═O)— or —C(═O)—O—), or a carbonyl group (—C(═O)—), and R₁₁ to R₁₅ each independently represent a hydrogen atom, an alkyl group, a halogenated alkyl group, an alkoxy group, a halogen atom, or a nitro group; and

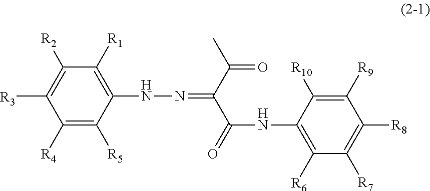

in the general formula (2-1), R₁ to R₅ each independently represent a hydrogen atom, an alkoxy group, or a halogen atom, provided that not more than one of R₁, R₃, and R₄ represents a hydrogen atom. And R₆ to R₁₀ each independently represent a hydrogen atom, an alkyl group, a halogenated alkyl group, an alkoxy group, an acyl group, a halogen atom, a nitro group, an alkoxycarbonyl group, or an acyloxy group, provided that R₆ does not represent a hydrogen atom.

Features of the present disclosure will become apparent from the following description of embodiments.

### DESCRIPTION OF THE EMBODIMENTS

The present disclosure is described in more detail below by way of exemplary embodiments. In the present disclosure, an ink for ink jet is sometimes simply referred to as “ink”. The “unit” of a resin refers to the minimum repeating unit for forming the resin, and means a structure formed by (co)polymerization of one monomer. Physical property values are values at normal temperature (25° C.) unless otherwise stated.

The inventors have made investigations on the reason why a yellow monoazo pigment is difficult to sufficiently micronize when the yellow monoazo pigment is micronized in the presence of a pigment derivative. As a result, it has been found that when a pigment derivative in which the kind and substitution position of a substituent are not optimized is used, the pigment derivative is not effectively adsorbed onto the particle (crystal) surface of the yellow monoazo pigment, and hence the suppression of crystal growth becomes insufficient.

In general, in order to minimize the total interfacial energy between the particle surface of a pigment and a medium in the entire system, a pigment particle grows by Ostwald ripening in which a particle grows so that the specific surface area in the entire system is minimized, the particle diameter increases, and a coarse particle is formed. At this time, it is known that a new pigment molecule is adsorbed onto a step or a kink position on the crystal surface of the pigment and incorporated into the crystal, and hence crystal growth proceeds. In addition, when a pigment derivative (synergist) is present at this time, a molecule of the pigment derivative is adsorbed onto the crystal surface and incorporated, and further adsorption of a pigment molecule is inhibited in the vicinity thereof. It is conceived that the growth rate of a particle is thus reduced and the crystal growth is suppressed.

In consideration of such mechanism as described above, the inventors have made investigations on the structure of the pigment derivative in order to significantly reduce the rate of the crystal growth to improve a crystal growth-suppressing effect. As a result, it has been found that the following two characteristics of the pigment derivative are important: an adsorption ability and an adsorption inhibitory property. The above-mentioned two characteristics are described below by taking as an example a case in which a yellow monoazo pigment is used as a pigment and a derivative of the yellow monoazo pigment is used as a pigment derivative.

### (i) Adsorption Ability

The adsorption ability of the pigment derivative means high affinity between the pigment derivative and the crystal surface of the pigment. As the affinity between the two becomes higher, the adsorption ability of the pigment derivative to the crystal surface of the pigment increases, and hence the pigment derivative easily adsorbs to the crystal surface of the pigment. The high affinity between the pigment derivative and the crystal surface of the pigment may be predicted by molecular orbital calculation using density functional theory. Specifically, the energy (E₁) of a system formed only of a pigment crystal, the energy (E₂) of a system formed only of one molecule of the pigment derivative, and the energy (E₁₊₂) of a mixed system in which one molecule of the pigment derivative is adsorbed onto the pigment crystal surface at the most stable distance are calculated. Then, as the value of E₁₊₂−(E₁+E₂) becomes smaller (the negative absolute value becomes larger), the interaction between the pigment derivative and the crystal surface of the pigment becomes stronger, and hence the affinity between the two increases. That is, the absolute value of E₁₊₂−(E₁+E₂) is adsorption stabilization energy obtained when the pigment derivative is adsorbed onto the particle surface of the pigment. The adsorption state is more stabilized as the absolute value of E₁₊₂−(E₁+E₂) becomes larger, and hence the pigment derivative is more easily adsorbed onto the crystal surface of the pigment.

In order to increase the adsorption ability of the pigment derivative, the above-mentioned adsorption stabilization energy may be increased, and a substituent that electronically interacts with the crystal surface of the pigment may be introduced into the molecule of the pigment derivative. As a result of investigations, the inventors have found that it is important to use a compound represented by the general formula (1-1) or (2-1) as a pigment derivative. Specifically, it has been found that when the pigment derivative is a compound represented by the general formula (1-1), the adsorption stabilization energy is increased by introducing a substituent having a phenyl group into a benzene ring on a diazonium side. It is conceived that when the substituent having a phenyl group is introduced, a π-conjugated plane capable of π-π interaction with the crystal surface of the pigment is expanded in the molecule of the pigment derivative.

Examples of the bulky substituent having a benzene ring such as a phenyl group may include a phenyl group, a phenoxy group, a phenoxycarbonyl group, a benzoyloxy group, a benzoyl group, an N-phenylcarbamoyl group, and a benzoylamino group. Of those, an N-phenylcarbamoyl group and a benzoylamino group each have an amide bond (—NH—C(═O)—) as a linking group, and hence an amide moiety is also present in the molecule of the pigment derivative into which each of those substituents is introduced. However, when the amide moiety is present in the molecule of the pigment derivative, hydrogen bonding occurs between molecules of the pigment derivative, and the interaction between molecules of the pigment derivative becomes strong. For this reason, it is not necessarily preferred for enhancing the interaction with the crystal surface of the pigment. Accordingly, as the bulky substituent having a benzene ring such as a phenyl group, a phenyl group, a phenoxy group, a phenoxycarbonyl group, a benzoyloxy group, and a benzoyl group each having no amide bond are each preferred.

In addition, it has been found that when the pigment derivative is a compound represented by the general formula (2-1), the adsorption stabilization energy is increased by introducing an alkoxy group and a halogen atom into a benzene ring on a diazonium side. It is conceived that when an alkoxy group and a halogen atom each having a characteristic electron density environment are introduced, a strong electronic interaction with the crystal surface of the pigment occurs, and the adsorption stabilization energy increases. It is also conceived that when an alkoxy group and a halogen atom are introduced, the π-electron environment of the benzene ring on the diazonium side of the pigment derivative is affected, and a strong π-π interaction with the crystal surface of the pigment occurs, and hence the adsorption stabilization energy increases.

### (ii) Adsorption Inhibitory Property

The pigment derivative adsorbed onto the crystal surface of the pigment inhibits further adsorption of the pigment to the vicinity of the adsorbed portion, that is, to an adjacent crystal lattice point, and reduces the crystal growth rate. It is conceived that the substituent introduced into the molecule of the pigment derivative sterically repels a pigment molecule approaching an adjacent crystal lattice point owing to its steric bulkiness, and inhibits the pigment molecule from adsorbing to an adjacent crystal lattice point and crystallizing. A significant reduction in crystal growth rate is expected by enhancing such adsorption inhibitory property, and hence it is conceived that the steric repulsion to be generated at the adjacent crystal lattice point only needs to be increased. It is clear from the molecular arrangement in the crystal structure of the pigment that the degree of steric repulsion to be generated at an adjacent crystal lattice point greatly depends on the position of the substituent on the molecule of the pigment derivative in addition to the steric bulkiness of the substituent. That is, when the position of the substituent on the molecule of the pigment derivative is adjusted, it is possible to effectively cause steric repulsion with a pigment molecule trying to adsorb to an adjacent crystal lattice point.

As a result of investigations, the inventors have found that it is effective to introduce a substituent into the benzene ring on the diazonium side of the pigment derivative, particularly at the para-position and meta-position of a hydrazone or an azo moiety. In the case of the compound represented by the general formula (1-1), it is conceived that an effective adsorption inhibitory property can be imparted to the pigment derivative by introducing a bulky substituent having a benzene ring such as a phenyl group into a predetermined position serving as a steric repulsion imparting group. In addition, in the case of the compound represented by the general formula (2-1), it has been found that it is further effective to introduce a steric repulsion imparting group into a benzene ring on a coupler side, particularly at the ortho-position of an amide moiety.

Based on the above-mentioned considerations, the inventors have made various investigations on the pigment derivative capable of suppressing the crystal growth of the yellow monoazo pigment. As a result, the inventors have found that the crystal growth of the yellow monoazo pigment can be significantly suppressed by using a compound represented by the following general formula (1-1) or (2-1) as the pigment derivative, and thus have reached the present disclosure.

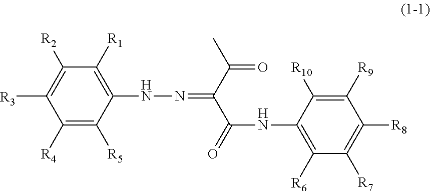

In the general formula (1-1), R₁ to R₁₀ each independently represent a hydrogen atom, an alkyl group, a halogenated alkyl group, an alkoxy group, an acyl group, a halogen atom, a nitro group, an alkoxycarbonyl group, or an acyloxy group, provided that R₃ or R₄ represents a substituent represented by the following general formula (1-2).

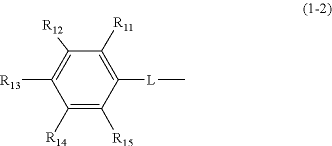

In the general formula (1-2), L represents a single bond, an ether bond (—O—), an ester bond (—O—C(═O)— or —C(═O)—O—), or a carbonyl group (—C(═O)—), and R₁₁ to R₁₅ each independently represent a hydrogen atom, an alkyl group, a halogenated alkyl group, an alkoxy group, a halogen atom, or a nitro group.

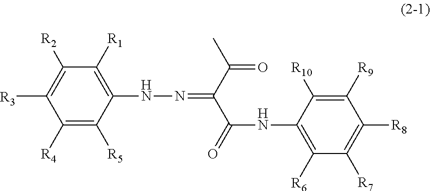

In the general formula (2-1), R₁ to R₅ each independently represent a hydrogen atom, an alkoxy group, or a halogen atom, provided that not more than one of R₁, R₃, and R₄ represents a hydrogen atom. And R₆ to R₁₀ each independently represent a hydrogen atom, an alkyl group, a halogenated alkyl group, an alkoxy group, an acyl group, a halogen atom, a nitro group, an alkoxycarbonyl group, or an acyloxy group, provided that R₆ does not represent a hydrogen atom.

As shown in the general formula (1-1), a bulky substituent capable of increasing the adsorption ability to the crystal surface of the pigment is introduced onto the benzene ring on the diazonium side. Further, the substituent is introduced at the para-position (R₃) or meta-position (R₄) of a hydrazone or an azo moiety, and hence the adsorption inhibitory property is improved. Accordingly, the use of the compound represented by the general formula (1-1) as the pigment derivative in combination with the yellow monoazo pigment can suppress the crystal growth of the yellow monoazo pigment, and hence can provide a composition for image recording, which is capable of recording an image having high color developability and high chroma, and is excellent in storage stability.

In addition, as shown in the general formula (2-1), the alkoxy group or the halogen atom capable of increasing the adsorption ability to the yellow monoazo pigment is introduced onto the benzene ring on the diazonium side. In addition, such alkoxy group or halogen atom is introduced at the para-position (R₃) or meta-position (R₄) of the benzene ring on the diazonium side, and hence an inhibiting effect on the adsorption of the yellow monoazo pigment to an adjacent crystal lattice point (adsorption inhibitory property) is excellent. In addition, a substituent except the hydrogen atom is introduced at the ortho-position (R₆) of the benzene ring on the coupler side, and hence the adsorption inhibitory property is more excellent. As described above, the use of the compound represented by the general formula (2-1) as the pigment derivative in combination with the yellow monoazo pigment can suppress the crystal growth of the yellow monoazo pigment, and hence can provide a composition for image recording, which is capable of recording an image having high color developability and high chroma, and is excellent in storage stability.

### <Composition for Image Recording>

The composition for image recording of the present disclosure is an image recording agent to be suitably used for image recording, such as ink jet recording, electrophotography, and thermal transfer recording, the agent including a pigment composition. The pigment composition contains a yellow monoazo pigment and a compound represented by the following general formula (1-1) or (2-1) different from the yellow monoazo pigment. More specifically, the composition for image recording of the present disclosure is a composition that may be used as an image recording agent, such as an ink for ink jet or a toner for electrophotography, by incorporating thereinto an appropriate component, such as a resin, an additive, a carrier, or a solvent. Components for forming the composition for image recording of the present disclosure and the like are described in detail below.

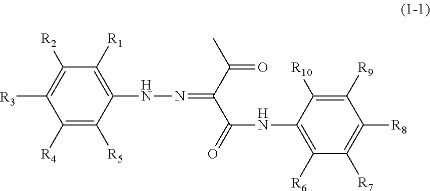

In the general formula (1-1), R₁ to R₁₀ each independently represent a hydrogen atom, an alkyl group, a halogenated alkyl group, an alkoxy group, an acyl group, a halogen atom, a nitro group, an alkoxycarbonyl group, or an acyloxy group, provided that R₃ or R₄ represents a substituent represented by the following general formula (1-2).

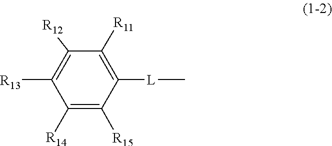

In the general formula (1-2), L represents a single bond, an ether bond (—O—), an ester bond (—O—C(═O)— or —C(═O)—O—), or a carbonyl group (—C(═O)—), and R₁₁ to R₁₅ each independently represent a hydrogen atom, an alkyl group, a halogenated alkyl group, an alkoxy group, a halogen atom, or a nitro group.

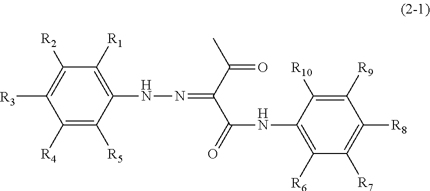

In the general formula (2-1), R₁ to R₅ each independently represent a hydrogen atom, an alkoxy group, or a halogen atom, provided that not more than one of R₁, R₃, and R₄ represents a hydrogen atom. And R₆ to R₁₀ each independently represent a hydrogen atom, an alkyl group, a halogenated alkyl group, an alkoxy group, an acyl group, a halogen atom, a nitro group, an alkoxycarbonyl group, or an acyloxy group, provided that R₆ does not represent a hydrogen atom.

### (Yellow Monoazo Pigment)

The composition for image recording of the present disclosure includes the pigment composition containing the yellow monoazo pigment and the compound represented by the general formula (1-1) or (2-1) (pigment derivative) different from the yellow monoazo pigment. The yellow monoazo pigment is an acetoacetanilide-based monoazo pigment having one azo group or hydrazone group in a molecule thereof and exhibiting a yellow hue. Specific examples of the yellow monoazo pigment may include C.I. Pigment Yellow 1, C.I. Pigment Yellow 2, C.I. Pigment Yellow 3, C.I. Pigment Yellow 4, C.I. Pigment Yellow 5, C.I. Pigment Yellow 6, C.I. Pigment Yellow 9, C.I. Pigment Yellow 49, C.I. Pigment Yellow 65, C.I. Pigment Yellow 73, C.I. Pigment Yellow 74, C.I. Pigment Yellow 75, C.I. Pigment Yellow 97, C.I. Pigment Yellow 98, C.I. Pigment Yellow 111, C.I. Pigment Yellow 116, C.I. Pigment Yellow 130, C.I. Pigment Yellow 133, C.I. Pigment Yellow 169, and C.I. Pigment Yellow 203. Of those, C.I. Pigment Yellow 74 (PY74), which is excellent in hue and sharpness, is preferred as the yellow monoazo pigment.

The yellow monoazo pigment is typically synthesized by coupling a diazo component (a1) obtained by converting an aniline derivative into a diazonium salt and a coupler component (a2) that is an acetoacetanilide derivative. For example, C.I. Pigment Yellow 74 may be synthesized by coupling the diazo component (aa) obtained by converting 2-methoxy-4-nitroaniline into a diazonium salt and o-acetoacetanisidide (coupler component (a2)).

### (Compound Represented by General Formula (1-1) or (2-1))

The pigment composition to be used in the composition for image recording of the present disclosure contains a compound represented by the following general formula (1-1) or (2-1) (hereinafter also referred to as “pigment derivative”).

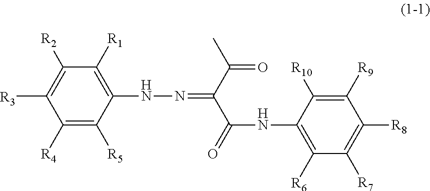

In the general formula (1-1), R₁ to R₁₀ each independently represent a hydrogen atom, an alkyl group, a halogenated alkyl group, an alkoxy group, an acyl group, a halogen atom, a nitro group, an alkoxycarbonyl group, or an acyloxy group, provided that R₃ or R₄ represents a substituent represented by the following general formula (1-2).

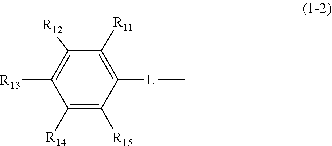

In the general formula (1-2), L represents a single bond, an ether bond (—O—), an ester bond (—O—C(═O)— or —C(═O)—O—), or a carbonyl group (—C(═O)—), and R₁₁ to R₁₅ each independently represent a hydrogen atom, an alkyl group, a halogenated alkyl group, an alkoxy group, a halogen atom, or a nitro group.

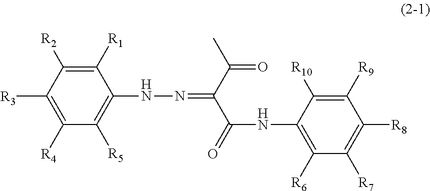

In the general formula (2-1), R₁ to R₅ each independently represent a hydrogen atom, an alkoxy group, or a halogen atom, provided that not more than one of R₁, R₃, and R₄ represents a hydrogen atom. And R₆ to R₁₀ each independently represent a hydrogen atom, an alkyl group, a halogenated alkyl group, an alkoxy group, an acyl group, a halogen atom, a nitro group, an alkoxycarbonyl group, or an acyloxy group, provided that R₆ does not represent a hydrogen atom.

Specific examples of the alkyl group represented by each of R₁ to R₁₅ in the general formula (1-1) may include a methyl group, an ethyl group, a n-propyl group, an i-propyl group, a n-butyl group, an i-butyl group, a sec-butyl group, a tert-butyl group, a n-pentyl group, an i-pentyl group, a sec-pentyl group, a neopentyl group, a n-hexyl group, a 2-ethylhexyl group, and a n-dodecyl group. Of those, a methyl group and an ethyl group are preferred, and a methyl group is more preferred.

Specific examples of the halogenated alkyl group represented by each of R₁ to R₁₅ in the general formula (1-1) may include a trifluoromethyl group, a trichloromethyl group, a pentafluoroethyl group, and a 2,2,2-trifluoroethyl group. Of those, a trifluoromethyl group is preferred.

Specific examples of the alkoxy group represented by each of R₁ to R₁₅ in the general formula (1-1) may include a methoxy group, an ethoxy group, a n-propoxy group, an i-propoxy group, a n-butoxy group, an i-butoxy group, a sec-butoxy group, a tert-butoxy group, a pentyloxy group, a hexyloxy group, and a (2-ethyl)hexyloxy group. Of those, a methoxy group and an ethoxy group are preferred, and a methoxy group is more preferred.

Specific examples of the halogen atom represented by each of R₁ to R₁₅ in the general formula (1-1) may include a fluorine atom, a chlorine atom, a bromine atom, and an iodine atom. Of those, a fluorine atom and a chlorine atom are preferred, and a chlorine atom is more preferred.

Specific examples of the acyl group represented by each of R₁ to R₁₀ in the general formula (1-1) may include an acetyl group, a propanoyl group, a butanoyl group, a tert-butanoyl group, a pentanoyl group, a hexanoyl group, a (2-ethyl)hexanoyl group, a heptanoyl group, and an octanoyl group. Of those, an acetyl group is preferred.

Specific examples of the alkoxycarbonyl group represented by each of R₁ to R₁₀ in the general formula (1-1) may include a methoxycarbonyl group, an ethoxycarbonyl group, a n-propoxycarbonyl group, an i-propoxycarbonyl group, a n-butoxycarbonyl group, a tert-butoxycarbonyl group, a pentyloxycarbonyl group, a hexyloxycarbonyl group, a (2-ethyl)hexyloxycarbonyl group, a heptyloxycarbonyl group, and an octyloxycarbonyl group. Of those, a methoxycarbonyl group is preferred.

Specific examples of the acyloxy group represented by each of R₁ to R₁₀ in the general formula (1-1) may include a formyloxy group, an acetoxy group, a propanoyloxy group, a butanoyloxy group, a 2,2-dimethylpropanoyloxy group, a pentanoyloxy group, a hexanoyloxy group, a (2-ethyl)hexanoyloxy group, a heptanoyloxy group, and an octanoyloxy group. Of those, an acetoxy group is preferred.

In the general formula (1-2), L preferably represents a single bond or an ether bond (—O—). When L in the general formula (1-2) represents a single bond or an ether bond (—O—), a π-π interaction plane formed by the benzene ring on the diazonium side of the pigment derivative and the benzene ring in the general formula (1-2) becomes wider, and hence the adsorption ability to the crystal surface of the pigment can be further improved.

In the general formula (1-1), it is preferred that R₆ represent a methoxy group and R₇ to R₁₀ each represent a hydrogen atom because the adsorption ability and adsorption inhibitory property of the pigment derivative are further improved, and the crystal growth-suppressing effect becomes higher. Of those, C.I. Pigment Yellow 74 is preferably used as the yellow monoazo pigment because the crystal growth-suppressing effect becomes higher by virtue of the common structure on the coupler side.

In addition, specific examples of the alkoxy group represented by each of R₁ to R₁₀ in the general formula (2-1) may include a methoxy group, an ethoxy group, a n-propoxy group, an i-propoxy group, a n-butoxy group, an i-butoxy group, a sec-butoxy group, a tert-butoxy group, a pentyloxy group, a hexyloxy group, and a (2-ethyl)hexyloxy group. Of those, a methoxy group and an ethoxy group are preferred, and a methoxy group is more preferred.

Specific examples of the halogen atom represented by each of R₁ to R₁₀ in the general formula (2-1) may include a fluorine atom, a chlorine atom, a bromine atom, and an iodine atom. Of those, a fluorine atom and a chlorine atom are preferred, and a chlorine atom is more preferred.

Specific examples of the alkyl group represented by each of R₆ to R₁₀ in the general formula (2-1) may include a methyl group, an ethyl group, a n-propyl group, an i-propyl group, a n-butyl group, an i-butyl group, a sec-butyl group, a tert-butyl group, a n-pentyl group, an i-pentyl group, a sec-pentyl group, a neopentyl group, a n-hexyl group, a 2-ethylhexyl group, and a n-dodecyl group. Of those, a methyl group and an ethyl group are preferred, and a methyl group is more preferred.

Specific examples of the halogenated alkyl group represented by each of R₆ to R₁₀ in the general formula (2-1) may include a trifluoromethyl group, a trichloromethyl group, a pentafluoroethyl group, and a 2,2,2-trifluoroethyl group. Of those, a trifluoromethyl group is preferred.

Specific examples of the acyl group represented by each of R₆ to R₁₀ in the general formula (2-1) may include an acetyl group, a propanoyl group, a butanoyl group, a tert-butanoyl group, a pentanoyl group, a hexanoyl group, a (2-ethyl)hexanoyl group, a heptanoyl group, and an octanoyl group. Of those, an acetyl group is preferred.

Specific examples of the alkoxycarbonyl group represented by each of R₆ to R₁₀ in the general formula (2-1) may include a methoxycarbonyl group, an ethoxycarbonyl group, a n-propoxycarbonyl group, an i-propoxycarbonyl group, a n-butoxycarbonyl group, a tert-butoxycarbonyl group, a pentyloxycarbonyl group, a hexyloxycarbonyl group, a (2-ethyl)hexyloxycarbonyl group, a heptyloxycarbonyl group, and an octyloxycarbonyl group. Of those, a methoxycarbonyl group is preferred.

Specific examples of the acyloxy group represented by each of R₆ to R₁₀ in the general formula (2-1) may include a formyloxy group, an acetoxy group, a propanoyloxy group, a butanoyloxy group, a 2,2-dimethylpropanoyloxy group, a pentanoyloxy group, a hexanoyloxy group, a (2-ethyl)hexanoyloxy group, a heptanoyloxy group, and an octanoyloxy group. Of those, an acetoxy group is preferred.

In the general formula (2-1), it is preferred that R₆ represent a methoxy group and R₇ to R₁₀ each represent a hydrogen atom because the adsorption ability and adsorption inhibitory property of the pigment derivative are further improved, and the crystal growth-suppressing effect becomes higher. Of those, C.I. Pigment Yellow 74 is preferably used as the yellow monoazo pigment because the crystal growth-suppressing effect becomes higher by virtue of the common structure on the coupler side.

In addition, in the general formula (2-1), it is preferred that R₁ represent a methoxy group, R₃ and R₄ each independently represent a methoxy group or a chlorine atom, and R₂ and R₅ each represent a hydrogen atom. This is because the adsorption ability and adsorption inhibitory property of the pigment derivative are further improved, and the crystal growth-suppressing effect is further enhanced.

The compound represented by the general formula (1-1) or (2-1) may be synthesized by, for example, the same method as in the case of the yellow monoazo pigment. That is, the compound may be synthesized by coupling a diazo component (b1) obtained by converting an aniline derivative into a diazonium salt and a coupler component (b2) that is an acetoacetanilide derivative.

Specific examples of the aniline derivative for obtaining the diazo component (b1) to be used in the synthesis of the compound represented by the general formula (1-1) may include 3-aminobiphenyl, 3-amino-4-methoxybiphenyl, 3-amino-4-ethoxybiphenyl, 3-amino-4-isopropoxybiphenyl, 3-amino-4-methylbiphenyl, 3-amino-4-ethylbiphenyl, 3-amino-4-fluorobiphenyl, 3-amino-4-chlorobiphenyl, 3-amino-4-(trifluoromethyl)biphenyl, 3-amino-4-nitrobiphenyl, 4-acetyl-3-aminobiphenyl, methyl 2-amino-4-phenylbenzoate, ethyl 2-amino-4-phenylbenzoate, 5-amino-2-chlorobiphenyl, 5-amino-2-methoxybiphenyl, 4-aminobiphenyl, 4-amino-3-methoxybiphenyl, 4-amino-3-ethoxybiphenyl, 4-amino-3-methylbiphenyl, 4-amino-3-ethylbiphenyl, 4-amino-3-fluorobiphenyl, 4-amino-3-chlorobiphenyl, 4-amino-3-(trifluoromethyl)biphenyl, 4-amino-3-nitrobiphenyl, 3-acetyl-4-aminobiphenyl, methyl 2-amino-5-phenylbenzoate, ethyl 2-amino-5-phenylbenzoate, 4-amino-2′-methoxybiphenyl, 4-amino-4′-nitrobiphenyl, 4-amino-4′-chlorobiphenyl, 4-phenoxyaniline, 4-amino-4′-methyldiphenyl ether, 4-amino-4′-chlorodiphenyl ether, 4-amino-4′-nitrodiphenyl ether, 4-amino-3-methyldiphenyl ether, 4-amino-3-(trifluoromethyl)diphenyl ether, 3-phenoxyaniline, 3-amino-4-methoxydiphenyl ether, 4-aminobenzophenone, 4-amino-4′-chlorobenzophenone, 4-amino-4′-fluorobenzophenone, 4′-amino-3,4-dimethylbenzophenone, 4-amino-3-nitrobenzophenone, 3-aminobenzophenone, 3′-amino-3,4-dimethylbenzophenone, phenyl 3-aminobenzoate, phenyl 4-aminobenzoate, 3-aminophenyl benzoate, and 4-aminophenyl benzoate.

Specific examples of the acetoacetanilide derivative for obtaining the coupler component (b2) to be used in the synthesis of the compound represented by the general formula (1-1) may include acetoacetanilide, o-acetoacetanisidide, m-acetoacetanisidide, p-acetoacetanisidide, 2′-ethoxyacetoacetanilide, 4′-ethoxyacetoacetanilide, 2′-isopropoxyacetoacetanilide, 2′-tert-butoxyacetoacetanilide, 2′,4′-dimethoxyacetoacetanilide, 2′,5′-dimethoxyacetoacetanilide, 2′-methylacetoacetanilide, 4′-methylacetoacetanilide, 2′,4′-dimethylacetoacetanilide, 2′-ethylacetoacetanilide, 2′-isopropylacetoacetanilide, 2′-n-butylacetoacetanilide, 4′-tert-butylacetoacetanilide, 5′-methyl-2′-methoxyacetoacetanilide, 5′-chloro-2′-methoxyacetoacetanilide, 4′-chloro-2′,5′-dimethoxyacetoacetanilide, 5′-chloro-2′,4′-dimethoxyacetoacetanilide, 2′-chloro-4′-methylacetoacetanilide, 2′-chloro-5′-methylacetoacetanilide, 4′-tert-butyl-2′-chloroacetoacetanilide, 4′-chloro-2′-methylacetoacetanilide, 2′-(trifluoromethyl)acetoacetanilide, 4′-(trifluoromethyl)acetoacetanilide, 2′-chloroacetoacetanilide, 3′-chloroacetoacetanilide, 4′-chloroacetoacetanilide, 2′,5′-dichloroacetoacetanilide, 2′,4′,5′-trichloroacetoacetanilide, 2′-nitroacetoacetanilide, 4′-nitroacetoacetanilide, 4′-chloro-2′-nitroacetoacetanilide, 4′-methoxy-2′-nitroacetoacetanilide, 2′-methoxy-4′-nitroacetoacetanilide, 3′-acetoxyacetoacetanilide, 4′-acetoxyacetoacetanilide, 4′-valeryloxyacetoacetanilide, 5′-acetoxy-2′-methoxyacetoacetanilide, 2′-acetylacetoacetanilide, 4′-acetylacetoacetanilide, 2′-propionylacetoacetanilide, 4′-acetyl-2′-methoxyacetoacetanilide, methyl 2-(acetoacetylamino)benzoate, methyl 3-(acetoacetylamino)benzoate, methyl 4-(acetoacetylamino)benzoate, ethyl 2-(acetoacetylamino)benzoate, butyl 2-(acetoacetylamino)benzoate, and methyl 3-(acetoacetylamino)-4-methoxybenzoate.

Specific examples of the aniline derivative for obtaining the diazo component (b1) to be used in the synthesis of the compound represented by the general formula (2-1) may include 4-chloro-2,5-dimethoxyaniline, 5-chloro-2,4-dimethoxyaniline, 2-chloro-4,5-dimethoxyaniline, 4,5-dichloro-2-methoxyaniline, 2,4,5-trichloroaniline, 2,4,5-trimethoxyaniline, 2,4-dimethoxyaniline, 2,5-dimethoxyaniline, 3,4-dimethoxyaniline, 2,4-dichloroaniline, 2,5-dichloroaniline, 3,4-dichloroaniline, 4-chloro-2-methoxyaniline, 4-bromo-2-methoxyaniline, 5-chloro-2-methoxyaniline, 2-chloro-4-methoxyaniline, 2-chloro-5-methoxyaniline, 2-fluoro-5-methoxyaniline, 2,5-diethoxyaniline, 2-methoxy-4-isopropoxyaniline, and 2-methoxy-4-isobutoxyaniline.

Specific examples of the acetoacetanilide derivative for obtaining the coupler component (b2) to be used in the synthesis of the compound represented by the general formula (2-1) may include o-acetoacetanisidide, 2′-ethoxyacetoacetanilide, 2′-isopropoxyacetoacetanilide, 2′-tert-butoxyacetoacetanilide, 2′,4′-dimethoxyacetoacetanilide, 2′,5′-dimethoxyacetoacetanilide, 2′-methylacetoacetanilide, 2′,4′-dimethylacetoacetanilide, 2′-ethylacetoacetanilide, 2′-isopropylacetoacetanilide, 2′-n-butylacetoacetanilide, 5′-methyl-2′-methoxyacetoacetanilide, 5′-chloro-2′-methoxyacetoacetanilide, 4′-chloro-2′,5′-dimethoxyacetoacetanilide, 5′-chloro-2′,4′-dimethoxyacetoacetanilide, 2′-chloro-4′-methylacetoacetanilide, 2′-chloro-5′-methylacetoacetanilide, 4′-tert-butyl-2′-chloroacetoacetanilide, 4′-chloro-2′-methylacetoacetanilide, 2′-trifluoromethylacetoacetanilide, 2′-chloroacetoacetanilide, 2′,5′-dichloroacetoacetanilide, 2′,4′,5′-trichloroacetoacetanilide, 2′-nitroacetoacetanilide, 4′-chloro-2′-nitroacetoacetanilide, 4′-methoxy-2′-nitroacetoacetanilide, 2′-methoxy-4′-nitroacetoacetanilide, 5′-acetoxy-2′-methoxyacetoacetanilide, 2′-methoxy-5′-valeryloxyacetoacetanilide, 2′-acetylacetoacetanilide, 2′-propionylacetoacetanilide, 4′-acetyl-2′-methoxyacetoacetanilide, methyl 2-(acetoacetylamino)benzoate, ethyl 2-(acetoacetylamino)benzoate, butyl 2-(acetoacetylamino)benzoate, and methyl 3-(acetoacetylamino)-4-methoxybenzoate.

The content (% by mass) of the compound represented by the general formula (1-1) or (2-1) in the composition for image recording is preferably 0.001 times or more and 0.100 times or less in terms of mass ratio with respect to the content (% by mass) of the yellow monoazo pigment. In addition, the content is more preferably 0.010 times or more and 0.070 times or less. When the above-mentioned mass ratio is less than 0.001 times, the crystal growth-suppressing effect may be insufficient. Meanwhile, when the above-mentioned mass ratio is more than 0.100 times, the color of the pigment composition may be liable to deviate from the color of the yellow monoazo pigment serving as a main component owing to the influence of the color of the compound represented by the general formula (1-1) or (2-1) (pigment derivative) serving as a subcomponent. The main component of the pigment composition is the yellow monoazo pigment, which is a component having a large mass ratio in the pigment composition. In addition, the subcomponent of the pigment composition is the pigment derivative (compound represented by the general formula (1-1) or (2-1)), which is a component having a small mass ratio in the pigment composition.

Specific examples of the compound represented by the general formula (1-1) may include compounds (Syn1-01 to Syn1-44) represented by the following formulae.

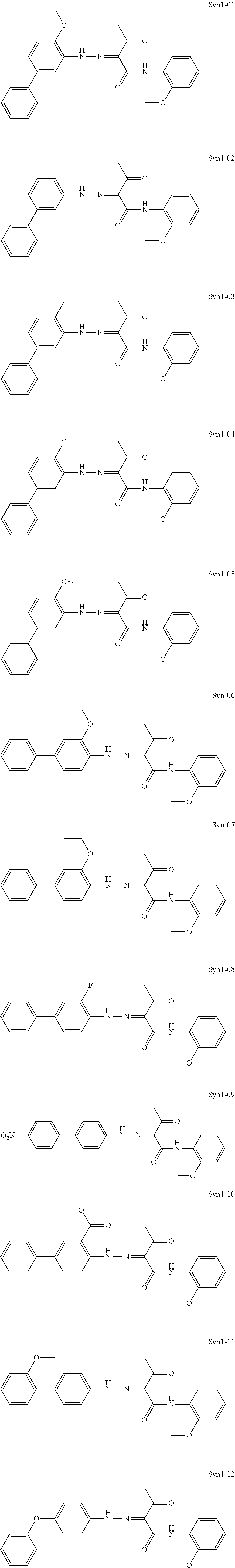

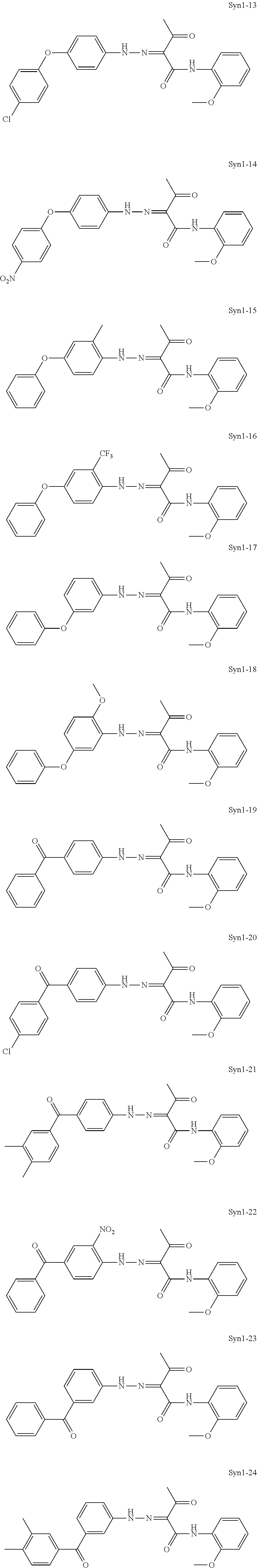

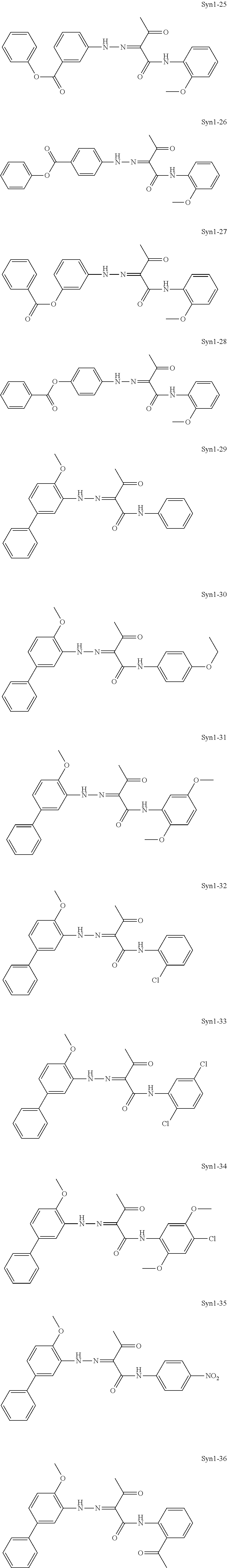

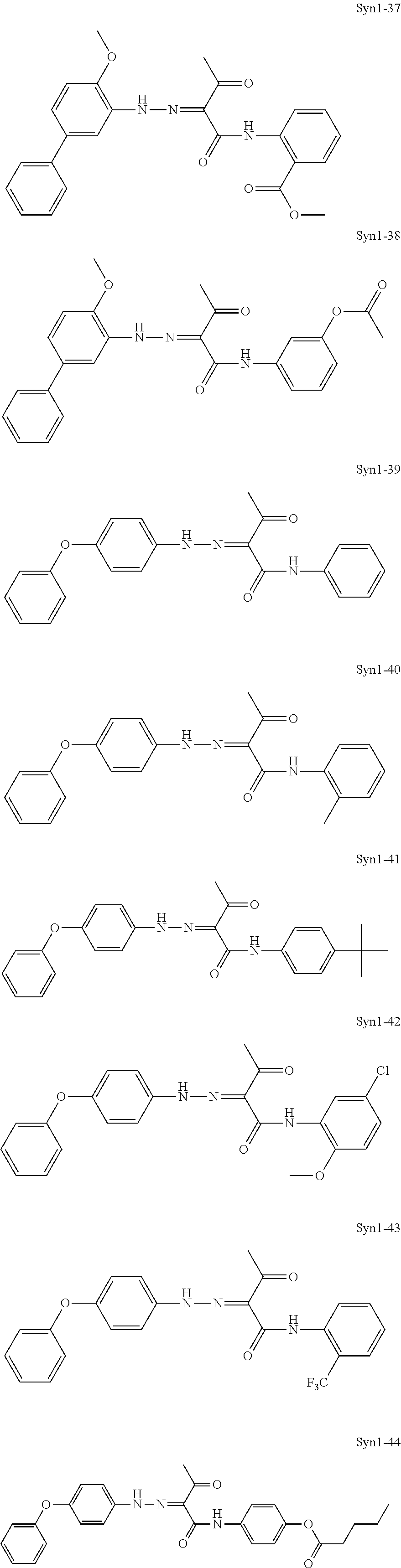

Specific examples of the compound represented by the general formula (2-1) may include compounds (Syn2-01 to Syn2-50) represented by the following formulae.

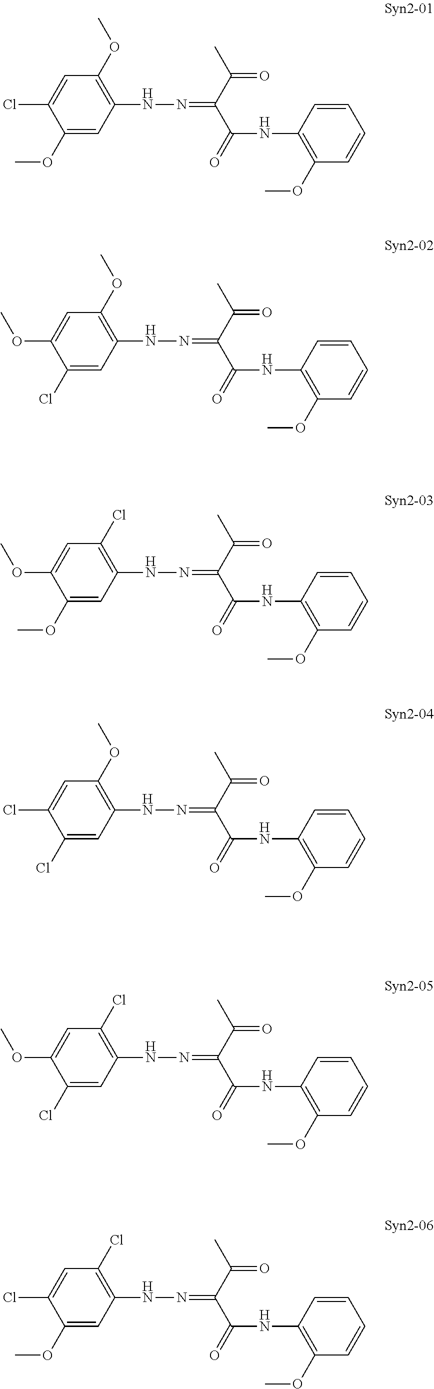

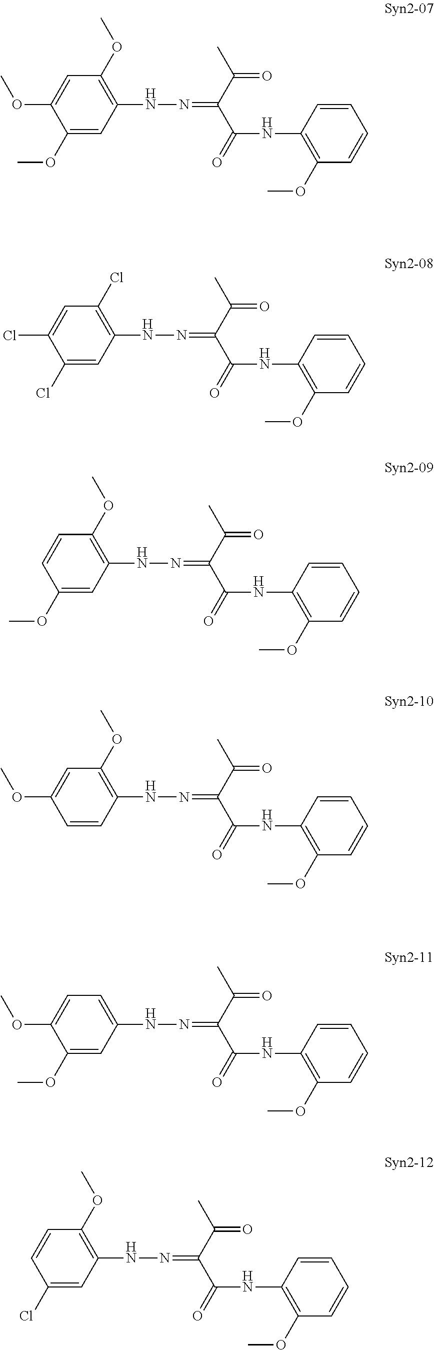

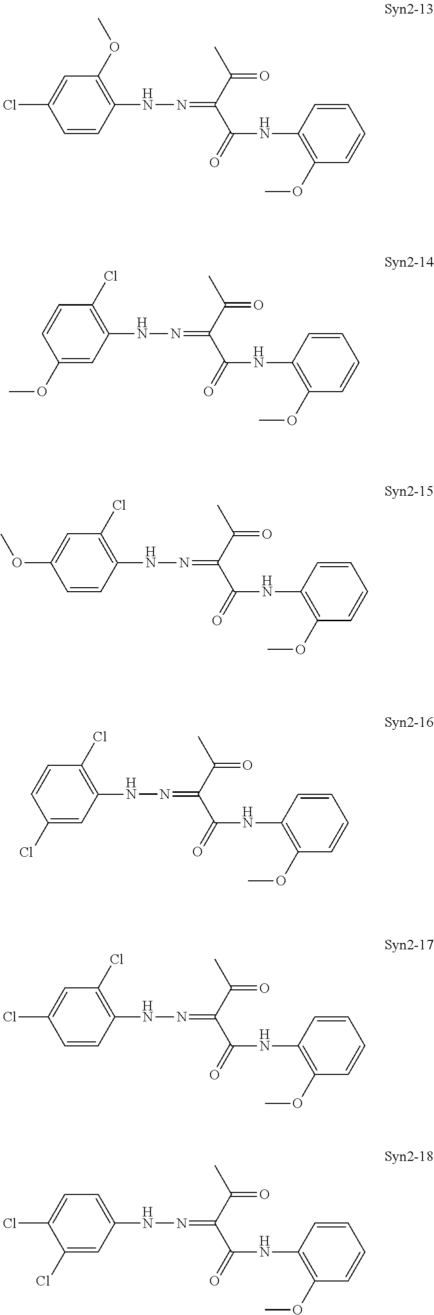

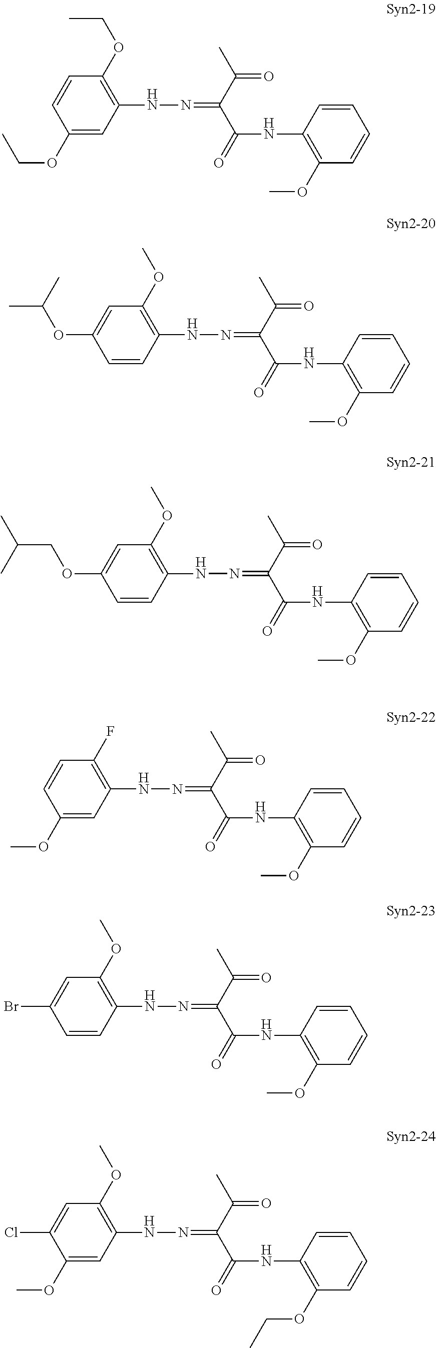

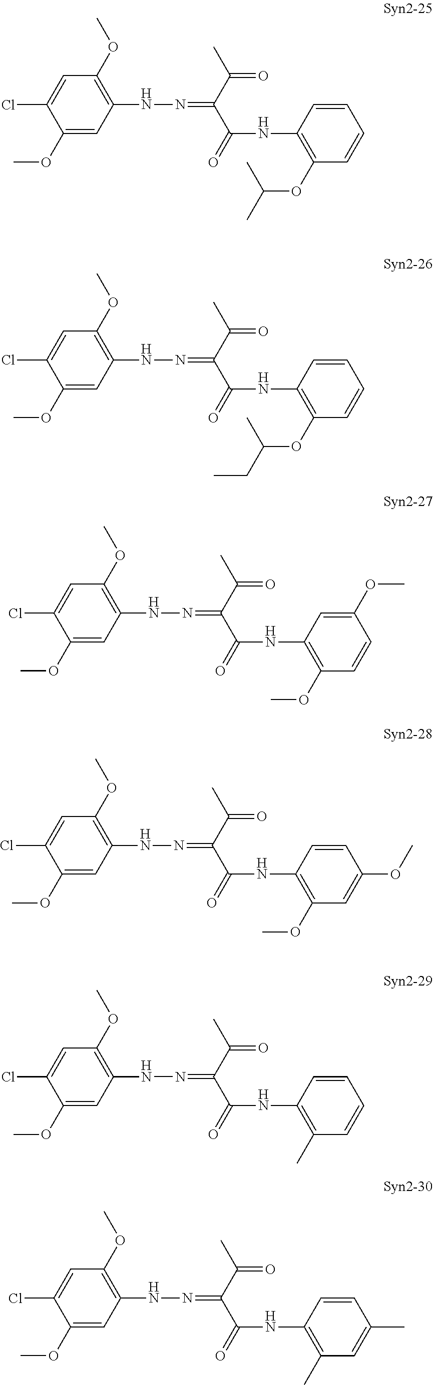

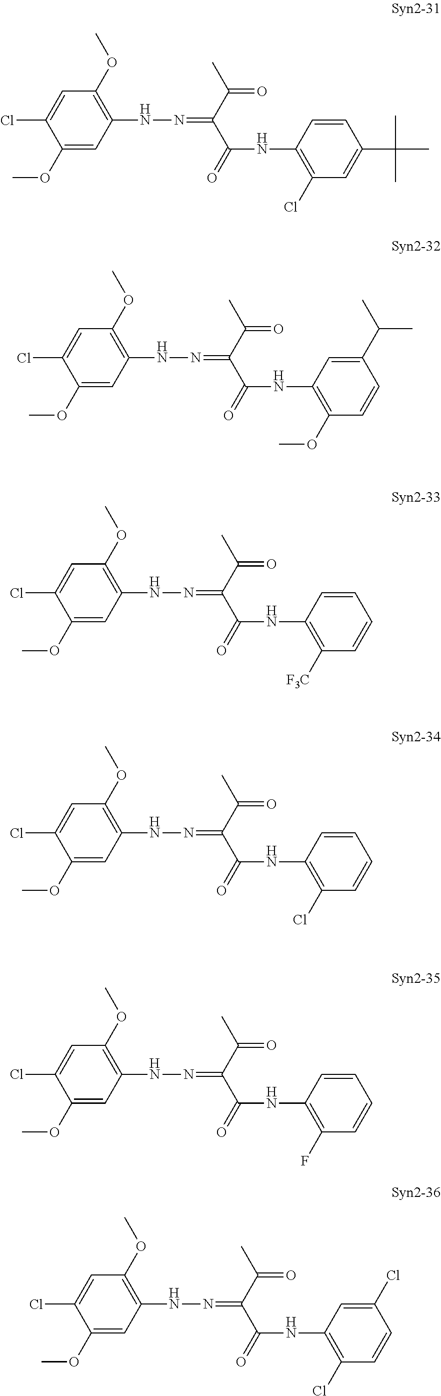

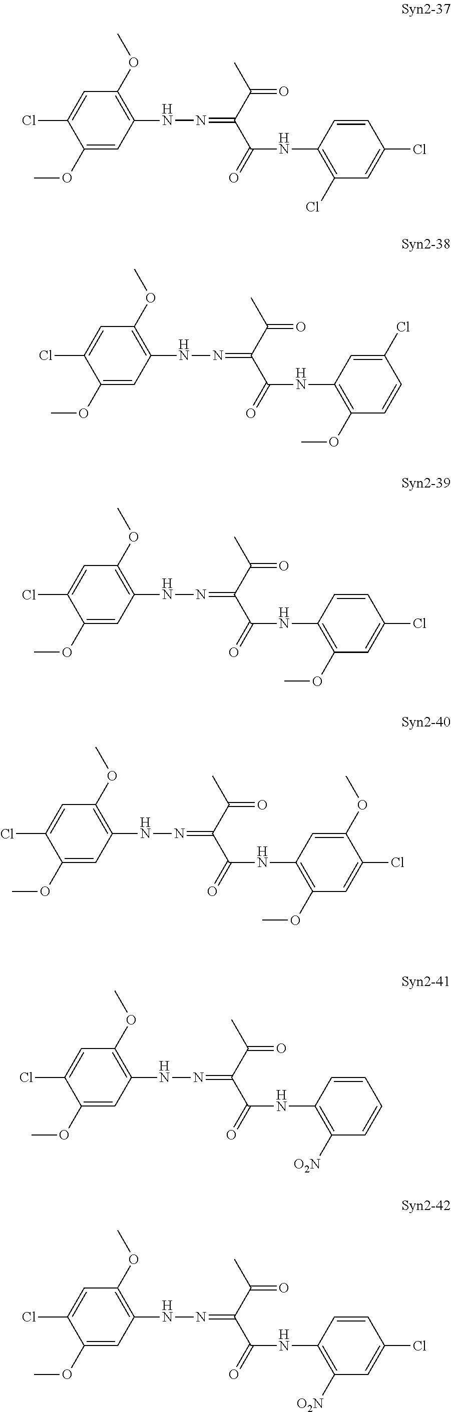

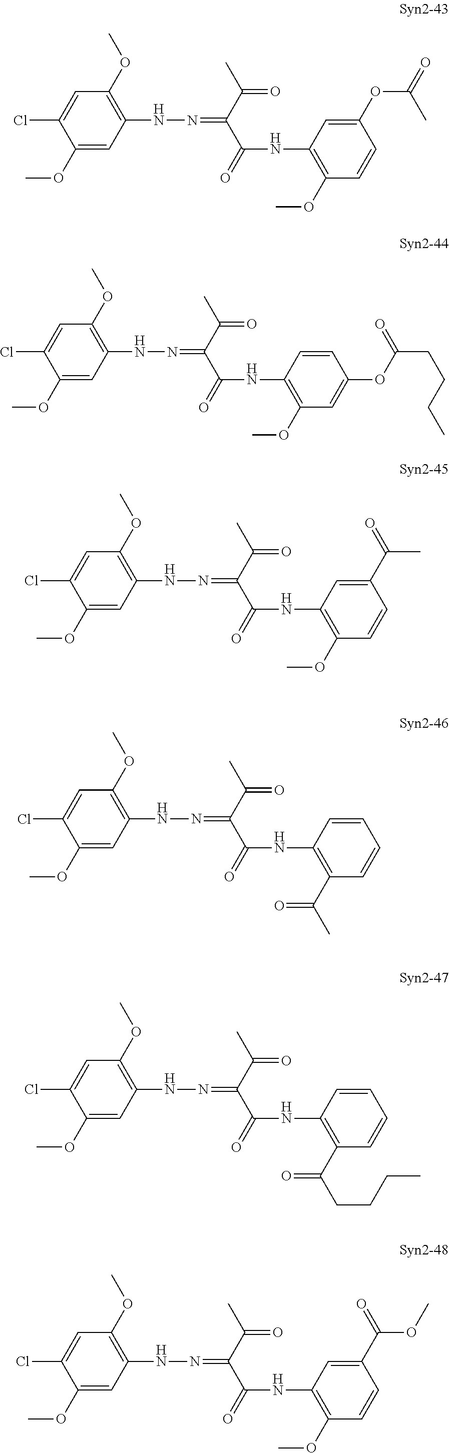

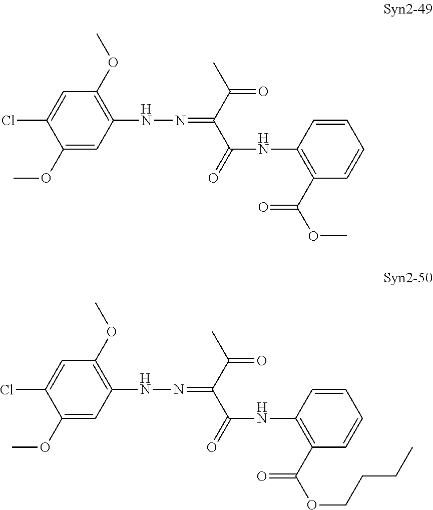

### (Pigment Composition)

The composition for image recording of the present disclosure includes a pigment composition containing a yellow monoazo pigment and a compound represented by the following general formula (1-1) or (2-1) (pigment derivative) different from the yellow monoazo pigment. The pigment composition is preferably substantially formed of the yellow monoazo pigment and the compound represented by the following general formula (1-1) or (2-1) (pigment derivative).

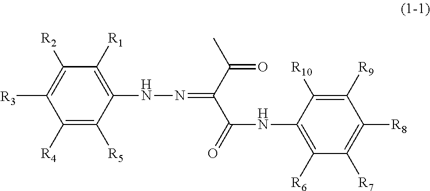

In the general formula (1-1), R₁ to R₁₀ each independently represent a hydrogen atom, an alkyl group, a halogenated alkyl group, an alkoxy group, an acyl group, a halogen atom, a nitro group, an alkoxycarbonyl group, or an acyloxy group, provided that R₃ or R₄ represents a substituent represented by the following general formula (1-2).

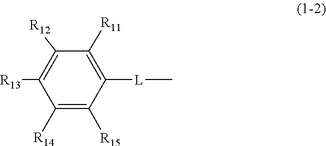

In the general formula (1-2), L represents a single bond, an ether bond (—O—), an ester bond (—O—C(═O)— or —C(═O)—O—), or a carbonyl group (—C(═O)—), and R₁ to R₁₅ each independently represent a hydrogen atom, an alkyl group, a halogenated alkyl group, an alkoxy group, a halogen atom, or a nitro group.

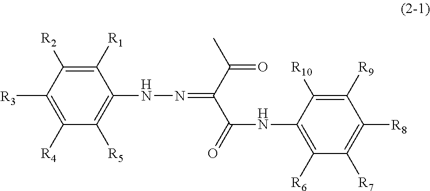

In the general formula (2-1), R₁ to R₅ each independently represent a hydrogen atom, an alkoxy group, or a halogen atom, provided that not more than one of R₁, R₃, and R₄ represents a hydrogen atom. And R₆ to R₁₀ each independently represent a hydrogen atom, an alkyl group, a halogenated alkyl group, an alkoxy group, an acyl group, a halogen atom, a nitro group, an alkoxycarbonyl group, or an acyloxy group, provided that R₆ does not represent a hydrogen atom.

The pigment composition is preferably formed by physical adsorption of the compound represented by the general formula (1-1) or (2-1) on the particle surface of the yellow monoazo pigment. That is, a molecule or a microcrystalline particle of the pigment derivative serving as a subcomponent is physically adsorbed onto at least part of the particle (crystal) surface of the yellow monoazo pigment serving as a main component in the pigment composition. For this reason, for example, the surface (particle surface) of the pigment composition, which is a granular material, is formed of the particle surface of the yellow monoazo pigment serving as a main component and the crystal surface of the pigment derivative serving as a subcomponent. It is difficult to form such surface state of the pigment composition simply by mixing the yellow monoazo pigment and the pigment derivative (e.g., in a powder or particle form). A method of producing the pigment composition is described later.

### (Rosin)

The pigment composition is preferably a surface-treated product having a particle surface treated with a rosin. When the pigment composition having a particle surface treated with a rosin is used, the crystal growth-suppressing effect of the compound represented by the general formula (1-1) or (2-1) can be further enhanced.

Examples of the rosin may include a rosin, a rosin ester, a hydrogenated rosin, a hydrogenated rosin ester, a disproportionated rosin, a disproportionated rosin ester, and a rosin amine. Of those, a rosin amine is preferred. The rosins may be used alone or in combination thereof.

The content (% by mass) of the rosin in the composition for image recording is preferably 0.001 times or more and 0.050 times or less, more preferably 0.005 times or more and 0.030 times or less in terms of mass ratio with respect to the content (% by mass) of the yellow monoazo pigment. When the above-mentioned mass ratio is less than 0.001 times, the amount of the rosin physically adsorbed onto the particle surface of the yellow monoazo pigment is slightly insufficient, and the crystal growth-suppressing effect to be obtained by the surface treatment with the rosin may be insufficient. Meanwhile, when the above-mentioned mass ratio is more than 0.050 times, the amount of the rosin released from the particle surface of the pigment composition may increase. For this reason, when the composition for image recording is used as, for example, an ink for ink jet, the storage stability and ejection performance of the ink may slightly reduce.

### <Ink>

The composition for image recording of the present disclosure is a composition suitable as an image recording agent, such as an ink for ink jet or a toner for electrophotography. Details of the composition for image recording when used as an ink for ink jet are described below.

The ink includes, as a coloring material, the pigment composition containing the yellow monoazo pigment and the compound represented by the general formula (1-1) or (2-1) (pigment derivative). The content (% by mass) of the pigment composition in the ink is preferably 0.1% by mass or more and 15.0% by mass or less, more preferably 1.0% by mass or more and 10.0% by mass or less with respect to the total mass of the ink.

A pigment dispersion system may be, for example, a resin-dispersed pigment using a resin (resin dispersant) as a dispersant, or a self-dispersible pigment having a hydrophilic group bonded to its particle surface. In addition, the pigment dispersion system may be, for example, a resin-bonded pigment having a resin-containing organic group chemically bonded to its particle surface, or a microcapsule pigment having a particle surface covered with, for example, a resin. Of those, a resin-dispersed pigment in which a resin serving as a dispersant is physically adsorbed onto its particle surface is preferably used, rather than a resin-bonded pigment or a microcapsule pigment.

The ink may further contain any other pigment except the pigment composition. Of those, an azo pigment exhibiting a yellow hue is preferably further incorporated. The content (% by mass) of the other pigment in the ink is preferably 0.1% by mass or more and 5.0% by mass or less, more preferably 0.1% by mass or more and 1.0% by mass or less with respect to the total mass of the ink.

### (Resin)

The ink may contain a resin. The content (% by mass) of the resin in the ink is preferably 0.1% by mass or more and 5.0% by mass or less with respect to the total mass of the ink. In addition, the content is more preferably 0.3% by mass or more and 2.0% by mass or less, particularly preferably 0.5% by mass or more and 1.5% by mass or less.

The resin may be incorporated into the ink for applications, such as (i) stabilizing the dispersion state of the pigment, that is, as a resin dispersant for the pigment or an aid therefor, and (ii) improving various characteristics of an image to be recorded. Of those, a resin dispersant is preferred as the resin because the ink preferably contains a resin-dispersed pigment. That is, the resin dispersant is preferably incorporated into the ink in addition to the above-mentioned pigment derivative.

Examples of the form of the resin may include a block copolymer, a random copolymer, a graft copolymer, and a combination thereof. In addition, the resin may be a soluble resin that can be dissolved in a liquid medium or may be a resin particle to be dispersed in the liquid medium. The resin particle does not need to include any coloring material.

The phrase “resin is soluble” as used herein means that when the resin is neutralized with an alkali in an equal amount to its acid value, the resin is present in a liquid medium under a state in which the resin does not form any particle whose particle diameter may be measured by a dynamic light scattering method. Whether or not a resin is soluble may be determined in accordance with a method described below. First, a liquid (resin solid content: 10% by mass) containing a resin neutralized with an alkali (e.g., sodium hydroxide or potassium hydroxide) equivalent to its acid value is prepared. Next, the prepared liquid is diluted 10-fold (volume basis) with pure water to prepare a sample solution. Then, when the particle diameter of the resin in the sample solution is measured by a dynamic light scattering method, and a particle having a particle diameter is not measured, the resin may be determined to be soluble. Measurement conditions in this case may be set, for example, as follows: Set Zero: 30 seconds; number of times of measurement: three times; and measurement time: 180 seconds. A particle size analyzer based on a dynamic light scattering method (e.g., product name “UPA-EX150”, manufactured by Nikkiso Co., Ltd.) or the like may be used as a particle size distribution-measuring apparatus. The particle size distribution-measuring apparatus to be used, the measurement conditions, and the like are of course not limited to the foregoing.

Examples of the resin may include an acrylic resin, a urethane-based resin, and a urea-based resin. Of those, an acrylic resin is preferred, and an acrylic resin having a hydrophilic unit and a hydrophobic unit is more preferred. When the resin is used as a resin dispersant for an aqueous ink, an acrylic resin having a hydrophilic unit derived from (meth)acrylic acid and a hydrophobic unit derived from a monomer having an aliphatic group or an aromatic ring is preferred. Further, an acrylic resin having a hydrophilic unit derived from (meth)acrylic acid and a hydrophobic unit derived from at least one monomer of styrene or α-methylstyrene is preferably used as a resin dispersant. Those resin dispersants are each suitable because its interaction with the pigment particularly easily occurs.

The hydrophilic unit is a unit having a hydrophilic group, such as a hydroxy group or an ethylene oxide group. The hydrophilic unit may be formed by, for example, polymerizing a hydrophilic monomer having a hydrophilic group. Examples of the hydrophilic monomer may include 2-hydroxyethyl (meth)acrylate and (poly)ethylene glycol (meth)acrylate.

In addition, the hydrophobic unit is a unit free of a hydrophilic group, such as an anionic group, a hydroxy group, or an ethylene oxide group. The hydrophobic unit may be formed by, for example, polymerizing a hydrophobic monomer free of the above-mentioned hydrophilic group. Examples of the hydrophobic monomer may include (meth)acrylic acid ester-based monomers, such as ethyl (meth)acrylate, methyl (meth)acrylate, butyl (meth)acrylate, and 2-ethylhexyl (meth)acrylate.

When the resin is used as a resin dispersant for an oil-based ink, examples thereof may include a hydroxy group-containing carboxylic acid ester, a salt of a polyaminoamide and a polymeric acid ester, a salt of a polycarboxylic acid, a salt of a polyaminoamide and a polar acid ester such as a sulfuric acid ester, an unsaturated acid ester, a copolymer of vinylpyrrolidone and an alkene, a modified polyurethane, a modified polyacrylate, a polyether ester-type anionic surfactant, a polyoxyethylene alkyl phosphate ester, and a polyester polyamine. Examples of the modified polyurethane and the modified polyacrylate may include epoxy-modified and acrylic-modified products.

The weight-average molecular weight of the resin is preferably 1,000 or more and 30,000 or less, more preferably 5,000 or more and 15,000 or less. The weight-average molecular weight of the resin is a value in terms of polystyrene measured by gel permeation chromatography (GPC).

The acid value of the resin is preferably 80 mgKOH/g or more and 250 mgKOH/g or less, more preferably 100 mgKOH/g or more and 200 mgKOH/g or less.

Any other resin except the above-mentioned resins may be further incorporated into the ink. The content (% by mass) of the other resin in the ink is preferably 0.1% by mass or more and 5.0% by mass or less with respect to the total mass of the ink.

### (Liquid Medium)

The ink typically contains a liquid medium. A water-insoluble organic solvent, such as a hydrocarbon compound, a ketone, an ether, an acetic acid ester, or an aromatic compound, is preferably used as a liquid medium for an oil-based ink. In addition, a water-soluble organic solvent to be described later may be used. Those organic solvents may be used alone or in combination thereof as long as the organic solvents form a single phase. The content (% by mass) of the organic solvent in the oil-based ink is preferably 60.0% by mass or more and 95.0% by mass or less, more preferably 80.0% by mass or more and 95.0% by mass or less with respect to the total mass of the ink.

Water or an aqueous medium, which is a mixed solvent of water and a water-soluble organic solvent, is preferably used as a liquid medium for an aqueous ink. Deionized water (ion-exchanged water) is preferably used as the water. The content (% by mass) of the water in the ink is preferably 50.0% by mass or more and 95.0% by mass or less with respect to the total mass of the ink. The water-soluble organic solvent that may be used for the aqueous ink is not particularly limited as long as the solvent is water-soluble (preferably a solvent that dissolves in water at any ratio at 25° C.). Specifically, for example, a monohydric or polyhydric alcohol, an alkylene glycol, a glycol ether, a nitrogen-containing polar compound, or a sulfur-containing polar compound may be used. The content (% by mass) of the water-soluble organic solvent in the ink is preferably 5.0% by mass or more and 90.0% by mass or less, more preferably 10.0% by mass or more and 50.0% by mass or less with respect to the total mass of the ink.

### (Other Additive)

Various additives, such as a surfactant, a pH adjuster, a preservative, a fungicide, an antioxidant, an anti-reduction agent, an evaporation accelerator, and a chelating agent, may be incorporated into the ink as required. Of those, a surfactant is preferably incorporated into the ink. The content (% by mass) of the surfactant in the ink is preferably 0.1% by mass or more and 5.0% by mass or less, more preferably 0.1% by mass or more and 2.0% by mass or less with respect to the total mass of the ink.

Examples of the surfactant may include an anionic surfactant, a cationic surfactant, and a nonionic surfactant.

### (Physical Properties of Ink)

The ink is an ink appliable to an ink jet system, and hence it is preferred to appropriately control its physical properties. The surface tension of the ink at 25° C. is preferably 10 mN/m or more and 60 mN/m or less, more preferably 20 mN/m or more and 40 mN/m or less. The surface tension of the ink may be adjusted by appropriately setting the kind and content of the surfactant in the ink. The viscosity of the ink at 25° C. is preferably 1.0 mPa s or more and 10.0 mPa s or less. When the ink is an aqueous ink, the pH of the ink at 25° C. is preferably 5.0 or more and 10.0 or less.

### <Method of Producing Composition for Image Recording>

A method of producing a composition for image recording of the present disclosure includes the following steps:
[1] a first step of producing a pigment composition containing a yellow monoazo pigment and a compound represented by the general formula (1-1) or (2-1);
[2] a second step of treating the pigment composition in accordance with each image recording system; and
[3] a third step of mixing the treated pigment composition and any other component required for each image recording system.

### <Method of Producing Ink>

A method of producing an ink for ink jet out of the compositions for image recording is described in detail below. The method of producing an ink includes the following steps:
[1] a first step of producing a pigment composition containing a yellow monoazo pigment and a compound represented by the general formula (1-1) or (2-1);
[2] a second step of producing a pigment dispersion liquid using the pigment composition; and
[3] a third step of mixing the pigment dispersion liquid and any other component required for an ink jet recording system.

### (First Step; Production of Pigment Composition)

The pigment composition may be produced in accordance with the method shown below. The pigment composition preferably contains a micronized pigment from the viewpoint of producing a pigment dispersion liquid.

### (i) Mixed Coupling Reaction

The pigment composition may be produced by, for example, a so-called “mixed coupling reaction” in which a yellow monoazo pigment and a compound represented by the general formula (1-1) or (2-1) (pigment derivative) are simultaneously synthesized in the same system. Specifically, a diazo component mixture (c1) containing a diazo component (a1) and a diazo component (b1) each obtained by converting an aniline derivative into a diazonium salt, and a coupler component (c2) that is an acetoacetanilide derivative are coupled. The coupler component (c2) means a common coupler component when a coupler component (a2) for the yellow monoazo pigment and a coupler component (b2) for the pigment derivative are the same component. Thus, a crude product of a pigment composition containing a yellow monoazo pigment and a pigment derivative can be obtained by the “mixed coupling reaction” in which the diazo component mixture (c1) and the coupler component (c2) are coupled. When the coupler component (c2) is coupled, a yellow monoazo pigment and a pigment derivative having the same molecular structure portion derived from the coupler can be simultaneously synthesized. In addition, the structural similarity between yellow monoazo pigment and pigment derivative molecules produced by the “mixed coupling reaction” is high, and hence the pigment derivative is easily adsorbed onto the crystal surface of the yellow monoazo pigment. Accordingly, there can be obtained a composition for image recording including a pigment composition that is more excellent in crystal growth-suppressing effect and is highly micronized.

### (ii) Solvent Salt Milling Method

The pigment composition may be produced by subjecting a crude product mixture (pretreatment mixture) containing a crude product of a yellow monoazo pigment and a crude product of a compound represented by the general formula (1-1) or (2-1) to wet kneading and grinding by a solvent salt milling method. The crude product mixture may be a crude product of a pigment composition to be obtained by the above-mentioned mixed coupling reaction, or may be a mixture containing a crude product of a yellow monoazo pigment and a crude product of a pigment derivative produced separately. In particular, it is preferred to subject a crude product of a pigment composition to be obtained by the mixed coupling reaction to wet kneading and grinding by a solvent salt milling method because a pigment composition in which a yellow monoazo pigment and a pigment derivative are more uniformly mixed can be obtained.

In addition, when a mixture (crude product mixture) containing a crude product of a yellow monoazo pigment and a crude product of a pigment derivative produced separately is subjected to wet kneading and grinding by a solvent salt milling method, it is preferred to subject the crude product mixture to pretreatment. That is, it is preferred to obtain a pretreatment mixture by dissolving at least part of the crude product mixture in an organic solvent, then removing at least part of the organic solvent from the crude product mixture, and physically adsorbing the compound represented by the general formula (1-1) or (2-1) on the particle surface of the yellow monoazo pigment. When the crude product mixture is subjected to the pretreatment, solvent salt milling may be performed under a state in which at least part of the pigment derivative is physically adsorbed onto the particle surface of the yellow monoazo pigment.

Thus, the yellow monoazo pigment and the compound represented by the general formula (1-1) or (2-1) can be mixed more uniformly.

In order to obtain a pigment composition that is a surface-treated product having a particle surface treated with a rosin, first, a rosin is added to the synthesis system of a yellow monoazo pigment to provide a crude product of a yellow monoazo pigment having a particle surface treated with a rosin. Next, a crude product mixture containing the resultant crude product of the yellow monoazo pigment and a crude product of the compound represented by the general formula (1-1) or (2-1) may be subjected to solvent salt milling. Alternatively, the rosin may be added to the reaction system of the mixed coupling reaction to provide a pigment composition that is a surface-treated product having a particle surface treated with a rosin.

### (Solvent Salt Milling Method)

A wet kneading and grinding method such as a salt milling method and a dry grinding method are each known as a method of micronizing a coarse pigment particle. Of those, wet kneading and grinding by a solvent salt milling method is preferred because a more uniform pigment composition can be obtained.

The solvent salt milling method is a method of mechanically grinding a pigment particle with a kneader or the like in the presence of a water-soluble inorganic salt (salt) and an organic solvent (solvent), and is a method capable of efficiently micronizing a pigment particle. The solvent salt milling method typically includes a kneading step of producing a kneaded product of a pigment and the like in the presence of a water-soluble inorganic salt and an organic solvent, and a post-step of removing the water-soluble inorganic salt and the organic solvent.

### [Water-Soluble Inorganic Salt]

The inorganic salt is used to grind the pigment and micronize the pigment during the kneading step by utilizing its high hardness. A water-soluble salt (water-soluble inorganic salt) is preferably used as the inorganic salt in consideration of handleability at the time of its removal. Examples of the water-soluble inorganic salt may include: chlorides of alkali metals, such as sodium chloride and potassium chloride; and chlorides of polyvalent metals, such as zinc chloride and magnesium chloride.

The volume-based cumulative 50% particle diameter (D₅₀) of the water-soluble inorganic salt is preferably 1 μm or more and 50 μm or less. In addition, the volume-based cumulative 95% particle diameter (D₉₅) of the water-soluble inorganic salt is preferably 80 μm or less. The D₅₀ and the D₉₅ are diameters of a particle at 50% and 95% integrated from a small particle diameter side, based on the total volume of measured particles in a particle diameter integration curve, respectively. The D₅₀ and D₉₅ of the water-soluble inorganic salt may be measured with, for example, a particle size analyzer based on a dynamic light scattering method.

### [Organic Solvent]

The organic solvent is used in the kneading step to wet the pigment particle, the pigment derivative, and the water-soluble inorganic salt to increase a grinding effect and promote the micronization of the pigment. A water-soluble organic solvent, such as an alcohol, a glycol, or an ether, is preferred as the organic solvent. Of those, a highly viscous water-soluble organic solvent, such as ethylene glycol, diethylene glycol, or polyethylene glycol, is more preferred from the viewpoint of improving the grinding effect.

### [Kneading Step]

The kneading step is a step of kneading a mixture of a pigment and a pigment derivative while applying a load to compress the mixture in the presence of a water-soluble inorganic salt and an organic solvent. Examples of an apparatus to be used in the kneading step may include a kneader, a roll mill, a ball mill, an attritor, a sand mill, and a planetary mixer. Of those, a kneader is preferably used.

The usage amount (% by mass) of the compound represented by the general formula (1-1) or (2-1) to be used in the kneading step is preferably 0.001 times or more and 0.100 times or less, more preferably 0.010 times or more and 0.070 times or less in terms of mass ratio with respect to the usage amount (% by mass) of the yellow monoazo pigment. When the above-mentioned mass ratio is less than 0.001 times, the crystal growth-suppressing effect may be insufficient. Meanwhile, when the above-mentioned mass ratio is more than 0.100 times, the color of the pigment composition may be liable to deviate from the color of the yellow monoazo pigment serving as a main component owing to the influence of the color of the compound represented by the general formula (1-1) or (2-1) (pigment derivative) serving as a subcomponent.

A temperature during the kneading step is preferably 25° C. or more and 90° C. or less. When the temperature is less than 25° C., the pigment particle may be excessively micronized, and the light resistance of an image may be insufficient. Meanwhile, when the temperature is more than 90° C., the crystal growth rate of the pigment may become excessively fast. For this reason, the micronization of the pigment hardly proceeds, and hence the color developability of an image may be insufficient.

### [Post-Step]

The post-step is a step of removing the water-soluble inorganic salt and the organic solvent from the kneaded product obtained in the kneading step. Specifically, water may be added to the kneaded product at a predetermined ratio to form a slurry, and the slurry may be filtered and washed. Ion-exchanged water or pure water is preferably used as the water. Examples of a method of filtering the slurry may include a method including separation by passing the slurry through an ultrafiltration membrane or a dialysis membrane, and a method including separation with a high-pressure filter press. When the post-step is performed, a pigment composition in which the organic solvent and the water-soluble inorganic salt are reduced or removed can be obtained in a wet cake state.

The pigment composition obtained in a wet cake state is preferably dried until its water content (moisture content) becomes 5% by mass or less in order to suppress bacterial growth. In particular, when a pigment dispersion liquid for an oil-based ink is prepared, the composition is preferably dried until the water content becomes 0%. Examples of a method of removing the water include a batch or continuous drying method including dehydration by heating to from 80° C. to 120° C. with a heating source arranged in a dryer, and a method including evaporation to dryness under reduced pressure. A box dryer, a band dryer, a spray dryer, or the like may be used as the dryer.

### (Second Step; Production of Pigment Dispersion Liquid)

When the pigment composition is used, for example, a pigment dispersion liquid to be used for producing an ink for ink jet can be obtained. Specifically, the pigment dispersion liquid can be obtained by dispersing the pigment composition in a liquid medium. An additive such as a pH adjuster may be used as required. Further, treatment for obtaining a desired particle size distribution such as applying shearing force is preferably performed.

A pigment dispersion system may be, for example, a resin-dispersed pigment, a self-dispersible pigment, a resin-bonded pigment, or a microcapsule pigment. Of those, a resin-dispersed pigment is preferred. When a pigment dispersion liquid is prepared by using the pigment composition, a known dispersion method, such as media dispersion or medialess dispersion, may be adopted. Examples of a disperser based on the media dispersion may include a paint shaker, a bead mill, a sand mill, a ball mill, and a roll mill. Examples of a disperser based on the medialess dispersion may include an ultrasonic homogenizer and a high-pressure homogenizer. Two or more kinds of dispersers may be used in combination at the time of the dispersion.

The temperature when the pigment composition is dispersed in the liquid medium (at the time of the dispersion treatment) may be freely set. When the pigment composition is dispersed in an aqueous liquid medium, the temperature is preferably set to 0° C. or more and 100° C. or less. In addition, when heat is generated during the dispersion treatment or when a media dispersion system is adopted, the temperature is preferably set to 10° C. or more and 40° C. or less from the viewpoint of, for example, the reliability of media. The time for the dispersion treatment may be adjusted in accordance with an apparatus to be used, the concentration of the pigment dispersion liquid, and the like. In addition, preliminary dispersion treatment may be performed in which components each containing the pigment composition are mixed and wetted with a liquid medium to facilitate dispersion. In the preliminary dispersion treatment, the above-mentioned dispersion system and apparatus may be adopted.

### [Liquid Medium]

When a pigment dispersion liquid for an aqueous ink is obtained, an aqueous liquid medium is used. Water or an aqueous medium in which water serving as a main solvent and an organic solvent are used in combination may be used as the aqueous liquid medium. A liquid medium that is miscible or soluble in water at any ratio is preferably used as the organic solvent. Of those, a uniform mixed solvent containing 50% by mass or more of water is preferably used as the aqueous medium. Ion-exchanged water or pure water is preferably used as the water.

A protic organic solvent or an aprotic organic solvent may be used as the organic solvent. In addition, a protic organic solvent and an aprotic organic solvent may be used in combination. The protic organic solvent is an organic solvent having a hydrogen atom bonded to an oxygen atom or a nitrogen atom (acidic hydrogen atom). In addition, the aprotic organic solvent is an organic solvent having no acidic hydrogen atom. Examples of the organic solvent may include an alcohol, an alkylene glycol, a polyalkylene glycol, a glycol ether, a glycol ether ester, a carboxylic acid amide, a ketone, a keto alcohol, a cyclic ether, a nitrogen-containing compound, and a sulfur-containing compound.

### [Post-Treatment]

The produced pigment dispersion liquid may be suitably used for producing an ink for ink jet after being subjected to general post-treatment such as purification. When only water is used as the liquid medium without use of an organic solvent, the resultant dispersion liquid may be used as it is for producing an ink, or a liquid obtained by washing or adjusting its pigment content may be used as the final dispersion liquid. When a liquid medium containing an organic solvent is used, the organic solvent may be removed. An example of a method of removing the organic solvent is a method including adding water while removing the organic solvent by pressure reduction or heating through utilization of an evaporator. Another example thereof is a method including repeating the operation of adding water after removing the organic solvent by ultrafiltration.

### (Third Step; Production of Ink)

A desired ink can be obtained by mixing the pigment dispersion liquid and any other component required for an ink jet recording system. Examples of the other component may include water, a water-soluble organic solvent, a water-insoluble organic solvent, a resin, and the above-mentioned “other additive.” For example, the target ink may be prepared by loading the pigment dispersion liquid and other ink components into a suitable container and stirring the mixture. Conditions, such as stirring speed, temperature, and time, may be appropriately set. In addition, known production steps may be combined.

### Examples

The present disclosure is described in more detail below by way of Examples and Comparative Examples. The present disclosure is by no means limited to Examples below within a range not departing from the gist of the present disclosure. “Part(s)” and “%” with regard to the description of the amounts of components are by mass unless otherwise stated.

### <Analysis of Pigment>

### (High Performance Liquid Chromatography Mass Spectrometry)

High performance liquid chromatography mass spectrometry (HPLC/MS) was performed under the following conditions.

### [HPLC Analysis Conditions]

Column: silica gel column (product name: “SunFire C18 Column”, 2.1 mm×150 mm, manufactured by Waters)
Column temperature: 40° C.
Flow rate: 0.2 mL/min
Detector: diode array (PDA) detector
Detection range: 200 nm to 700 nm
Analysis time: 45 minutes
Mobile phase gradient conditions: Table 1-1 below
Sample solution: dimethyl sulfoxide (DMSO) solution having a pigment concentration of 30 ppm
Sample solution injection volume: 2 μL

TABLE 1-1
Gradient conditions of mobile phase

| | 0 minutes | 5 minutes | 24 minutes | 31 minutes |
|---|---|---|---|---|
| | to 5 | to 24 | to 31 | to 45 |
| | minutes | minutes | minutes | minutes |
| A: Water | 85% | 85→45% | 45→0% | 0% |
| B: Methanol | 10% | 10→50% | 50→95% | 95% |
| C: 0.2 mol/L | 5% | 5% | 5% | 5% |
| aqueous solution | | | | |
| of ammonium | | | | |
| acetate | | | | |

### [Mass Spectrometry Conditions]

For peaks obtained in the HPLC analysis performed under the above-mentioned conditions, mass spectra were measured under the following conditions. The most strongly detected m/z was measured for each of positive (ES+) and negative (ES−).
Ionization method: electrospray ionization method (ESI method)
Capillary voltage: 3.5 kV
Desolvation gas: 350° C.
Ion source temperature: 120° C.
Detector: 40 V, 200 amu to 1,500 amu/0.9 sec (in the case of positive (ES+)); 40 V, 200 amu to 1,500 amu/0.9 sec (in the case of negative (ES−))

### [Measurement of Mass Ratio of Each Pigment Component in Mixed Pigment]

A mixed pigment sample was analyzed by the HPLC analysis performed under the above-mentioned conditions, and the area of the peak of each pigment component in a mixed pigment to be obtained on a chromatogram at a detection wavelength of 254 nm was measured. At the same time, a standard DMSO solution for a calibration curve of each pigment component alone having a pigment concentration of 30 ppm was also analyzed, and a concentration calibration curve of each pigment component at a detection wavelength of 254 nm was prepared. Then, the pigment concentration of each pigment component in the mixed pigment sample was calculated from the prepared concentration calibration curve, and the mass ratio of each pigment component in the mixed pigment was determined.

### [Measurement of Mass Ratio of Rosin in Pigment]

A pigment sample was analyzed by the HPLC analysis performed under the above-mentioned conditions. Next, the area of the MS count peak of a target rosin to be obtained on the MS chromatogram at m/z of the rosin was measured. At the same time, a standard DMSO solution for a calibration curve of the target rosin alone having a concentration of 1 ppm was also analyzed, and a concentration calibration curve of the target rosin was prepared. Then, the concentration of the rosin in the pigment sample was calculated from the prepared concentration calibration curve, and the mass ratio of the rosin in the pigment was determined.

### <Production of Pigment Derivative>

### (Syn1-01)

10.0 Parts of 3-amino-4-methoxybiphenyl was added to 63.0 parts of ion-exchanged water, and the mixture was stirred to prepare a suspension. 13.0 Parts of 35% hydrochloric acid was added, and the mixture was stirred for 1 hour and then cooled in an ice-salt bath until its internal temperature became 0° C. or less. An aqueous solution of sodium nitrite prepared by adding 8.96 parts of ion-exchanged water to 3.49 parts of sodium nitrite was added thereto, and the mixture was stirred for 1 hour to form a diazonium salt while the internal temperature was maintained at 0° C. or less in an ice-salt bath. Thus, a diazonium salt solution was obtained. 0.049 Part of sulfamic acid was added to the resultant diazonium salt solution to remove excess nitrous acid. Thus, a diazo component solution was prepared.

10.2 Parts of o-acetoacetanisidide, 5.12 parts of sodium hydroxide, and 80.6 parts of ion-exchanged water were mixed and stirred until o-acetoacetanisidide and sodium hydroxide were completely dissolved to provide a liquid. The above-mentioned liquid was added to an aqueous solution obtained by mixing 8.20 parts of acetic acid and 54.5 parts of ion-exchanged water, and the mixture was stirred to prepare a coupler component slurry.

The coupler component slurry was heated to 40° C. with a hot stirrer, and while the internal temperature was maintained at 40° C., the diazo component solution was added dropwise over 30 minutes. The mixture was stirred at 40° C. for 30 minutes, and was then increased in temperature to an internal temperature of 70° C. and stirred for 20 minutes to complete the reaction. The reaction precipitate taken out by filtering the reaction liquid was washed three times with an appropriate amount of ion-exchanged water to provide a crude cake of the reaction product. The resultant crude cake was washed by adding ethanol thereto and stirring the mixture for 1 hour. The filtered product obtained by filtration was dried to provide 19.5 parts of Syn1-01 (yield: 95%).

The analysis result of Syn1-01 by HPLC/MS is shown below.

### [HPLC/MS]

Measured value: MS (ES+) m/z 418.33 (M+H)⁺

MS (ES−) m/z 416.32 (M−H)⁻

Calculated value: C₂₄H₂₃N₃O₄=417.17

### (Syn1-02)

17.9 Parts of Syn1-02 (yield: 94%) was obtained in the same manner as in the case of Syn1-01 described above except that 9.38 parts of 3-aminobiphenyl was used instead of 10.0 parts of 3-amino-4-methoxybiphenyl.

The analysis result of Syn1-02 by HPLC/MS is shown below.

### [HPLC/MS]

Measured value: MS (ES+) m/z 388.30 (M+H)⁺

MS (ES−) m/z 386.29 (M−H)⁻

Calculated value: C₂₃H₂₁N₃O₃=387.16

### (Syn1-03)

18.8 Parts of Syn1-03 (yield: 96%) was obtained in the same manner as in the case of Syn1-01 described above except that 9.16 parts of 3-amino-4-methylbiphenyl was used instead of 10.0 parts of 3-amino-4-methoxybiphenyl.

The analysis result of Syn1-03 by HPLC/MS is shown below.

### [HPLC/MS]

Measured value: MS (ES+) m/z 402.32 (M+H)⁺

MS (ES−) m/z 400.33 (M−H)⁻

Calculated value: C₂₄H₂₃N₃O₃=401.17

### (Syn1-11)

19.1 Parts of Syn1-11 (yield: 94%) was obtained in the same manner as in the case of Syn1-01 described above except that 9.96 parts of 3-amino-2′-methoxybiphenyl was used instead of 10.0 parts of 3-amino-4-methoxybiphenyl.

The analysis result of Syn1-11 by HPLC/MS is shown below.

### [HPLC/MS]

Measured value: MS (ES+) m/z 418.33 (M+H)⁺

MS (ES−) m/z 416.33 (M−H)⁻

Calculated value: C₂₄H₂₃N₃O₄=417.17

### (Syn1-12)

18.9 Parts of Syn1-12 (yield: 95%) was obtained in the same manner as in the case of Syn1-01 described above except that 9.26 parts of 4-phenoxyaniline was used instead of 10.0 parts of 3-amino-4-methoxybiphenyl.

The analysis result of Syn1-12 by HPLC/MS is shown below.

### [HPLC/MS]

Measured value: MS (ES+) m/z 404.32 (M+H)⁺

MS (ES−) m/z 402.32 (M−H)⁻

Calculated value: C₂₃H₂₁N₃O₄=403.15

### (Syn1-17)

12.8 Parts of Syn1-17 (yield: 65%) was obtained in the same manner as in the case of Syn1-01 described above except that 9.26 parts of 3-phenoxyaniline was used instead of 10.0 parts of 3-amino-4-methoxybiphenyl.

The analysis result of Syn1-17 by HPLC/MS is shown below.

### [HPLC/MS]

Measured value: MS (ES+) m/z 404.35 (M+H)⁺

MS (ES−) m/z 402.37 (M−H)⁻

Calculated value: C₂₃H₂₁N₃O₄=403.15

### (Syn1-19)

18.4 Parts of Syn1-19 (yield: 91%) was obtained in the same manner as in the case of Syn1-01 described above except that 9.86 parts of 4-aminobenzophenone was used instead of 10.0 parts of 3-amino-4-methoxybiphenyl.

The analysis result of Syn1-19 by HPLC/MS is shown below.

### [HPLC/MS]

Measured value: MS (ES+) m/z 416.34 (M+H)⁺

MS (ES−) m/z 414.33 (M−H)⁻

Calculated value: C₂₄H₂₁N₃O₄=415.15

### (Syn1-22)

19.7 Parts of Syn1-22 (yield: 87%) was obtained in the same manner as in the case of Syn1-01 described above except that 12.1 parts of 4-amino-3-nitrobenzophenone was used instead of 10.0 parts of 3-amino-4-methoxybiphenyl.

The analysis result of Syn1-22 by HPLC/MS is shown below.

### [HPLC/MS]

Measured value: MS (ES+) m/z 461.33 (M+H)⁺

MS (ES−) m/z 459.33 (M−H)⁻

Calculated value: C₂₄H₂₀N₄O₆=460.14

### (Syn1-23)

17.4 Parts of Syn1-23 (yield: 86%) was obtained in the same manner as in the case of Syn1-01 described above except that 9.86 parts of 3-aminobenzophenone was used instead of 10.0 parts of 3-amino-4-methoxybiphenyl.

The analysis result of Syn1-23 by HPLC/MS is shown below.

### [HPLC/MS]

Measured value: MS (ES+) m/z 416.33 (M+H)⁺

MS (ES−) m/z 414.35 (M−H)⁻

Calculated value: C₂₄H₂₁N₃O₄=415.15

### (Syn1-26)

19.3 Parts of Syn1-26 (yield: 91%) was obtained in the same manner as in the case of Syn1-01 described above except that 10.7 parts of phenyl 4-aminobenzoate was used instead of 10.0 parts of 3-amino-4-methoxybiphenyl.

The analysis result of Syn1-26 by HPLC/MS is shown below.

### [HPLC/MS]

Measured value: MS (ES+) m/z 432.32 (M+H)⁺

MS (ES−) m/z 430.33 (M−H)⁻

Calculated value: C₂₄H₂₁N₃O₅=431.15

### (Syn1-27)

17.9 Parts of Syn1-27 (yield: 85%) was obtained in the same manner as in the case of Syn1-01 described above except that 10.7 parts of 3-aminophenyl benzoate was used instead of 10.0 parts of 3-amino-4-methoxybiphenyl.

The analysis result of Syn1-27 by HPLC/MS is shown below.

### [HPLC/MS]

Measured value: MS (ES+) m/z 432.33 (M+H)⁺

MS (ES−) m/z 430.33 (M−H)⁻

Calculated value: C₂₄H₂₁N₃O₅=431.15

### (Syn1-29)

18.1 Parts of Syn1-29 (yield: 95%) was obtained in the same manner as in the case of Syn1-01 described above except that 8.68 parts of acetoacetanilide was used instead of 10.2 parts of o-acetoacetanisidide.

The analysis result of Syn1-29 by HPLC/MS is shown below.

### [HPLC/MS]

Measured value: MS (ES+) m/z 388.34 (M+H)⁺

MS (ES−) m/z 386.33 (M−H)⁻

Calculated value: C₂₃H₂₁N₃O₃=387.16

### (Syn1-32)

19.6 Parts of Syn1-32 (yield: 95%) was obtained in the same manner as in the case of Syn1-01 described above except that 10.4 parts of 2′-chloroacetoacetanilide was used instead of 10.2 parts of o-acetoacetanisidide.

The analysis result of Syn1-32 by HPLC/MS is shown below.

### [HPLC/MS]

Measured value: MS (ES+) m/z 422.32, 424.33 (M+H)⁺

MS (ES−) m/z 420.33, 422.33 (M−H)⁻

Calculated value: C₂₃H₂₀ClN₃03=421.12

### (Syn1-36)

11.0 Parts of 2-acetylaniline was added to 240 parts of ion-exchanged water heated to 50° C., and the mixture was stirred. After heating to 100° C., 18.2 parts of 2,2,6-trimethyl-1,3-dioxin-4-one was added, and the mixture was stirred for 2.5 hours while being heated at 100° C. After standing to cool, 35.0 parts of 2 mol/L hydrochloric acid was added, and the mixture was stirred. The extract obtained by using ethyl acetate was washed with a saturated aqueous solution of sodium chloride, and was then dried over sodium sulfate. After the removal of sodium sulfate by filtration, ethyl acetate was evaporated with an evaporator. When the resultant viscous product was cooled and left to stand, the viscous product was crystallized and solidified to provide 13.5 parts of 2′-acetylacetoacetanilide (yield: 76%).

Then, 18.8 parts of Syn1-36 (yield: 90%) was obtained in the same manner as in the production of Syn1-01 described above except that 10.7 parts of the resultant 2′-acetylacetoacetanilide was used instead of 10.2 parts of o-acetoacetanisidide.

The analysis result of Syn1-36 by HPLC/MS is shown below.

### [HPLC/MS]

Measured value: MS (ES+) m/z 430.35 (M+H)⁺

MS (ES−) m/z 428.34 (M−H)⁻

Calculated value: C₂₅H₂₃N₃O₄=429.17

### (Syn1-37)

20.0 Parts of Syn1-37 (yield: 92%) was obtained in the same manner as in the case of Syn1-01 described above except that 11.5 parts of methyl 2-(acetoacetylamino)benzoate was used instead of 10.2 parts of o-acetoacetanisidide.

The analysis result of Syn1-37 by HPLC/MS is shown below.

### [HPLC/MS]

Measured value: MS (ES+) m/z 446.33 (M+H)⁺

MS (ES−) m/z 444.34 (M−H)⁻

Calculated value: C₂₅H₂₃N₃O₅=445.16

### (Syn1-38)

70 Parts of an 18% aqueous solution of sodium hydroxide was added to 300 parts of ice. After that, 34.8 parts of 3′-hydroxyacetoacetanilide was further added, and the mixture was stirred. 23.4 Parts of acetic anhydride was added dropwise over 10 minutes to react, and then the resultant precipitate was collected by filtration. The resultant filtered product was washed with ion-exchanged water, and was then dried to provide 32.2 parts of 3′-acetoxyacetoacetanilide (yield: 76%).

Then, 18.9 parts of Syn1-38 (yield: 87%) was obtained in the same manner as in the case of Syn1-01 described above except that 11.5 parts of the resultant 3′-acetoxyacetoacetanilide was used instead of 10.2 parts of o-acetoacetanisidide.

The analysis result of Syn1-38 by HPLC/MS is shown below.

### [HPLC/MS]

Measured value: MS (ES+) m/z 446.32 (M+H)⁺

MS (ES−) m/z 444.34 (M−H)⁻

Calculated value: C₂₅H₂₃N₃O₅=445.16

### (Syn1-39)

17.6 Parts of Syn1-39 (yield: 96%) was obtained in the same manner as in the case of Syn1-01 described above except that: 9.26 parts of 4-phenoxyaniline was used instead of 10.0 parts of 3-amino-4-methoxybiphenyl; and 8.68 parts of acetoacetanilide was used instead of 12.2 parts of o-acetoacetanisidide.

The analysis result of Syn1-39 by HPLC/MS is shown below.

### [HPLC/MS]

Measured value: MS (ES+) m/z 374.33 (M+H)⁺

MS (ES−) m/z 372.32 (M−H)⁻

Calculated value: C₂₂H₁₉N₃O₃=373.14

### (Syn1-43)

19.5 Parts of Syn1-43 (yield: 90%) was obtained in the same manner as in the case of Syn1-01 described above except that: 9.26 parts of 4-phenoxyaniline was used instead of 10.0 parts of 3-amino-4-methoxybiphenyl; and 12.0 parts of 2′-(trifluoromethyl)acetoacetanilide was used instead of 12.2 parts of o-acetoacetanisidide.

The analysis result of Syn1-43 by HPLC/MS is shown below.

### [HPLC/MS]

Measured value: MS (ES+) m/z 442.35 (M+H)⁺

MS (ES−) m/z 440.34 (M−H)⁻

Calculated value: C₂₃H₁₈F₃N₃O₃=441.13

### (Comparative Compound 1-1)

C.I. Pigment Yellow 203, which was a pigment derivative (synergist) described in Japanese Patent Laid-Open No. H05-70725, was produced as a comparative compound 1-1. Specifically, 16.2 parts of the comparative compound 1-1 represented by the following formula (1-A) (yield: 89%) was obtained in the same manner as in the case of Syn1-01 described above except that 7.61 parts of 4-methyl-2-nitroaniline was used instead of 10.0 parts of 3-amino-4-methoxybiphenyl.

The analysis result of the comparative compound 1-1 by HPLC/MS is shown below.

### [HPLC/MS]

Measured value: MS (ES+) m/z 371.32 (M+H)⁺

MS (ES−) m/z 369.33 (M−H)⁻

Calculated value: C₁₈H₁₈N₄O₅=370.13

### (Comparative Compound 1-2)

A pigment derivative (synergist) described in Japanese Patent Laid-Open No. 2010-260997 was produced as a comparative compound 1-2. Specifically, 17.9 parts of the comparative compound 1-2 represented by the following formula (1-B) (yield: 85%) was obtained in the same manner as in the case of Syn1-01 described above except that: 12.1 parts of 4-amino-N-(4-methoxyphenyl)benzamide was used instead of 10.0 parts of 3-amino-4-methoxybiphenyl; and 8.68 parts of acetoacetanilide was used instead of 10.2 parts of o-acetoacetanisidide.

The analysis result of the comparative compound 1-2 by HPLC/MS is shown below.

### [HPLC/MS]

Measured value: MS (ES+) m/z 431.32 (M+H)⁺

MS (ES−) m/z 429.31 (M−H)⁻

Calculated value: C₂₄H₂₂N₄O₄=430.16

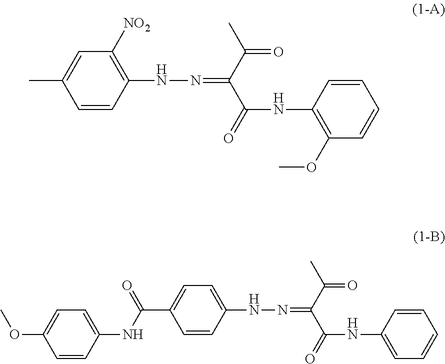 [SMILES: COc1ccccc1NC(=O)C(=NNc1ccc(C)cc1[N+](=O)[O-])C(C)=O ; COc1ccc(NC(=O)c2ccc(NN=C(C(C)=O)C(=O)Nc3ccccc3)cc2)cc1]

### (Syn2-01)

11.3 Parts of 4-chloro-2,5-dimethoxyaniline was added to 109 parts of ion-exchanged water, and the mixture was stirred to prepare a suspension. 15.6 Parts of 35% hydrochloric acid was added, and the mixture was stirred for 1 hour and then cooled in an ice-salt bath until its internal temperature became 0° C. or less. An aqueous solution of sodium nitrite prepared by adding 10.8 parts of ion-exchanged water to 4.18 parts of sodium nitrite was added, and the mixture was stirred for 1 hour to form a diazonium salt while the internal temperature was maintained at 0° C. or less in an ice-salt bath. Thus, a diazonium salt solution was obtained. 0.059 Part of sulfamic acid was added to the resultant diazonium salt solution to remove excess nitrous acid. Thus, a diazo component solution was prepared.

12.2 Parts of o-acetoacetanisidide, 6.14 parts of sodium hydroxide, and 96.7 parts of ion-exchanged water were mixed and stirred until o-acetoacetanisidide and sodium hydroxide were completely dissolved to provide a liquid. The above-mentioned liquid was added to an aqueous solution obtained by mixing 9.84 parts of acetic acid and 65.4 parts of ion-exchanged water, and the mixture was stirred to prepare a coupler component slurry.

The coupler component slurry was heated to 40° C. with a hot stirrer, and while the internal temperature was maintained at 40° C., the diazo component solution was added dropwise over 30 minutes. The mixture was stirred at 40° C. for 30 minutes, and was then increased in temperature to an internal temperature of 70° C. and stirred for 20 minutes to complete the reaction. The reaction precipitate taken out by filtering the reaction liquid was washed three times with an appropriate amount of ion-exchanged water to provide a crude cake of the reaction product. The resultant crude cake was washed by adding ethanol thereto and stirring the mixture for 1 hour. The filtered product obtained by filtration was dried to provide 23.0 parts of Syn2-01 (yield: 97%).

The analysis result of Syn2-01 by HPLC/MS is shown below.

### [HPLC/MS]

Measured value: MS (ES+) m/z 406.32, 408.30 (M+H)⁺

MS (ES−) m/z 404.35, 406.44 (M−H)⁻

Calculated value: C₁₉H₂₀ClN₃O₅=405.11

### (Syn2-02)

22.8 Parts of Syn2-02 (yield: 95%) was obtained in the same manner as in the case of Syn2-01 described above except that 11.3 parts of 5-chloro-2,4-dimethoxyaniline was used instead of 11.3 parts of 4-chloro-2,5-dimethoxyaniline.

The analysis result of Syn2-02 by HPLC/MS is shown below.

### [HPLC/MS]

Measured value: MS (ES+) m/z 406.30, 408.32 (M+H)⁺

MS (ES−) m/z 404.29, 406.33 (M−H)⁻

Calculated value: C₁₉H₂₀ClN₃O₅=405.11

### (Syn2-08)

22.7 Parts of Syn2-08 (yield: 93%) was obtained in the same manner as in the case of Syn2-01 described above except that 11.8 parts of 2,4,5-trichloroaniline was used instead of 11.3 parts of 4-chloro-2,5-dimethoxyaniline.

The analysis result of Syn2-08 by HPLC/MS is shown below.

### [HPLC/MS]

Measured value: MS (ES+) m/z 414.31, 416.30 (M+H)⁺

MS (ES−) m/z 412.34, 414.35 (M−H)⁻

Calculated value: C₁₇H₁₄Cl₃N₃O₃=413.01

### (Syn2-09)

20.5 Parts of Syn2-09 (yield: 94%) was obtained in the same manner as in the case of Syn2-01 described above except that 9.2 parts of 2,5-dimethoxyaniline was used instead of 11.3 parts of 4-chloro-2,5-dimethoxyaniline.

The analysis result of Syn2-09 by HPLC/MS is shown below.

### [HPLC/MS]

Measured value: MS (ES+) m/z 372.33 (M+H)⁺

MS (ES−) m/z 370.36 (M−H)⁻

Calculated value: C₁₉H₂₁N₃O₅=371.15

### (Syn2-10)

20.1 Parts of Syn2-10 (yield: 92%) was obtained in the same manner as in the case of Syn2-01 described above except that 9.2 parts of 2,4-dimethoxyaniline was used instead of 11.3 parts of 4-chloro-2,5-dimethoxyaniline.

The analysis result of Syn2-10 by HPLC/MS is shown below.

### [HPLC/MS]

Measured value: MS (ES+) m/z 372.32 (M+H)⁺

MS (ES−) m/z 370.35 (M−H)⁻

Calculated value: C₁₉H₂₁N₃O₅=371.15

### (Syn2-12)

21.0 Parts of Syn2-12 (yield: 95%) was obtained in the same manner as in the case of Syn2-01 described above except that 9.5 parts of 5-chloro-2-methoxyaniline was used instead of 11.3 parts of 4-chloro-2,5-dimethoxyaniline.

The analysis result of Syn2-12 by HPLC/MS is shown below.

### [HPLC/MS]

Measured value: MS (ES+) m/z 376.34, 378.30 (M+H)⁺

MS (ES−) m/z 374.35, 376.35 (M−H)⁻

Calculated value: C₁₈H₁₈ClN₃O₄=375.10

### (Syn2-13)

21.1 Parts of Syn2-13 (yield: 96%) was obtained in the same manner as in the case of Syn2-01 described above except that 9.5 parts of 4-chloro-2-methoxyaniline was used instead of 11.3 parts of 4-chloro-2,5-dimethoxyaniline.

The analysis result of Syn2-13 by HPLC/MS is shown below.

### [HPLC/MS]

Measured value: MS (ES+) m/z 376.32, 378.32 (M+H)⁺

MS (ES−) m/z 374.33, 376.34 (M−H)⁻

Calculated value: C₁₈H₁₈ClN₃O₄=375.10

### (Syn2-16)

21.0 Parts of Syn2-16 (yield: 94%) was obtained in the same manner as in the case of Syn2-01 described above except that 9.7 parts of 2,5-dichloroaniline was used instead of 11.3 parts of 4-chloro-2,5-dimethoxyaniline.

The analysis result of Syn2-16 by HPLC/MS is shown below.

### [HPLC/MS]

Measured value: MS (ES+) m/z 380.32, 382.33 (M+H)⁺

MS (ES−) m/z 378.33, 380.32 (M−H)⁻

Calculated value: C₁₇H₁₅Cl₂N₃O₃=379.05

### (Syn2-19)

21.3 Parts of Syn2-19 (yield: 91%) was obtained in the same manner as in the case of Syn2-01 described above except that 10.9 parts of 2,5-diethoxyaniline was used instead of 11.3 parts of 4-chloro-2,5-dimethoxyaniline.

The analysis result of Syn2-19 by HPLC/MS is shown below.

### [HPLC/MS]

Measured value: MS (ES+) m/z 400.32 (M+H)⁺

MS (ES−) m/z 398.35 (M−H)⁻

Calculated value: C₂₁H₂₅N₃O₅=399.18

### (Syn2-22)

18.7 Parts of Syn2-22 (yield: 89%) was obtained in the same manner as in the case of Syn2-01 described above except that 8.5 parts of 2-fluoro-5-methoxyaniline was used instead of 11.3 parts of 4-chloro-2,5-dimethoxyaniline.

The analysis result of Syn2-22 by HPLC/MS is shown below.

### [HPLC/MS]

Measured value: MS (ES+) m/z 360.33 (M+H)⁺

MS (ES−) m/z 358.34 (M−H)⁻

Calculated value: C₁₈H₁₈FN₃O₄=359.13

### (Syn2-25)

12.3 Parts of 2-isopropoxyaniline was added to 240 parts of ion-exchanged water heated to 50° C., and the mixture was stirred. After heating to 100° C., 18.2 parts of 2,2,6-trimethyl-1,3-dioxin-4-one was added, and the mixture was stirred for 2.5 hours while being heated at 100° C. After standing to cool, 35.0 parts of 2 mol/L hydrochloric acid was added, and the mixture was stirred. The extract obtained by using ethyl acetate was washed with a saturated aqueous solution of sodium chloride, and was then dried over sodium sulfate. After the removal of sodium sulfate by filtration, ethyl acetate was evaporated with an evaporator. When the resultant viscous product was cooled and left to stand, the viscous product was crystallized and solidified to provide 14.3 parts of 2′-isopropoxyacetoacetanilide as a light brown solid (yield: 75%).

Then, 23.4 parts of Syn2-25 (yield: 92%) was obtained in the same manner as in the case of Syn2-01 described above except that 13.8 parts of the resultant 2′-isopropoxyacetoacetanilide was used instead of 12.2 parts of o-acetoacetanisidide.

The analysis result of Syn2-25 by HPLC/MS is shown below.

### [HPLC/MS]

Measured value: MS (ES+) m/z 434.31, 436.30 (M+H)⁺

MS (ES−) m/z 432.30, 434.35 (M−H)⁻

Calculated value: C₂₁H₂₄ClN₃O₅=433.14

### (Syn2-29)

21.9 Parts of Syn2-29 (yield: 96%) was obtained in the same manner as in the case of Syn2-01 described above except that 11.2 parts of 2′-methylacetoacetanilide was used instead of 12.2 parts of o-acetoacetanisidide.

The analysis result of Syn2-29 by HPLC/MS is shown below.

### [HPLC/MS]

Measured value: MS (ES+) m/z 390.32, 392.33 (M+H)⁺

MS (ES−) m/z 388.32, 390.31 (M−H)⁻

Calculated value: C₁₉H₂₀ClN₃O₄=389.11

### (Syn2-31)

15.2 Parts of 4′-tert-butyl-2′-chloroacetoacetanilide (yield: 70%) was obtained in the same manner as in the case of Syn2-25 described above except that 14.9 parts of 4-tert-butyl-2-chloroaniline was used instead of 12.3 parts of 2-isopropoxyaniline.

Then, 25.4 parts of Syn2-31 (yield: 93%) was obtained in the same manner as in the case of Syn2-01 described above except that 15.7 parts of the resultant 4′-tert-butyl-2′-chloroacetoacetanilide was used instead of 12.2 parts of o-acetoacetanisidide.

The analysis result of Syn2-31 by HPLC/MS is shown below.

### [HPLC/MS]

Measured value: MS (ES+) m/z 466.32, 468.33 (M+H)⁺

MS (ES−) m/z 464.32, 466.34 (M−H)⁻

Calculated value: C₂₂H₂₅Cl₂N₃O₄=465.12

### (Syn2-33)

23.6 Parts of Syn2-33 (yield: 90%) was obtained in the same manner as in the case of Syn2-01 described above except that 14.4 parts of 2′-trifluoromethylacetoacetanilide was used instead of 12.2 parts of o-acetoacetanisidide.

The analysis result of Syn2-33 by HPLC/MS is shown below.

### [HPLC/MS]

Measured value: MS (ES+) m/z 444.33, 446.31 (M+H)⁺

MS (ES−) m/z 442.32, 444.33 (M−H)⁻

Calculated value: C₁₉H₁₇ClF₃N₃O₄=443.09

### (Syn2-34)

23.1 Parts of Syn2-34 (yield: 96%) was obtained in the same manner as in the case of Syn2-01 described above except that 12.4 parts of 2′-chloroacetoacetanilide was used instead of 12.2 parts of o-acetoacetanisidide.

The analysis result of Syn2-34 by HPLC/MS is shown below.

### [HPLC/MS]

Measured value: MS (ES+) m/z 410.34, 412.33 (M+H)⁺

MS (ES−) m/z 408.35, 410.33 (M−H)⁻

Calculated value: C₁₈H₁₇Cl₂N₃O₄=409.06

### (Syn2-42)

24.4 Parts of Syn2-42 (yield: 91%) was obtained in the same manner as in the case of Syn2-01 described above except that 15.1 parts of 4′-chloro-2′-nitroacetoacetanilide was used instead of 12.2 parts of o-acetoacetanisidide.

The analysis result of Syn2-42 by HPLC/MS is shown below.

### [HPLC/MS]

Measured value: MS (ES+) m/z 455.34, 457.31 (M+H)⁺

MS (ES−) m/z 453.32, 455.32 (M−H)⁻

Calculated value: C₁₈H₁₆Cl₂N₄O₆=454.05

### (Syn2-43)

16.0 Parts of 5′-acetoxy-2′-methoxyacetoacetanilide (yield: 74%) was obtained in the same manner as in the case of Syn2-25 described above except that 12.3 parts of 5-acetoxy-2-methoxyaniline was used instead of 12.3 parts of 2-isopropoxyaniline.

Then, 24.7 parts of Syn2-43 (yield: 91%) was obtained in the same manner as in the case of Syn2-01 described above except that 15.6 parts of the resultant 5′-acetoxy-2′-methoxyacetoacetanilide was used instead of 12.2 parts of o-acetoacetanisidide.

The analysis result of Syn2-43 by HPLC/MS is shown below.

### [HPLC/MS]

Measured value: MS (ES+) m/z 464.32, 466.33 (M+H)⁺

MS (ES−) m/z 462.33, 464.32 (M−H)⁻

Calculated value: C₂₁H₂₂ClN₃O₇=463.12

### (Syn2-46)

13.5 Parts of 2′-acetylacetoacetanilide (yield: 76%) was obtained in the same manner as in the case of Syn2-25 described above except that 11.0 parts of 2-acetylaniline was used instead of 12.3 parts of 2-isopropoxyaniline.

Then, 22.9 parts of Syn2-46 (yield: 93%) was obtained in the same manner as in the case of Syn2-01 described above except that 12.9 parts of the resultant 2′-acetylacetoacetanilide was used instead of 12.2 parts of o-acetoacetanisidide.

The analysis result of Syn2-46 by HPLC/MS is shown below.

### [HPLC/MS]

Measured value: MS (ES+) m/z 418.34, 420.32 (M+H)⁺

MS (ES−) m/z 416.33, 418.34 (M−H)⁻

Calculated value: C₂₀H₂₀ClN₃O₅=417.11

### (Syn2-49)

24.0 Parts of Syn2-49 (yield: 94%) was obtained in the same manner as in the case of Syn2-01 described above except that 13.8 parts of methyl 2-(acetoacetylamino)benzoate was used instead of 12.2 parts of o-acetoacetanisidide.

The analysis result of Syn2-49 by HPLC/MS is shown below.

### [HPLC/MS]

Measured value: MS (ES+) m/z 434.32, 436.32 (M+H)⁺

MS (ES−) m/z 432.30, 434.31 (M−H)⁻

Calculated value: C₂₀H₂₀ClN₃O₆=433.10

### (Comparative Compound 2-1)

C.I. Pigment Yellow 203, which was a pigment derivative (synergist) described in Japanese Patent Laid-Open No. H05-70725, was produced as a comparative compound 2-1. Specifically, 19.2 parts of the comparative compound 2-1 represented by the following formula (2-A) (yield: 88%) was obtained in the same manner as in the case of Syn2-01 described above except that 9.1 parts of 4-methyl-2-nitroaniline was used instead of 11.3 parts of 4-chloro-2,5-dimethoxyaniline.

The analysis result of the comparative compound 2-1 by HPLC/MS is shown below.

### [HPLC/MS]

Measured value: MS (ES+) m/z 371.32 (M+H)⁺

MS (ES−) m/z 369.31 (M−H)⁻

Calculated value: C₁₈H₁₈N₄O₅=370.13

### (Comparative Compound 2-2)

A pigment derivative (synergist) described in Japanese Patent Laid-Open No. S57-126856 was produced as a comparative compound 2-2. Specifically, 20.4 parts of the comparative compound 2-2 represented by the following formula (2-B) (yield: 90%) was obtained in the same manner as in the case of Syn2-01 described above except that: 11.8 parts of 2,4,5-trichloroaniline was used instead of 11.3 parts of 4-chloro-2,5-dimethoxyaniline; and 10.4 parts of acetoacetanilide was used instead of 12.2 parts of o-acetoacetanisidide.

The analysis result of the comparative compound 2-2 by HPLC/MS is shown below.

### [HPLC/MS]

Measured value: MS (ES+) m/z 384.30, 386.32 (M+H)⁺

MS (ES−) m/z 382.31, 384.30 (M−H)⁻

Calculated value: C₁₆H₁₂Cl₃N₃O₂=383.00

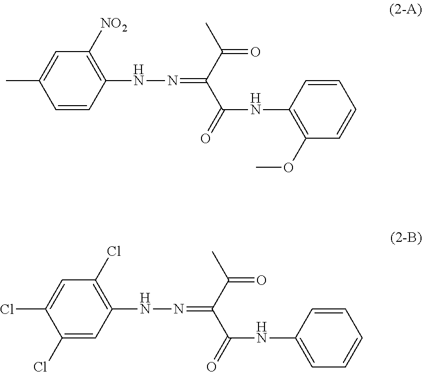 [SMILES: COc1ccccc1NC(=O)C(=NNc1ccc(C)cc1[N+](=O)[O-])C(C)=O ; CC(=O)C(=NNc1cc(Cl)c(Cl)cc1Cl)C(=O)Nc1ccccc1]

### <Production of Mixed Coupling Product>

### (Mixed Coupling Product 1-1)

42.3 Parts of 2-methoxy-4-nitroaniline and 2.64 parts of 3-amino-4-methoxybiphenyl were added to 337 parts of ion-exchanged water, and the contents were stirred and mixed to prepare a suspension. 69.0 Parts of 35% hydrochloric acid was added, and the mixture was stirred for 1 hour and then cooled in an ice-salt bath until its internal temperature became 0° C. or less. An aqueous solution of sodium nitrite prepared by adding 44.0 parts of ion-exchanged water to 18.5 parts of sodium nitrite was added, and the mixture was stirred for 1 hour to form a diazonium salt while the internal temperature was maintained at 0° C. or less in the ice-salt bath. Thus, a diazonium salt solution was obtained. 0.258 Part of sulfamic acid was added to the resultant diazonium salt solution to remove excess nitrous acid. Thus, a mixed diazo component solution was prepared.

53.8 Parts of o-acetoacetanisidide, 27.1 parts of sodium hydroxide, and 427 parts of ion-exchanged water were mixed and stirred until o-acetoacetanisidide and sodium hydroxide were completely dissolved to provide a liquid. The above-mentioned liquid was added to an aqueous solution obtained by mixing 43.4 parts of acetic acid and 289 parts of ion-exchanged water, and the mixture was stirred to prepare a coupler component slurry.

The coupler component slurry was heated to 40° C. with an oil bath, and while the internal temperature was maintained at 40° C., the mixed diazo component solution was added dropwise over 45 minutes. The mixture was stirred at 40° C. for 30 minutes, and was then increased in temperature to an internal temperature of 70° C. and stirred for 20 minutes to complete the reaction. The reaction liquid was left to stand to cool to room temperature, and then the reaction precipitate taken out of the liquid by filtration was washed three times with 1,500 parts of ion-exchanged water to provide a cake-like crude reaction product. 5,000 Parts of ion-exchanged water was added to the crude reaction product to provide a slurry, and the slurry was washed under stirring for 1 hour and filtered. 2,500 Parts of ethanol was added to the filtered product to wash the filtered product in the same manner. After that, the resultant filtered product was dried to provide 97.6 parts of a mixed coupling product 1-1 (yield: 97%) containing PY74 and Syn1-01.

The analysis result of the mixed coupling product 1-1 by HPLC/MS is shown below.

### [HPLC/MS]

### (i) Peak (a): PY74

Measured value: MS (ES+) m/z 387.34 (M+H)⁺

MS (ES−) m/z 385.35 (M−H)⁻

Calculated value: C₁₈H₁₈N₄O₆=386.12

### (ii) Peak (b): Syn1-01

Measured value: MS (ES+) m/z 418.34 (M+H)⁺

MS (ES−) m/z 416.33 (M−H)⁻

Calculated value: C₂₄H₂₃N₃O₄=417.17

(iii) Mass Ratio

PY74: 95.16%

Syn1-01: 4.84%

Mass ratio of Syn1-01 to PY74 (Syn1-01/PY74): 0.051

### (Mixed Coupling Product 1-2)

A mixed diazo component solution and a coupler component slurry were prepared in the same manner as in the case of the mixed coupling product 1-1 described above. The coupler component slurry was heated to 40° C. with an oil bath, and while the internal temperature was maintained at 40° C., the mixed diazo component solution was added dropwise over 45 minutes. Next, an acetic acid solution of a rosin amine obtained by dissolving 1.26 parts of a rosin amine in 6.67 parts of acetic acid was added. The mixture was stirred for 5 minutes, and then an aqueous solution of sodium hydroxide was added to adjust the pH to 8.5. The mixture was further stirred for 5 minutes. Acetic acid was added to adjust the pH to 7.0, and then the mixture was increased in temperature to an internal temperature of 70° C. and stirred for 20 minutes to complete the reaction. After the reaction liquid had been left to stand to cool to room temperature, the reaction precipitate taken out of the liquid by filtration was washed three times with 1,500 parts of ion-exchanged water to provide a cake-like crude reaction product. 5,000 Parts of ion-exchanged water was added to the crude reaction product to provide a slurry, and the slurry was washed under stirring for 1 hour and filtered. After 2,500 parts of ethanol had been added to the filtered product for washing in the same manner, the resultant filtered product was dried to provide 93.2 parts of a mixed coupling product 1-2 (yield: 91%) containing PY74 and Syn1-01, and subjected to rosin amine treatment.

The analysis result of the mixed coupling product 1-2 by HPLC/MS is shown below.

### [HPLC/MS]

### (i) Peak (a): PY74

Measured value: MS (ES+) m/z 387.33 (M+H)⁺

MS (ES−) m/z 385.33 (M−H)⁻

Calculated value: C₁₈H₁₈N₄O₆=386.12

### (ii) Peak (b): Syn1-01

Measured value: MS (ES+) m/z 418.33 (M+H)⁺

MS (ES−) m/z 416.32 (M−H)⁻

Calculated value: C₂₄H₂₃N₃O₄=417.17

(iii) Mass Ratio

PY74: 94.39%

Syn1-01: 4.65%

Rosin amine: 0.95%

Mass ratio of Syn1-01 to PY74 (Syn1-01/PY74): 0.049

Mass ratio of rosin amine to PY74 (rosin amine/PY74): 0.010

### (Mixed Coupling Product 2-1)

47.9 Parts of 2-methoxy-4-nitroaniline and 2.8 parts of 4-chloro-2,5-dimethoxyaniline were added to 360 parts of ion-exchanged water, and the mixture was stirred to prepare a suspension. 78.1 Parts of 35% hydrochloric acid was added, and the mixture was stirred for 1 hour and then cooled in an ice-salt bath until its internal temperature became 0° C. or less. An aqueous solution of sodium nitrite prepared by adding 53.7 parts of ion-exchanged water to 20.9 parts of sodium nitrite was added, and the mixture was stirred for 1 hour to form a diazonium salt while the internal temperature was maintained at 0° C. or less in the ice-salt bath. Thus, a diazonium salt solution was obtained. 0.29 Part of sulfamic acid was added to the resultant diazonium salt solution to remove excess nitrous acid. Thus, a mixed diazo component solution was prepared.

60.9 Parts of o-acetoacetanisidide, 30.7 parts of sodium hydroxide, and 400 parts of ion-exchanged water were mixed and stirred until o-acetoacetanisidide and sodium hydroxide were completely dissolved to provide a liquid. The above-mentioned liquid was added to an aqueous solution obtained by mixing 49.2 parts of acetic acid and 327 parts of ion-exchanged water, and the mixture was stirred to prepare a coupler component slurry.

The coupler component slurry was heated to 40° C. with an oil bath, and while the internal temperature was maintained at 40° C., the mixed diazo component solution was added dropwise over 45 minutes. The mixture was stirred at 40° C. for 30 minutes, and was then increased in temperature to an internal temperature of 70° C. and stirred for 20 minutes to complete the reaction. The reaction liquid was left to stand to cool to room temperature, and then the reaction precipitate taken out by filtration was washed three times with 1,500 parts of ion-exchanged water to provide a cake-like crude reaction product. 5,000 Parts of ion-exchanged water was added to the crude reaction product to provide a slurry, and the slurry was washed under stirring for 1 hour and filtered. The filtered product was washed by adding 2,500 parts of ethanol thereto in the same manner, and then the resultant filtered product was dried to provide 108 parts of a mixed coupling product 2-1 (yield: 95%) containing PY74 and Syn2-01.

The analysis result of the mixed coupling product 2-1 by HPLC/MS is shown below.

### [HPLC/MS]

### (i) Peak (a): PY74

Measured value: MS (ES+) m/z 387.32 (M+H)⁺

MS (ES−) m/z 385.33 (M−H)⁻

Calculated value: C₁₈H₁₈N₄O₆=386.12

### (ii) Peak (b): Syn2-01

Measured value: MS (ES+) m/z 406.31, 408.32 (M+H)⁺

MS (ES−) m/z 404.33, 406.36 (M−H)⁻

Calculated value: C₁₉H₂₀ClN₃O₅=405.11

(iii) Mass Ratio

PY74: 95.87%

Syn2-01: 4.13%

Mass ratio of Syn2-01 to PY74 (Syn2-01/PY74): 0.043

### (Mixed Coupling Product 2-2)

A mixed diazo component solution and a coupler component slurry were prepared in the same manner as in the case of the mixed coupling product 2-1 described above. The coupler component slurry was heated to 40° C. with an oil bath, and while the internal temperature was maintained at 40° C., the mixed diazo component solution was added dropwise over 45 minutes. Next, an acetic acid solution of a rosin amine obtained by dissolving 1.37 parts of a rosin amine in 7.24 parts of acetic acid was added. The mixture was stirred for 5 minutes, and was then adjusted to have a pH of 8.5 by adding an aqueous solution of sodium hydroxide and further stirred for 5 minutes. The mixture was adjusted to have a pH of 7.0 by adding acetic acid, and was then increased in temperature to an internal temperature of 70° C. and stirred for 20 minutes to complete the reaction. The reaction liquid was left to stand to cool to room temperature, and then the reaction precipitate taken out by filtration was washed three times with 1,500 parts of ion-exchanged water to provide a cake-like crude reaction product. 5,000 Parts of ion-exchanged water was added to the crude reaction product to provide a slurry, and the slurry was washed under stirring for 1 hour and filtered. The filtered product was washed by adding 2,500 parts of ethanol thereto in the same manner, and then the resultant filtered product was dried to provide 107 parts of a mixed coupling product 2-2 (yield: 92%) containing PY74 and Syn2-01, the mixed coupling product being treated with the rosin amine.

The analysis result of the mixed coupling product 2-2 by HPLC/MS is shown below.

### [HPLC/MS]

### (i) Peak (a): PY74

Measured value: MS (ES+) m/z 387.33 (M+H)⁺

MS (ES−) m/z 385.32 (M−H)⁻

Calculated value: C₁₈H₁₈N₄O₆=386.12

### (ii) Peak (b): Syn2-01

Measured value: MS (ES+) m/z 406.31, 408.32 (M+H)⁺

MS (ES−) m/z 404.32, 406.35 (M−H)⁻

Calculated value: C₁₉H₂₀ClN₃O₅=405.11

(iii) Mass Ratio

PY74: 94.87% Syn2-01: 4.17% (Mass ratio to PY74: 0.044)

Rosin amine: 0.96%

Mass ratio of Syn2-01 to PY74 (Syn2-01/PY74): 0.044

Mass ratio of rosin amine to PY74 (rosin amine/PY74): 0.010

### <Preparation of Pigment Composition>

### (Crude Yellow Pigment)

Crude yellow pigments Y1-1 to Y1-8 and Y2-1 to Y2-9 whose kinds were shown in Table 1-2 and Table 2-2 were prepared. The meanings of abbreviations in Table 1-2 and Table 2-2 are shown below.

PY74: C.I. Pigment Yellow 74

PY73: C.I. Pigment Yellow 73

PY3: C.I. Pigment Yellow 3

PY13: C.I. Pigment Yellow 13

RA: rosin amine

HR: hydrogenated rosin

TABLE 1-2
Crude yellow pigment

Rosin treatment

| | | | Content |
|---|---|---|---|
| Crude yellow | Base pigment | | Mass ratio |
| pigment | Kind | Rosin | (to base pigment) |
| Y1-1 | PY74 | None | — |
| Y1-2 | PY74 | RA | 0.001 |
| Y1-3 | PY74 | RA | 0.010 |
| Y1-4 | PY74 | RA | 0.050 |
| Y1-5 | PY74 | RA | 0.070 |
| Y1-6 | PY74 | HR | 0.040 |
| Y1-7 | PY73 | RA | 0.010 |
| Y1-8 | PY3 | RA | 0.010 |

TABLE 2-2
Crude yellow pigment

Rosin treatment

| | | | Content |
|---|---|---|---|
| Crude yellow | Base pigment | | Mass ratio |
| pigment | Kind | Rosin | (to base pigment) |
| Y2-1 | PY74 | None | — |
| Y2-2 | PY74 | RA | 0.001 |
| Y2-3 | PY74 | RA | 0.010 |
| Y2-4 | PY74 | RA | 0.050 |
| Y2-5 | PY74 | RA | 0.070 |
| Y2-6 | PY74 | HR | 0.040 |
| Y2-7 | PY73 | RA | 0.001 |
| Y2-8 | PY3 | RA | 0.010 |
| Y2-9 | PY13 | RA | 0.010 |

### (Pigment Compositions 1-1 and 1-27)

500 Parts of sodium chloride (product name: “Nakuru Four 1”, manufactured by Naikai Salt Industries Co., Ltd.) and 85 parts of diethylene glycol were added to 100 parts of a mixed coupling product whose kind was shown in Table 1-3. Then, pigments were mixed and subjected to micronization treatment by a solvent salt milling method including kneading at 30° C. for 4 hours with a kneader (product name: “TX-2L”, manufactured by Inoue Mfg., Inc.) to provide a kneaded product. The resultant kneaded product was sufficiently washed with ion-exchanged water, and was then filtered and dried. Thus, pigment compositions 1-1 and 1-27 were obtained.

### (Pigment Compositions 1-5, 1-7 to 1-26, and 1-28 to 1-37)

Pigment compositions 1-5, 1-7 to 1-26, and 1-28 to 1-37 were each obtained by the same solvent salt milling method as that in the case of each of the pigment compositions 1-1 and 1-27 described above by using a crude yellow pigment and a pigment derivative whose kinds and amounts were shown in Table 1-3. The pigment compositions 1-34 and 1-35 were each obtained by using only the crude yellow pigment as a raw material without using the pigment derivative.

### (Pigment Compositions 1-3 and 1-4)

A suspension obtained by mixing a crude yellow pigment and a pigment derivative whose kinds and usage amounts were shown in Table 1-3, and adding 1,000 parts of a solvent whose kind was shown in Table 1-3 was stirred at 25° C. for 2 hours. The suspension was filtered to provide a filtered product. The resultant filtered product was subjected to pretreatment including washing twice by adding 3,000 parts of ion-exchanged water and stirring the mixture for 30 minutes, followed by drying, to provide a pretreated pigment. Then, pigment compositions 1-3 and 1-4 were each obtained in the same manner as in the case of each of the pigment compositions 1-1 and 1-27 described above except that the resultant pretreated pigment was used instead of the mixed coupling product. In Table 1-3, “NMP” means N-methylpyrrolidone, and “DMSO” means dimethyl sulfoxide.

### (Pigment Compositions 1-2 and 1-6)

Raw materials whose kinds and usage amounts were shown in Table 1-3 were loaded into a mortar and mixed well to provide pigment compositions 1-2 and 1-6. That is, pigments were subjected to micronization treatment by a dry grinding method to prepare the pigment compositions 1-2 and 1-6.

The characteristics of the resultant pigment compositions are summarized in Table 1-3.

TABLE 1-3
Preparation and characteristics of pigment composition

| | | | Raw material | | | | | |
|---|---|---|---|---|---|---|---|---|
| | | | Crude yellow | | Pigment | | Mixed coupling | |
| | | | pigment | | derivative | | product | |
| | Pretreatment | | | Usage | | Usage | | Usage |
| Pigment | Kind of | | | amount | | amount | | amount |
| composition | solvent | Milling | Kind | (part(s)) | Kind | (part(s)) | Kind | (part(s)) |
| 1-1 | — | ∘ | — | — | — | — | 1-2 | 100 |
| 1-2 | — | — | — | — | — | — | 1-2 | 100 |
| 1-3 | NMP | ∘ | Y1-3 | 95 | Syn1-01 | 5 | — | — |
| 1-4 | DMSO | ∘ | Y1-3 | 95 | Syn1-01 | 5 | — | — |
| 1-5 | — | ∘ | Y1-3 | 95 | Syn1-01 | 5 | — | — |
| 1-6 | — | — | Y1-3 | 95 | Syn1-01 | 5 | — | — |
| 1-7 | — | ∘ | Y1-3 | 95 | Syn1-02 | 5 | — | — |
| 1-8 | — | ∘ | Y1-3 | 95 | Syn1-03 | 5 | — | — |
| 1-9 | — | ∘ | Y1-3 | 95 | Syn1-11 | 5 | — | — |
| 1-10 | — | ∘ | Y1-3 | 95 | Syn1-12 | 5 | — | — |
| 1-11 | — | ∘ | Y1-3 | 95 | Syn1-17 | 5 | — | — |
| 1-12 | — | ∘ | Y1-3 | 95 | Syn1-19 | 5 | — | — |
| 1-13 | — | ∘ | Y1-3 | 95 | Syn1-22 | 5 | — | — |
| 1-14 | — | ∘ | Y1-3 | 95 | Syn1-23 | 5 | — | — |
| 1-15 | — | ∘ | Y1-3 | 95 | Syn1-26 | 5 | — | — |
| 1-16 | — | ∘ | Y1-3 | 95 | Syn1-27 | 5 | — | — |
| 1-17 | — | ∘ | Y1-3 | 95 | Syn1-29 | 5 | — | — |
| 1-18 | — | ∘ | Y1-3 | 95 | Syn1-36 | 5 | — | — |
| 1-19 | — | ∘ | Y1-3 | 95 | Syn1-37 | 5 | — | — |
| 1-20 | — | ∘ | Y1-3 | 95 | Syn1-38 | 5 | — | — |
| 1-21 | — | ∘ | Y1-3 | 95 | Syn1-39 | 5 | — | — |
| 1-22 | — | ∘ | Y1-3 | 95 | Syn1-43 | 5 | — | — |
| 1-23 | — | ∘ | Y1-3 | 99.9 | Syn1-01 | 0.1 | — | — |
| 1-24 | — | ∘ | Y1-3 | 91 | Syn1-01 | 9 | — | — |
| 1-25 | — | ∘ | Y1-3 | 87 | Syn1-01 | 13 | — | — |
| 1-26 | — | ∘ | Y1-6 | 95 | Syn1-01 | 5 | — | — |
| 1-27 | — | ∘ | — | — | — | — | 1-1 | 100 |
| 1-28 | — | ∘ | Y1-1 | 95 | Syn1-01 | 5 | — | — |
| 1-29 | — | ∘ | Y1-2 | 95 | Syn1-01 | 5 | — | — |
| 1-30 | — | ∘ | Y1-4 | 95 | Syn1-01 | 5 | — | — |
| 1-31 | — | ∘ | Y1-5 | 95 | Syn1-01 | 5 | — | — |
| 1-32 | — | ∘ | Y1-7 | 95 | Syn1-01 | 5 | — | — |
| 1-33 | — | ∘ | Y1-8 | 95 | Syn1-32 | 5 | — | — |
| 1-34 | — | ∘ | Y1-1 | 100 | — | — | — | — |
| 1-35 | — | ∘ | Y1-3 | 100 | — | — | — | — |
| 1-36 | — | ∘ | Y1-3 | 95 | Comparative | 5 | — | — |
| | — | | | | compound 1-1 | | | |
| 1-37 | — | ∘ | Y1-3 | 95 | Comparative | 5 | — | — |
| | | | | | compound 1-2 | | | |

| | Characteristics | | | | |
|---|---|---|---|---|---|
| | | Pigment | | Rosin | |
| | Yellow monoazo | derivative (B) | | (C) | |
| Pigment | pigment (A) | | Mass ratio | | Mass ratio |
| composition | Kind | Kind | B/A | Kind | C/A |
| 1-1 | PY74 | Syn1-01 | 0.049 | RA | 0.010 |
| 1-2 | PY74 | Syn1-01 | 0.049 | RA | 0.010 |
| 1-3 | PY74 | Syn1-01 | 0.053 | RA | 0.010 |
| 1-4 | PY74 | Syn1-01 | 0.053 | RA | 0.010 |
| 1-5 | PY74 | Syn1-01 | 0.053 | RA | 0.010 |
| 1-6 | PY74 | Syn1-01 | 0.053 | RA | 0.010 |
| 1-7 | PY74 | Syn1-02 | 0.053 | RA | 0.010 |
| 1-8 | PY74 | Syn1-03 | 0.053 | RA | 0.010 |
| 1-9 | PY74 | Syn1-11 | 0.053 | RA | 0.010 |
| 1-10 | PY74 | Syn1-12 | 0.053 | RA | 0.010 |
| 1-11 | PY74 | Syn1-17 | 0.053 | RA | 0.010 |
| 1-12 | PY74 | Syn1-19 | 0.053 | RA | 0.010 |
| 1-13 | PY74 | Syn1-22 | 0.053 | RA | 0.010 |
| 1-14 | PY74 | Syn1-23 | 0.053 | RA | 0.010 |
| 1-15 | PY74 | Syn1-26 | 0.053 | RA | 0.010 |
| 1-16 | PY74 | Syn1-27 | 0.053 | RA | 0.010 |
| 1-17 | PY74 | Syn1-29 | 0.053 | RA | 0.010 |
| 1-18 | PY74 | Syn1-36 | 0.053 | RA | 0.010 |
| 1-19 | PY74 | Syn1-37 | 0.053 | RA | 0.010 |
| 1-20 | PY74 | Syn1-38 | 0.053 | RA | 0.010 |
| 1-21 | PY74 | Syn1-39 | 0.053 | RA | 0.010 |
| 1-22 | PY74 | Syn1-43 | 0.053 | RA | 0.010 |
| 1-23 | PY74 | Syn1-01 | 0.001 | RA | 0.010 |
| 1-24 | PY74 | Syn1-01 | 0.100 | RA | 0.010 |
| 1-25 | PY74 | Syn1-01 | 0.151 | RA | 0.010 |
| 1-26 | PY74 | Syn1-01 | 0.055 | HR | 0.040 |
| 1-27 | PY74 | Syn1-01 | 0.051 | — | — |
| 1-28 | PY74 | Syn1-01 | 0.053 | — | — |
| 1-29 | PY74 | Syn1-01 | 0.053 | RA | 0.001 |
| 1-30 | PY74 | Syn1-01 | 0.055 | RA | 0.050 |
| 1-31 | PY74 | Syn1-01 | 0.057 | RA | 0.070 |
| 1-32 | PY73 | Syn1-01 | 0.053 | RA | 0.010 |
| 1-33 | PY3 | Syn1-32 | 0.053 | RA | 0.010 |
| 1-34 | PY74 | — | — | — | — |
| 1-35 | PY74 | — | — | RA | 0.010 |
| 1-36 | PY74 | Comparative | 0.053 | RA | 0.010 |
| | | compound 1-1 | | | |
| 1-37 | PY74 | Comparative | 0.053 | RA | 0.010 |
| | | compound 1-2 | | | |

### (Pigment Compositions 2-1 and 2-2)

500 Parts of sodium chloride (product name: “Nakuru Four 1”, manufactured by Naikai Salt Industries Co., Ltd.) and 85 parts of diethylene glycol were added to 100 parts of each of mixed coupling products whose kinds were shown in Table 2-3. Then, pigment mixing and micronization treatment were performed by a solvent salt milling method including kneading at 30° C. for 4 hours with a kneader (product name: “TX-2L”, manufactured by Inoue Mfg., Inc.) to provide a kneaded product. The resultant kneaded product was sufficiently washed with ion-exchanged water, and was then filtered and dried. Thus, pigment compositions 2-1 and 2-2 were obtained.

### (Pigment Compositions 2-5 to 2-32 and 2-35 to 2-39)

Pigment compositions 2-5 to 2-32 and 2-35 to 2-39 were each obtained by the same solvent salt milling method as in the case of each of the pigment compositions 2-1 and 2-2 described above by using a crude yellow pigment and a pigment derivative whose kinds and usage amounts were shown in Table 2-3. The pigment compositions 2-35 and 2-36 were each obtained by using only the crude yellow pigment as a raw material without using the pigment derivative.

### (Pigment Compositions 2-3 and 2-4)

A suspension obtained by mixing a crude yellow pigment and a pigment derivative whose kinds and usage amounts were shown in Table 2-3, and adding 1,000 parts of a solvent whose kind was shown in Table 2-3 was stirred at 25° C. for 2 hours. The suspension was filtered to provide a filtered product. The resultant filtered product was subjected to pretreatment including washing twice by adding 3,000 parts of ion-exchanged water and stirring the mixture for 30 minutes, followed by drying, to provide a pretreated pigment. Then, pigment compositions 2-3 and 2-4 were each obtained in the same manner as in the case of each of the pigment compositions 2-1 and 2-2 described above except that the resultant pretreated pigment was used instead of the mixed coupling product. In Table 2-3, “NMP” means N-methylpyrrolidone, and “DMSO” means dimethyl sulfoxide.

### (Pigment Compositions 2-33 and 2-34)

Raw materials whose kinds and usage amounts were shown in Table 2-3 were loaded into a mortar and mixed well to provide each of pigment compositions 2-33 and 2-34. That is, pigments were subjected to micronization treatment by a dry grinding method to prepare each of the pigment compositions 2-33 and 2-34.

The characteristics of the resultant pigment compositions are summarized in Table 2-3.

TABLE 2-3
Preparation and characteristics of pigment composition

| | | | Raw material | | | | | |
|---|---|---|---|---|---|---|---|---|
| | | | Crude yellow | | Pigment | | Mixed coupling | |
| | | | pigment | | derivative | | product | |
| | Pretreatment | | | Usage | | Usage | | Usage |
| Pigment | Kind of | | | amount | | amount | | amount |
| composition | solvent | Milling | Kind | (part(s)) | Kind | (part(s)) | Kind | (part(s)) |
| 2-1 | — | ∘ | — | — | — | — | 2-1 | 100 |
| 2-2 | — | ∘ | — | — | — | — | 2-2 | 100 |
| 2-3 | NMP | ∘ | Y2-3 | 95 | Syn2-01 | 5 | — | — |
| 2-4 | DMSO | ∘ | Y2-3 | 95 | Syn2-01 | 5 | — | — |
| 2-5 | — | ∘ | Y2-3 | 95 | Syn2-01 | 5 | — | — |
| 2-6 | — | ∘ | Y2-3 | 100 | Syn2-01 | 0.1 | — | — |
| 2-7 | — | ∘ | Y2-3 | 91 | Syn2-01 | 9 | — | — |
| 2-8 | — | ∘ | Y2-3 | 87 | Syn2-01 | 13 | — | — |
| 2-9 | — | ∘ | Y2-2 | 95 | Syn2-01 | 5 | — | — |
| 2-10 | — | ∘ | Y2-4 | 95 | Syn2-01 | 5 | — | — |
| 2-11 | — | ∘ | Y2-5 | 95 | Syn2-01 | 5 | — | — |
| 2-12 | — | ∘ | Y2-6 | 95 | Syn2-01 | 5 | — | — |
| 2-13 | — | ∘ | Y2-1 | 95 | Syn2-01 | 5 | — | — |
| 2-14 | — | ∘ | Y2-3 | 95 | Syn2-02 | 5 | — | — |
| 2-15 | — | ∘ | Y2-3 | 95 | Syn2-08 | 5 | — | — |
| 2-16 | — | ∘ | Y2-3 | 95 | Syn2-09 | 5 | — | — |
| 2-17 | — | ∘ | Y2-3 | 95 | Syn2-10 | 5 | — | — |
| 2-18 | — | ∘ | Y2-3 | 95 | Syn2-12 | 5 | — | — |
| 2-19 | — | ∘ | Y2-3 | 95 | Syn2-13 | 5 | — | — |
| 2-20 | — | ∘ | Y2-3 | 95 | Syn2-16 | 5 | — | — |
| 2-21 | — | ∘ | Y2-3 | 95 | Syn2-19 | 5 | — | — |
| 2-22 | — | ∘ | Y2-3 | 95 | Syn2-22 | 5 | — | — |
| 2-23 | — | ∘ | Y2-3 | 95 | Syn2-25 | 5 | — | — |
| 2-24 | — | ∘ | Y2-3 | 95 | Syn2-29 | 5 | — | — |
| 2-25 | — | ∘ | Y2-3 | 95 | Syn2-31 | 5 | — | — |
| 2-26 | — | ∘ | Y2-3 | 95 | Syn2-33 | 5 | — | — |
| 2-27 | — | ∘ | Y2-3 | 95 | Syn2-42 | 5 | — | — |
| 2-28 | — | ∘ | Y2-3 | 95 | Syn2-43 | 5 | — | — |
| 2-29 | — | ∘ | Y2-3 | 95 | Syn2-46 | 5 | — | — |
| 2-30 | — | ∘ | Y2-3 | 95 | Syn2-49 | 5 | — | — |
| 2-31 | — | ∘ | Y2-7 | 95 | Syn2-01 | 5 | — | — |
| 2-32 | — | ∘ | Y2-8 | 95 | Syn2-34 | 5 | — | — |
| 2-33 | — | — | — | — | — | — | 2-2 | 100 |
| 2-34 | — | — | Y2-3 | 95 | Syn2-01 | 5 | — | — |
| 2-35 | — | ∘ | Y2-1 | 100 | — | — | — | — |
| 2-36 | — | ∘ | Y2-3 | 100 | — | — | — | — |
| 2-37 | — | ∘ | Y2-9 | 95 | Syn2-01 | 5 | — | — |
| 2-38 | — | ∘ | Y2-3 | 95 | Comparative | 5 | — | — |
| | | | | | compound 2-1 | | | |
| 2-39 | — | ∘ | Y2-3 | 95 | Comparative | 5 | — | — |
| | | | | | compound 2-2 | | | |

| | Characteristics | | | | |
|---|---|---|---|---|---|
| | | Pigment | | Rosin | |
| | Yellow monoazo | derivative (B) | | (C) | |
| Pigment | pigment (A) | | Mass ratio | | Mass ratio |
| composition | Kind | Kind | B/A | Kind | C/A |
| 2-1 | PY74 | Syn2-01 | 0.043 | — | — |
| 2-2 | PY74 | Syn2-01 | 0.044 | RA | 0.010 |
| 2-3 | PY74 | Syn2-01 | 0.053 | RA | 0.010 |
| 2-4 | PY74 | Syn2-01 | 0.053 | RA | 0.010 |
| 2-5 | PY74 | Syn2-01 | 0.053 | RA | 0.010 |
| 2-6 | PY74 | Syn2-01 | 0.001 | RA | 0.010 |
| 2-7 | PY74 | Syn2-01 | 0.100 | RA | 0.010 |
| 2-8 | PY74 | Syn2-01 | 0.151 | RA | 0.010 |
| 2-9 | PY74 | Syn2-01 | 0.053 | RA | 0.001 |
| 2-10 | PY74 | Syn2-01 | 0.055 | RA | 0.050 |
| 2-11 | PY74 | Syn2-01 | 0.057 | RA | 0.070 |
| 2-12 | PY74 | Syn2-01 | 0.055 | HR | 0.040 |
| 2-13 | PY74 | Syn2-01 | 0.053 | — | — |
| 2-14 | PY74 | Syn2-02 | 0.053 | RA | 0.010 |
| 2-15 | PY74 | Syn2-08 | 0.053 | RA | 0.010 |
| 2-16 | PY74 | Syn2-09 | 0.053 | RA | 0.010 |
| 2-17 | PY74 | Syn2-10 | 0.053 | RA | 0.010 |
| 2-18 | PY74 | Syn2-12 | 0.053 | RA | 0.010 |
| 2-19 | PY74 | Syn2-13 | 0.053 | RA | 0.010 |
| 2-20 | PY74 | Syn2-16 | 0.053 | RA | 0.010 |
| 2-21 | PY74 | Syn2-19 | 0.053 | RA | 0.010 |
| 2-22 | PY74 | Syn2-22 | 0.053 | RA | 0.010 |
| 2-23 | PY74 | Syn2-25 | 0.053 | RA | 0.010 |
| 2-24 | PY74 | Syn2-29 | 0.053 | RA | 0.010 |
| 2-25 | PY74 | Syn2-31 | 0.053 | RA | 0.010 |
| 2-26 | PY74 | Syn2-33 | 0.053 | RA | 0.010 |
| 2-27 | PY74 | Syn2-42 | 0.053 | RA | 0.010 |
| 2-28 | PY74 | Syn2-43 | 0.053 | RA | 0.010 |
| 2-29 | PY74 | Syn2-46 | 0.053 | RA | 0.010 |
| 2-30 | PY74 | Syn2-49 | 0.053 | RA | 0.010 |
| 2-31 | PY73 | Syn2-01 | 0.053 | RA | 0.010 |
| 2-32 | PY3 | Syn2-34 | 0.053 | RA | 0.010 |
| 2-33 | PY74 | Syn2-01 | 0.044 | RA | 0.010 |
| 2-34 | PY74 | Syn2-01 | 0.053 | RA | 0.010 |
| 2-35 | PY74 | — | — | — | — |
| 2-36 | PY74 | — | — | RA | 0.010 |
| 2-37 | (PY13) | Syn2-01 | 0.053 | RA | 0.010 |
| 2-38 | PY74 | Comparative | 0.053 | RA | 0.010 |
| | | compound 2-1 | | | |
| 2-39 | PY74 | Comparative | 0.053 | RA | 0.010 |
| | | compound 2-2 | | | |

### <Synthesis of Resin>

### (Resin 1)

200.0 Parts of isopropanol was loaded into a flask including a stirrer, a nitrogen-introducing tube, a reflux condenser, and a temperature gauge. After that, under a nitrogen atmosphere, a temperature in the flask was increased to 85° C. under stirring. A mixture of 60.0 parts of styrene, 20.0 parts of n-butyl acrylate, 20.0 parts of acrylic acid, and 5.0 parts of a polymerization initiator was added dropwise into the flask over 2 hours while the inside of the system was maintained at 85° C.

A solution obtained by dissolving 5.0 parts of a product available under the product name “Perkadox L-W75 (LS)” (dibenzoyl peroxide, manufactured by Kayaku Akzo Co., Ltd., purity: 75%) in 10.0 parts of isopropanol was used as the polymerization initiator. While the inside of the system was maintained at 85° C., the mixture was stirred for 4 hours to synthesize a resin 1. Potassium hydroxide in an amount of 0.9 times (molar basis) the acid value of the resin and an appropriate amount of ion-exchanged water were added, and then isopropanol was removed under reduced pressure. Thus, a liquid containing the resin 1 having a resin content of 18.0% was obtained.

### (Resin 2)

A commercially available polymer dispersant (product name: “Solsperse 17000”, manufactured by Lubrizol Japan Limited) was used as a resin 2. In the resin 2, the content of the resin is 100.0%.

### <Preparation of Pigment Dispersion Liquid>

### (Pigment Dispersion Liquids 1-1 to 1-37 and 2-1 to 2-39)

A pigment composition, a resin (liquid containing the resin), and a liquid medium whose kinds and usage amounts were shown in Tables 1-4 and 2-4 were mixed and subjected to dispersion treatment at a treatment pressure of 200 MPa with a homogenizer (product name: “Starburst”, manufactured by Sugino Machine Limited). After that, an appropriate amount of ion-exchanged water was added to the mixture to provide each of pigment dispersion liquids 1-1 to 1-37 and 2-1 to 2-39 each having a pigment content (including a pigment derivative and a rosin) of 15.0%.

### (Pigment Dispersion Liquids 1-38, 1-39, 2-40, and 2-41)

Pigment dispersion liquids 1-38, 1-39, 2-40, and 2-41 each having a pigment content (including a pigment derivative and a rosin) of 15.0% were each obtained in the same manner as in the case of each of the pigment dispersion liquids 1-1 to 1-37 and 2-1 to 2-39 described above except that, after the dispersion treatment, an appropriate amount of isopropyl palmitate was added instead of the appropriate amount of ion-exchanged water. In each of Tables 1-4 and 2-4, “IPP” means isopropyl palmitate.

TABLE 1-4
Preparation of pigment dispersion liquid

| | Pigment composition | | Resin | | Liquid medium | |
|---|---|---|---|---|---|---|
| Pigment | | Usage | | Usage | | Usage |
| dispersion | | amount | | amount | | amount |
| liquid | Kind | (part(s)) | Kind | (part(s)) | Kind | (part(s)) |
| 1-1 | 1-1 | 18.0 | 1 | 30.0 | Ion-exchanged water | 52.0 |
| 1-2 | 1-2 | 18.0 | 1 | 30.0 | Ion-exchanged water | 52.0 |
| 1-3 | 1-3 | 18.0 | 1 | 30.0 | Ion-exchanged water | 52.0 |
| 1-4 | 1-4 | 18.0 | 1 | 30.0 | Ion-exchanged water | 52.0 |
| 1-5 | 1-5 | 18.0 | 1 | 30.0 | Ion-exchanged water | 52.0 |
| 1-6 | 1-6 | 18.0 | 1 | 30.0 | Ion-exchanged water | 52.0 |
| 1-7 | 1-7 | 18.0 | 1 | 30.0 | Ion-exchanged water | 52.0 |
| 1-8 | 1-8 | 18.0 | 1 | 30.0 | Ion-exchanged water | 52.0 |
| 1-9 | 1-9 | 18.0 | 1 | 30.0 | Ion-exchanged water | 52.0 |
| 1-10 | 1-10 | 18.0 | 1 | 30.0 | Ion-exchanged water | 52.0 |
| 1-11 | 1-11 | 18.0 | 1 | 30.0 | Ion-exchanged water | 52.0 |
| 1-12 | 1-12 | 18.0 | 1 | 30.0 | Ion-exchanged water | 52.0 |
| 1-13 | 1-13 | 18.0 | 1 | 30.0 | Ion-exchanged water | 52.0 |
| 1-14 | 1-14 | 18.0 | 1 | 30.0 | Ion-exchanged water | 52.0 |
| 1-15 | 1-15 | 18.0 | 1 | 30.0 | Ion-exchanged water | 52.0 |
| 1-16 | 1-16 | 18.0 | 1 | 30.0 | Ion-exchanged water | 52.0 |
| 1-17 | 1-17 | 18.0 | 1 | 30.0 | Ion-exchanged water | 52.0 |
| 1-18 | 1-18 | 18.0 | 1 | 30.0 | Ion-exchanged water | 52.0 |
| 1-19 | 1-19 | 18.0 | 1 | 30.0 | Ion-exchanged water | 52.0 |
| 1-20 | 1-20 | 18.0 | 1 | 30.0 | Ion-exchanged water | 52.0 |
| 1-21 | 1-21 | 18.0 | 1 | 30.0 | Ion-exchanged water | 52.0 |
| 1-22 | 1-22 | 18.0 | 1 | 30.0 | Ion-exchanged water | 52.0 |
| 1-23 | 1-23 | 18.0 | 1 | 30.0 | Ion-exchanged water | 52.0 |
| 1-24 | 1-24 | 18.0 | 1 | 30.0 | Ion-exchanged water | 52.0 |
| 1-25 | 1-25 | 18.0 | 1 | 30.0 | Ion-exchanged water | 52.0 |
| 1-26 | 1-26 | 18.0 | 1 | 30.0 | Ion-exchanged water | 52.0 |
| 1-27 | 1-27 | 18.0 | 1 | 30.0 | Ion-exchanged water | 52.0 |
| 1-28 | 1-28 | 18.0 | 1 | 30.0 | Ion-exchanged water | 52.0 |
| 1-29 | 1-29 | 18.0 | 1 | 30.0 | Ion-exchanged water | 52.0 |
| 1-30 | 1-30 | 18.0 | 1 | 30.0 | Ion-exchanged water | 52.0 |
| 1-31 | 1-31 | 18.0 | 1 | 30.0 | Ion-exchanged water | 52.0 |
| 1-32 | 1-32 | 18.0 | 1 | 30.0 | Ion-exchanged water | 52.0 |
| 1-33 | 1-33 | 18.0 | 1 | 30.0 | Ion-exchanged water | 52.0 |
| 1-34 | 1-34 | 18.0 | 1 | 30.0 | Ion-exchanged water | 52.0 |
| 1-35 | 1-35 | 18.0 | 1 | 30.0 | Ion-exchanged water | 52.0 |
| 1-36 | 1-36 | 18.0 | 1 | 30.0 | Ion-exchanged water | 52.0 |
| 1-37 | 1-37 | 18.0 | 1 | 30.0 | Ion-exchanged water | 52.0 |
| 1-38 | 1-5 | 20.0 | 2 | 6.0 | IPP | 74.0 |
| 1-39 | 1-35 | 20.0 | 2 | 6.0 | IPP | 74.0 |

TABLE 2-4
Preparation of pigment dispersion liquid

| | Pigment composition | | Resin | | Liquid medium | |
|---|---|---|---|---|---|---|
| Pigment | | Usage | | Usage | | Usage |
| dispersion | | amount | | amount | | amount |
| liquid | Kind | (part(s)) | Kind | (part(s)) | Kind | (part(s)) |
| 2-1 | 2-1 | 18.0 | 1 | 30.0 | Ion-exchanged water | 52.0 |
| 2-2 | 2-2 | 18.0 | 1 | 30.0 | Ion-exchanged water | 52.0 |
| 2-3 | 2-3 | 18.0 | 1 | 30.0 | Ion-exchanged water | 52.0 |
| 2-4 | 2-4 | 18.0 | 1 | 30.0 | Ion-exchanged water | 52.0 |
| 2-5 | 2-5 | 18.0 | 1 | 30.0 | Ion-exchanged water | 52.0 |
| 2-6 | 2-6 | 18.0 | 1 | 30.0 | Ion-exchanged water | 52.0 |
| 2-7 | 2-7 | 18.0 | 1 | 30.0 | Ion-exchanged water | 52.0 |
| 2-8 | 2-8 | 18.0 | 1 | 30.0 | Ion-exchanged water | 52.0 |
| 2-9 | 2-9 | 18.0 | 1 | 30.0 | Ion-exchanged water | 52.0 |
| 2-10 | 2-10 | 18.0 | 1 | 30.0 | Ion-exchanged water | 52.0 |
| 2-11 | 2-11 | 18.0 | 1 | 30.0 | Ion-exchanged water | 52.0 |
| 2-12 | 2-12 | 18.0 | 1 | 30.0 | Ion-exchanged water | 52.0 |
| 2-13 | 2-13 | 18.0 | 1 | 30.0 | Ion-exchanged water | 52.0 |
| 2-14 | 2-14 | 18.0 | 1 | 30.0 | Ion-exchanged water | 52.0 |
| 2-15 | 2-15 | 18.0 | 1 | 30.0 | Ion-exchanged water | 52.0 |
| 2-16 | 2-16 | 18.0 | 1 | 30.0 | Ion-exchanged water | 52.0 |
| 2-17 | 2-17 | 18.0 | 1 | 30.0 | Ion-exchanged water | 52.0 |
| 2-18 | 2-18 | 18.0 | 1 | 30.0 | Ion-exchanged water | 52.0 |
| 2-19 | 2-19 | 18.0 | 1 | 30.0 | Ion-exchanged water | 52.0 |
| 2-20 | 2-20 | 18.0 | 1 | 30.0 | Ion-exchanged water | 52.0 |
| 2-21 | 2-21 | 18.0 | 1 | 30.0 | Ion-exchanged water | 52.0 |
| 2-22 | 2-22 | 18.0 | 1 | 30.0 | Ion-exchanged water | 52.0 |
| 2-23 | 2-23 | 18.0 | 1 | 30.0 | Ion-exchanged water | 52.0 |
| 2-24 | 2-24 | 18.0 | 1 | 30.0 | Ion-exchanged water | 52.0 |
| 2-25 | 2-25 | 18.0 | 1 | 30.0 | Ion-exchanged water | 52.0 |
| 2-26 | 2-26 | 18.0 | 1 | 30.0 | Ion-exchanged water | 52.0 |
| 2-27 | 2-27 | 18.0 | 1 | 30.0 | Ion-exchanged water | 52.0 |
| 2-28 | 2-28 | 18.0 | 1 | 30.0 | Ion-exchanged water | 52.0 |
| 2-29 | 2-29 | 18.0 | 1 | 30.0 | Ion-exchanged water | 52.0 |
| 2-30 | 2-30 | 18.0 | 1 | 30.0 | Ion-exchanged water | 52.0 |
| 2-31 | 2-31 | 18.0 | 1 | 30.0 | Ion-exchanged water | 52.0 |
| 2-32 | 2-32 | 18.0 | 1 | 30.0 | Ion-exchanged water | 52.0 |
| 2-33 | 2-33 | 18.0 | 1 | 30.0 | Ion-exchanged water | 52.0 |
| 2-34 | 2-34 | 18.0 | 1 | 30.0 | Ion-exchanged water | 52.0 |
| 2-35 | 2-35 | 18.0 | 1 | 30.0 | Ion-exchanged water | 52.0 |
| 2-36 | 2-36 | 18.0 | 1 | 30.0 | Ion-exchanged water | 52.0 |
| 2-37 | 2-37 | 18.0 | 1 | 30.0 | Ion-exchanged water | 52.0 |
| 2-38 | 2-38 | 18.0 | 1 | 30.0 | Ion-exchanged water | 52.0 |
| 2-39 | 2-39 | 18.0 | 1 | 30.0 | Ion-exchanged water | 52.0 |
| 2-40 | 2-5 | 20.0 | 2 | 6.0 | IPP | 74.0 |
| 2-41 | 2-36 | 20.0 | 2 | 6.0 | IPP | 74.0 |

### <Preparation of Ink>

Inks were each prepared by mixing and sufficiently stirring components (unit: part(s)) shown in each of Tables 1-5 to 1-8 and 2-5 to 2-9, followed by filtration with a microfilter having a pore size of 2.5 μm (manufactured by FUJIFILM Corporation) under pressure. In each of Tables 1-5 to 1-8 and 2-5 to 2-9, “Acetylenol E100” is the product name of a nonionic surfactant manufactured by Kawaken Fine Chemicals Co., Ltd. In addition, “AF Solvent No. 4” is the product name of a non-polar organic solvent manufactured by ENEOS Corporation.

TABLE 1-5
Composition and characteristics of ink

| | | Example | | | | | | | | | |
|---|---|---|---|---|---|---|---|---|---|---|---|
| | | 1-1 | 1-2 | 1-3 | 1-4 | 1-5 | 1-6 | 1-7 | 1-8 | 1-9 | 1-10 |
| Kind of pigment dispersion liquid | | 1-1 | 1-2 | 1-3 | 1-4 | 1-5 | 1-6 | 1-7 | 1-8 | 1-9 | 1-10 |
| Pigment dispersion liquid | | 30.0 | 30.0 | 30.0 | 30.0 | 30.0 | 30.0 | 30.0 | 30.0 | 30.0 | 30.0 |
| Glycerin | | 7.0 | 7.0 | 7.0 | 7.0 | 7.0 | 7.0 | 7.0 | 7.0 | 7.0 | 7.0 |
| Triethylene glycol | | 2.0 | 2.0 | 2.0 | 2.0 | 2.0 | 2.0 | 2.0 | 2.0 | 2.0 | 2.0 |
| 2-Pyrrolidone | | 2.0 | 2.0 | 2.0 | 2.0 | 2.0 | 2.0 | 2.0 | 2.0 | 2.0 | 2.0 |
| Triethylene glycol monobutyl | | 2.0 | 2.0 | 2.0 | 2.0 | 2.0 | 2.0 | 2.0 | 2.0 | 2.0 | 2.0 |
| ether | | | | | | | | | | | |
| Acetylenol E100 | | 1.0 | 1.0 | 1.0 | 1.0 | 1.0 | 1.0 | 1.0 | 1.0 | 1.0 | 1.0 |
| Ion-exchanged water | | 56.0 | 56.0 | 56.0 | 56.0 | 56.0 | 56.0 | 56.0 | 56.0 | 56.0 | 56.0 |
| Isopropyl palmitate | | | | | | | | | | | |
| Octadecanol | | | | | | | | | | | |
| AF Solvent No. 4 | | | | | | | | | | | |
| Yellow | Kind | PY74 | PY74 | PY74 | PY74 | PY74 | PY74 | PY74 | PY74 | PY74 | PY74 |
| monoazo | Content A (%) | 4.25 | 4.25 | 4.23 | 4.23 | 4.23 | 4.23 | 4.23 | 4.23 | 4.23 | 4.23 |
| pigment | | | | | | | | | | | |
| Specific | Kind | Syn1-01 | Syn1-01 | Syn1-01 | Syn1-01 | Syn1-01 | Syn1-01 | Syn1-02 | Syn1-03 | Syn1-11 | Syn1-12 |
| pigment | Content B (%) | 0.209 | 0.209 | 0.225 | 0.225 | 0.225 | 0.225 | 0.225 | 0.225 | 0.225 | 0.225 |
| derivative | Mass ratio B/A | 0.049 | 0.049 | 0.053 | 0.053 | 0.053 | 0.053 | 0.053 | 0.053 | 0.053 | 0.053 |
| Rosin | Kind | RA | RA | RA | RA | RA | RA | RA | RA | RA | RA |
| | Content C (%) | 0.043 | 0.043 | 0.042 | 0.042 | 0.042 | 0.042 | 0.042 | 0.042 | 0.042 | 0.042 |
| | Mass ratio C/A | 0.010 | 0.010 | 0.010 | 0.010 | 0.010 | 0.010 | 0.010 | 0.010 | 0.010 | 0.010 |

TABLE 1-6
Composition and characteristics of ink

| | | Example | | | | | | | | | |
|---|---|---|---|---|---|---|---|---|---|---|---|
| | | 1-11 | 1-12 | 1-13 | 1-14 | 1-15 | 1-16 | 1-17 | 1-18 | 1-19 | 1-20 |
| Kind of pigment dispersion liquid | | 1-11 | 1-12 | 1-13 | 1-14 | 1-15 | 1-16 | 1-17 | 1-18 | 1-19 | 1-20 |
| Pigment dispersion liquid | | 30.0 | 30.0 | 30.0 | 30.0 | 30.0 | 30.0 | 30.0 | 30.0 | 30.0 | 30.0 |
| Glycerin | | 7.0 | 7.0 | 7.0 | 7.0 | 7.0 | 7.0 | 7.0 | 7.0 | 7.0 | 7.0 |
| Triethylene glycol | | 2.0 | 2.0 | 2.0 | 2.0 | 2.0 | 2.0 | 2.0 | 2.0 | 2.0 | 2.0 |
| 2-Pyrrolidone | | 2.0 | 2.0 | 2.0 | 2.0 | 2.0 | 2.0 | 2.0 | 2.0 | 2.0 | 2.0 |
| Triethylene glycol monobutyl ether | | 2.0 | 2.0 | 2.0 | 2.0 | 2.0 | 2.0 | 2.0 | 2.0 | 2.0 | 2.0 |
| Acetylenol E100 | | 1.0 | 1.0 | 1.0 | 1.0 | 1.0 | 1.0 | 1.0 | 1.0 | 1.0 | 1.0 |
| Ion-exchanged water | | 56.0 | 56.0 | 56.0 | 56.0 | 56.0 | 56.0 | 56.0 | 56.0 | 56.0 | 56.0 |
| Isopropyl palmitate | | | | | | | | | | | |
| Octadecanol | | | | | | | | | | | |
| AF Solvent No. 4 | | | | | | | | | | | |
| Yellow | Kind | PY74 | PY74 | PY74 | PY74 | PY74 | PY74 | PY74 | PY74 | PY74 | PY74 |
| monoazo | Content A (%) | 4.23 | 4.23 | 4.23 | 4.23 | 4.23 | 4.23 | 4.23 | 4.23 | 4.23 | 4.23 |
| pigment | | | | | | | | | | | |
| Specific | Kind | Syn1-17 | Syn1-19 | Syn1-22 | Syn1-23 | Syn1-26 | Syn1-27 | Syn1-29 | Syn1-36 | Syn1-37 | Syn1-38 |
| pigment | Content B (%) | 0.225 | 0.225 | 0.225 | 0.225 | 0.225 | 0.225 | 0.225 | 0.225 | 0.225 | 0.225 |
| derivative | Mass ratio B/A | 0.053 | 0.053 | 0.053 | 0.053 | 0.053 | 0.053 | 0.053 | 0.053 | 0.053 | 0.053 |
| Rosin | Kind | RA | RA | RA | RA | RA | RA | RA | RA | RA | RA |
| | Content C (%) | 0.042 | 0.042 | 0.042 | 0.042 | 0.042 | 0.042 | 0.042 | 0.042 | 0.042 | 0.042 |
| | Mass ratio C/A | 0.010 | 0.010 | 0.010 | 0.010 | 0.010 | 0.010 | 0.010 | 0.010 | 0.010 | 0.010 |

TABLE 1-7
Composition and characteristics of ink

| | | Example | | | | | | | | | |
|---|---|---|---|---|---|---|---|---|---|---|---|
| | | 1-21 | 1-22 | 1-23 | 1-24 | 1-25 | 1-26 | 1-27 | 1-28 | 1-29 | 1-30 |
| Kind of pigment dispersion | | 1-21 | 1-22 | 1-23 | 1-24 | 1-25 | 1-26 | 1-27 | 1-28 | 1-29 | 1-30 |
| liquid | | | | | | | | | | | |
| Pigment dispersion liquid | | 30.0 | 30.0 | 30.0 | 30.0 | 30.0 | 30.0 | 30.0 | 30.0 | 30.0 | 30.0 |
| Glycerin | | 7.0 | 7.0 | 7.0 | 7.0 | 7.0 | 7.0 | 7.0 | 7.0 | 7.0 | 7.0 |
| Triethylene glycol | | 2.0 | 2.0 | 2.0 | 2.0 | 2.0 | 2.0 | 2.0 | 2.0 | 2.0 | 2.0 |
| 2-Pyrrolidone | | 2.0 | 2.0 | 2.0 | 2.0 | 2.0 | 2.0 | 2.0 | 2.0 | 2.0 | 2.0 |
| Triethylene glycol monobutyl | | 2.0 | 2.0 | 2.0 | 2.0 | 2.0 | 2.0 | 2.0 | 2.0 | 2.0 | 2.0 |
| ether | | | | | | | | | | | |
| Acetylenol E100 | | 1.0 | 1.0 | 1.0 | 1.0 | 1.0 | 1.0 | 1.0 | 1.0 | 1.0 | 1.0 |
| Ion-exchanged water | | 56.0 | 56.0 | 56.0 | 56.0 | 56.0 | 56.0 | 56.0 | 56.0 | 56.0 | 56.0 |
| Isopropyl palmitate | | | | | | | | | | | |
| Octadecanol | | | | | | | | | | | |
| AF Solvent No. 4 | | | | | | | | | | | |
| Yellow | Kind | PY74 | PY74 | PY74 | PY74 | PY74 | PY74 | PY74 | PY74 | PY74 | PY74 |
| monoazo | Content A (%) | 4.23 | 4.23 | 4.45 | 4.05 | 3.88 | 4.11 | 4.28 | 4.28 | 4.27 | 4.07 |
| pigment | | | | | | | | | | | |
| Specific | Kind | Syn1-39 | Syn1-43 | Syn1-01 | Syn1-01 | Syn1-01 | Syn1-01 | Syn1-01 | Syn1-01 | Syn1-01 | Syn1-01 |
| pigment | Content B (%) | 0.225 | 0.225 | 0.005 | 0.405 | 0.585 | 0.225 | 0.218 | 0.225 | 0.225 | 0.226 |
| derivative | Mass ratio B/A | 0.053 | 0.053 | 0.001 | 0.100 | 0.151 | 0.055 | 0.051 | 0.053 | 0.053 | 0.055 |
| Rosin | Kind | RA | RA | RA | RA | RA | HR | — | — | RA | RA |
| | Content C (%) | 0.042 | 0.042 | 0.045 | 0.041 | 0.039 | 0.164 | — | — | 0.004 | 0.204 |
| | Mass ratio C/A | 0.010 | 0.010 | 0.010 | 0.010 | 0.010 | 0.040 | — | — | 0.001 | 0.050 |

TABLE 1-8
Composition and characteristics of ink

| | | Example | | | | Comparative Example | | | | |
|---|---|---|---|---|---|---|---|---|---|---|
| | | 1-31 | 1-32 | 1-33 | 1-34 | 1-1 | 1-2 | 1-3 | 1-4 | 1-5 |
| Kind of pigment dispersion | | 1-31 | 1-32 | 1-33 | 1-38 | 1-34 | 1-35 | 1-36 | 1-37 | 1-39 |
| liquid | | | | | | | | | | |
| Pigment dispersion liquid | | 30.0 | 30.0 | 30.0 | 25.0 | 30.0 | 30.0 | 30.0 | 30.0 | 25.0 |
| Glycerin | | 7.0 | 7.0 | 7.0 | | 7.0 | 7.0 | 7.0 | 7.0 | |
| Triethylene glycol | | 2.0 | 2.0 | 2.0 | | 2.0 | 2.0 | 2.0 | 2.0 | |
| 2-Pyrrolidone | | 2.0 | 2.0 | 2.0 | | 2.0 | 2.0 | 2.0 | 2.0 | |
| Triethylene glycol monobutyl | | 2.0 | 2.0 | 2.0 | | 2.0 | 2.0 | 2.0 | 2.0 | |
| ether | | | | | | | | | | |
| Acetylenol E100 | | 1.0 | 1.0 | 1.0 | | 1.0 | 1.0 | 1.0 | 1.0 | |
| Ion-exchanged water | | 56.0 | 56.0 | 56.0 | | 56.0 | 56.0 | 56.0 | 56.0 | |
| Isopropyl palmitate | | | | | 30.0 | | | | | 30.0 |
| Octadecanol | | | | | 18.0 | | | | | 18.0 |
| AF Solvent No. 4 | | | | | 27.0 | | | | | 27.0 |
| Yellow | Kind | PY74 | PY73 | PY3 | PY74 | PY74 | PY74 | PY74 | PY74 | PY74 |
| monoazo | Content A (%) | 3.99 | 4.23 | 4.23 | 3.53 | 4.50 | 4.46 | 4.23 | 4.23 | 3.71 |
| pigment | | | | | | | | | | |
| Specific | Kind | Syn1-01 | Syn1-01 | Syn1-32 | Syn1-01 | — | — | Comparative | Comparative | — |
| pigment | | | | | | | | compound 1-1 | compound 1-2 | |
| derivative | Content B (%) | 0.226 | 0.225 | 0.225 | 0.188 | — | — | 0.225 | 0.225 | — |
| | Mass ratio | 0.057 | 0.053 | 0.053 | 0.053 | — | — | 0.053 | 0.053 | — |
| | B/A | | | | | | | | | |
| Rosin | Kind | RA | RA | RA | RA | — | RA | RA | RA | RA |
| | Content C (%) | 0.280 | 0.042 | 0.042 | 0.035 | — | 0.045 | 0.042 | 0.042 | 0.037 |
| | Mass ratio | 0.070 | 0.010 | 0.010 | 0.010 | — | 0.010 | 0.010 | 0.010 | 0.010 |
| | C/A | | | | | | | | | |

TABLE 2-5
Composition and characteristics of ink

| | | Example | | | | | | | | |
|---|---|---|---|---|---|---|---|---|---|---|
| | | 2-1 | 2-2 | 2-3 | 2-4 | 2-5 | 2-6 | 2-7 | 2-8 | 2-9 |
| Kind of pigment dispersion | | 2-1 | 2-33 | 2-3 | 2-4 | 2-5 | 2-34 | 2-14 | 2-15 | 2-16 |
| liquid | | | | | | | | | | |
| Pigment dispersion liquid | | 30.0 | 30.0 | 30.0 | 30.0 | 30.0 | 30.0 | 30.0 | 30.0 | 30.0 |
| Glycerin | | 7.0 | 7.0 | 7.0 | 7.0 | 7.0 | 7.0 | 7.0 | 7.0 | 7.0 |
| Triethylene glycol | | 2.0 | 2.0 | 2.0 | 2.0 | 2.0 | 2.0 | 2.0 | 2.0 | 2.0 |
| 2-Pyrrolidone | | 2.0 | 2.0 | 2.0 | 2.0 | 2.0 | 2.0 | 2.0 | 2.0 | 2.0 |
| Triethylene glycol monobutyl | | 2.0 | 2.0 | 2.0 | 2.0 | 2.0 | 2.0 | 2.0 | 2.0 | 2.0 |
| ether | | | | | | | | | | |
| Acetylenol E100 | | 1.0 | 1.0 | 1.0 | 1.0 | 1.0 | 1.0 | 1.0 | 1.0 | 1.0 |
| Ion-exchanged water | | 56.0 | 56.0 | 56.0 | 56.0 | 56.0 | 56.0 | 56.0 | 56.0 | 56.0 |
| Isopropyl palmitate | | | | | | | | | | |
| Octadecanol | | | | | | | | | | |
| AF Solvent No. 4 | | | | | | | | | | |
| Yellow | Kind | PY74 | PY74 | PY74 | PY74 | PY74 | PY74 | PY74 | PY74 | PY74 |
| monoazo | Content A (%) | 4.27 | 4.27 | 4.23 | 4.23 | 4.23 | 4.23 | 4.23 | 4.23 | 4.23 |
| pigment | | | | | | | | | | |
| Pigment | Kind | Syn2-01 | Syn2-01 | Syn2-01 | Syn2-01 | Syn2-01 | Syn2-01 | Syn2-02 | Syn2-08 | Syn2-09 |
| derivative | Content B (%) | 0.188 | 0.188 | 0.225 | 0.225 | 0.225 | 0.225 | 0.225 | 0.225 | 0.225 |
| | Mass ratio B/A | 0.044 | 0.044 | 0.053 | 0.053 | 0.053 | 0.053 | 0.053 | 0.053 | 0.053 |
| Rosin | Kind | RA | RA | RA | RA | RA | RA | RA | RA | RA |
| | Content C (%) | 0.043 | 0.043 | 0.042 | 0.042 | 0.042 | 0.042 | 0.042 | 0.042 | 0.042 |
| | Mass ratio C/A | 0.010 | 0.010 | 0.010 | 0.010 | 0.010 | 0.010 | 0.010 | 0.010 | 0.010 |

TABLE 2-6
Composition and characteristics of ink

| | | Example | | | | | | | | |
|---|---|---|---|---|---|---|---|---|---|---|
| | | 2-10 | 2-11 | 2-12 | 2-13 | 2-14 | 2-15 | 2-16 | 2-17 | 2-18 |
| Kind of pigment dispersion | | 2-17 | 2-18 | 2-19 | 2-20 | 2-21 | 2-22 | 2-23 | 2-24 | 2-25 |
| liquid | | | | | | | | | | |
| Pigment dispersion liquid | | 30.0 | 30.0 | 30.0 | 30.0 | 30.0 | 30.0 | 30.0 | 30.0 | 30.0 |
| Glycerin | | 7.0 | 7.0 | 7.0 | 7.0 | 7.0 | 7.0 | 7.0 | 7.0 | 7.0 |
| Triethylene glycol | | 2.0 | 2.0 | 2.0 | 2.0 | 2.0 | 2.0 | 2.0 | 2.0 | 2.0 |
| 2-Pyrrolidone | | 2.0 | 2.0 | 2.0 | 2.0 | 2.0 | 2.0 | 2.0 | 2.0 | 2.0 |
| Triethylene glycol monobutyl | | 2.0 | 2.0 | 2.0 | 2.0 | 2.0 | 2.0 | 2.0 | 2.0 | 2.0 |
| ether | | | | | | | | | | |
| Acetylenol E100 | | 1.0 | 1.0 | 1.0 | 1.0 | 1.0 | 1.0 | 1.0 | 1.0 | 1.0 |
| Ion-exchanged water | | 56.0 | 56.0 | 56.0 | 56.0 | 56.0 | 56.0 | 56.0 | 56.0 | 56.0 |
| Isopropyl palmitate | | | | | | | | | | |
| Octadecanol | | | | | | | | | | |
| AF Solvent No. 4 | | | | | | | | | | |
| Yellow | Kind | PY74 | PY74 | PY74 | PY74 | PY74 | PY74 | PY74 | PY74 | PY74 |
| monoazo | Content A (%) | 4.23 | 4.23 | 4.23 | 4.23 | 4.23 | 4.23 | 4.23 | 4.23 | 4.23 |
| pigment | | | | | | | | | | |
| Pigment | Kind | Syn2-10 | Syn2-12 | Syn2-13 | Syn2-16 | Syn2-19 | Syn2-22 | Syn2-25 | Syn2-29 | Syn2-31 |
| derivative | Content B (%) | 0.225 | 0.225 | 0.225 | 0.225 | 0.225 | 0.225 | 0.225 | 0.225 | 0.225 |
| | Mass ratio B/A | 0.053 | 0.053 | 0.053 | 0.053 | 0.053 | 0.053 | 0.053 | 0.053 | 0.053 |
| Rosin | Kind | RA | RA | RA | RA | RA | RA | RA | RA | RA |
| | Content C (%) | 0.042 | 0.042 | 0.042 | 0.042 | 0.042 | 0.042 | 0.042 | 0.042 | 0.042 |
| | Mass ratio C/A | 0.010 | 0.010 | 0.010 | 0.010 | 0.010 | 0.010 | 0.010 | 0.010 | 0.010 |

TABLE 2-7
Composition and characteristics of ink

| | | Example | | | | | | | | |
|---|---|---|---|---|---|---|---|---|---|---|
| | | 2-19 | 2-20 | 2-21 | 2-22 | 2-23 | 2-24 | 2-25 | 2-26 | 2-27 |
| Kind of pigment dispersion liquid | | 2-26 | 2-27 | 2-28 | 2-29 | 2-30 | 2-6 | 2-7 | 2-8 | 2-12 |
| Pigment dispersion liquid | | 30.0 | 30.0 | 30.0 | 30.0 | 30.0 | 30.0 | 30.0 | 30.0 | 30.0 |
| Glycerin | | 7.0 | 7.0 | 7.0 | 7.0 | 7.0 | 7.0 | 7.0 | 7.0 | 7.0 |
| Triethylene glycol | | 2.0 | 2.0 | 2.0 | 2.0 | 2.0 | 2.0 | 2.0 | 2.0 | 2.0 |
| 2-Pyrrolidone | | 2.0 | 2.0 | 2.0 | 2.0 | 2.0 | 2.0 | 2.0 | 2.0 | 2.0 |
| Triethylene glycol monobutyl | | 2.0 | 2.0 | 2.0 | 2.0 | 2.0 | 2.0 | 2.0 | 2.0 | 2.0 |
| ether | | | | | | | | | | |
| Acetylenol E100 | | 1.0 | 1.0 | 1.0 | 1.0 | 1.0 | 1.0 | 1.0 | 1.0 | 1.0 |
| Ion-exchanged water | | 56.0 | 56.0 | 56.0 | 56.0 | 56.0 | 56.0 | 56.0 | 56.0 | 56.0 |
| Isopropyl palmitate | | | | | | | | | | |
| Octadecanol | | | | | | | | | | |
| AF Solvent No. 4 | | | | | | | | | | |
| Yellow | Kind | PY74 | PY74 | PY74 | PY74 | PY74 | PY74 | PY74 | PY74 | PY74 |
| monoazo | Content A (%) | 4.23 | 4.23 | 4.23 | 4.23 | 4.23 | 4.45 | 4.05 | 3.88 | 4.11 |
| pigment | | | | | | | | | | |
| Pigment | Kind | Syn2-33 | Syn2-42 | Syn2-43 | Syn2-46 | Syn2-49 | Syn2-01 | Syn2-01 | Syn2-01 | Syn2-01 |
| derivative | Content B (%) | 0.225 | 0.225 | 0.225 | 0.225 | 0.225 | 0.005 | 0.405 | 0.585 | 0.225 |
| | Mass ratio B/A | 0.053 | 0.053 | 0.053 | 0.053 | 0.053 | 0.001 | 0.100 | 0.151 | 0.055 |
| Rosin | Kind | RA | RA | RA | RA | RA | RA | RA | RA | HR |
| | Content C (%) | 0.042 | 0.042 | 0.042 | 0.042 | 0.042 | 0.045 | 0.041 | 0.039 | 0.164 |
| | Mass ratio C/A | 0.010 | 0.010 | 0.010 | 0.010 | 0.010 | 0.010 | 0.010 | 0.010 | 0.040 |

TABLE 2-8
Composition and characteristics of ink

| | | Example | | | | | | | |
|---|---|---|---|---|---|---|---|---|---|
| | | 2-28 | 2-29 | 2-30 | 2-31 | 2-32 | 2-33 | 2-34 | 2-35 |
| Kind of pigment dispersion liquid | | 2-1 | 2-13 | 2-9 | 2-10 | 2-11 | 2-31 | 2-32 | 2-40 |
| Pigment dispersion liquid | | 30.0 | 30.0 | 30.0 | 30.0 | 30.0 | 30.0 | 30.0 | 25.0 |
| Glycerin | | 7.0 | 7.0 | 7.0 | 7.0 | 7.0 | 7.0 | 7.0 | |
| Triethylene glycol | | 2.0 | 2.0 | 2.0 | 2.0 | 2.0 | 2.0 | 2.0 | |
| 2-Pyrrolidone | | 2.0 | 2.0 | 2.0 | 2.0 | 2.0 | 2.0 | 2.0 | |
| Triethylene glycol monobutyl ether | | 2.0 | 2.0 | 2.0 | 2.0 | 2.0 | 2.0 | 2.0 | |
| Acetylenol E100 | | 1.0 | 1.0 | 1.0 | 1.0 | 1.0 | 1.0 | 1.0 | |
| Ion-exchanged water | | 56.0 | 56.0 | 56.0 | 56.0 | 56.0 | 56.0 | 56.0 | |
| Isopropyl palmitate | | | | | | | | | 30.0 |
| Octadecanol | | | | | | | | | 18.0 |
| AF Solvent No. 4 | | | | | | | | | 27.0 |
| Yellow | Kind | PY74 | PY74 | PY74 | PY74 | PY74 | PY73 | PY3 | PY74 |
| monoazo | Content A (%) | 4.31 | 4.28 | 4.27 | 4.07 | 3.99 | 4.23 | 4.23 | 3.53 |
| pigment | | | | | | | | | |
| Pigment | Kind | Syn2-01 | Syn2-01 | Syn2-01 | Syn2-01 | Syn2-01 | Syn2-01 | Syn2-34 | Syn2-01 |
| derivative | Content B (%) | 0.186 | 0.225 | 0.225 | 0.226 | 0.226 | 0.225 | 0.225 | 0.188 |
| | Mass ratio B/A | 0.043 | 0.053 | 0.053 | 0.055 | 0.057 | 0.053 | 0.053 | 0.053 |
| Rosin | Kind | — | — | RA | RA | RA | RA | RA | RA |
| | Content C (%) | — | — | 0.004 | 0.204 | 0.280 | 0.042 | 0.042 | 0.035 |
| | Mass ratio C/A | — | — | 0.001 | 0.050 | 0.070 | 0.010 | 0.010 | 0.010 |

TABLE 2-9
Composition and characteristics of ink

| | | Comparative Example | | | | | |
|---|---|---|---|---|---|---|---|
| | | 2-1 | 2-2 | 2-3 | 2-4 | 2-5 | 2-6 |
| Kind of pigment dispersion | | 2-35 | 2-36 | 2-37 | 2-38 | 2-39 | 2-41 |
| liquid | | | | | | | |
| Pigment dispersion liquid | | 30.0 | 30.0 | 30.0 | 30.0 | 30.0 | 25.0 |
| Glycerin | | 7.0 | 7.0 | 7.0 | 7.0 | 7.0 | |
| Triethylene glycol | | 2.0 | 2.0 | 2.0 | 2.0 | 2.0 | |
| 2-Pyrrolidone | | 2.0 | 2.0 | 2.0 | 2.0 | 2.0 | |
| Triethylene glycol | | 2.0 | 2.0 | 2.0 | 2.0 | 2.0 | |
| monobutyl ether | | | | | | | |
| Acetylenol E100 | | 1.0 | 1.0 | 1.0 | 1.0 | 1.0 | |
| Ion-exchanged water | | 56.0 | 56.0 | 56.0 | 56.0 | 56.0 | |
| Isopropyl palmitate | | | | | | | 30.0 |
| Octadecanol | | | | | | | 18.0 |
| AF Solvent No. 4 | | | | | | | 27.0 |
| Yellow | Kind | PY74 | PY74 | (PY13) | PY74 | PY74 | PY74 |
| monoazo | Content A | 4.50 | 4.46 | 4.23 | 4.23 | 4.23 | 3.71 |
| pigment | (%) | | | | | | |
| Pigment | Kind | — | — | Syn2-01 | Comparative | Comparative | — |
| derivative | | | | | compound 2-1 | compound 2-2 | |
| | Content B | — | — | 0.225 | 0.225 | 0.225 | — |
| | (%) | | | | | | |
| | Mass ratio | — | — | 0.053 | 0.053 | 0.053 | — |
| | B/A | | | | | | |
| Rosin | Kind | — | RA | RA | RA | RA | RA |
| | Content C | — | 0.045 | 0.042 | 0.042 | 0.042 | 0.037 |
| | (%) | | | | | | |
| | Mass ratio | — | 0.010 | 0.010 | 0.010 | 0.010 | 0.010 |
| | C/A | | | | | | |

### <Evaluation>

An ink cartridge was filled with each of the inks obtained above, and was mounted on an ink jet recording apparatus (product name: “PIXUS PRO-10S”, manufactured by CANON KABUSHIKI KAISHA) that ejected an ink from a recording head by thermal energy. In this Example, the recording duty of a solid image recorded under the condition of applying eight droplets of 3.8 ng of the ink to a unit area of 1/600 inch× 1/600 inch is defined as 100%. Fourteen kinds of solid images in which the recording duty was changed between 10% and 140% in increments of 10% were recorded on an A4 size recording medium (photo paper, product name: “Canon Photo Paper Glossy Gold GL-101”, manufactured by CANON KABUSHIKI KAISHA) by using the above-mentioned ink jet recording apparatus. After that, the images were dried at 25° C. for 24 hours and used for the following evaluations. In the present disclosure, in the evaluation criteria of each item below, “A” and “B” were defined as acceptable levels, and “C” was defined as an unacceptable level. The evaluation results are shown in Tables 1-9 and 2-10.

### (Particle Diameter)

The particle diameter (volume-based cumulative 50% particle diameter: D₅₀) of the pigment in each of the inks immediately after its preparation was measured in a monodisperse mode with a nanoparticle size analyzer (product name: “Nanotrac Wave”, manufactured by MicrotracBEL Corp.). Then, the particle diameter of the pigment in the ink was evaluated in accordance with the evaluation criteria shown below.
A: The D₅₀ was less than 120 nm.
B: The D₅₀ was 120 nm or more and less than 160 nm.
C: The D₅₀ was 160 nm or more.

### (Color Developability)

The optical density (OD) of the solid image with a recording duty of 100% was measured with a spectrofluorometer (product name: “FD-7”, manufactured by Konica Minolta, Inc.). Then, the color developability of the image was evaluated in accordance with the evaluation criteria shown below. A value defined by ISO Status A was utilized for the optical density.
A: The optical density was 2.0 or more.
B: The optical density was 1.8 or more and less than 2.0.
C: The optical density was less than 1.8.

### (Chroma)

The chroma C* of the solid image with a recording duty of 140% was measured with a spectrofluorometer (product name: “FD-7”, manufactured by Konica Minolta, Inc.). Then, the color developability of the image was evaluated in accordance with the evaluation criteria shown below.
A: The chroma was 112 or more.
B: The chroma was 108 or more and less than 112.
C: The chroma was less than 108.

### (Storage Stability)

The prepared inks were each sealed and stored in a thermostat at 60° C. for 1 month. The particle diameters (volume-based cumulative 50% particle diameters: D₅₀) of the pigment in the ink immediately after its preparation and after its storage were each measured in a monodisperse mode with a nanoparticle size analyzer (product name: “Nanotrac Wave”, manufactured by MicrotracBEL Corp.). Then, a “particle diameter change rate (%) before and after storage” was calculated from the following equation (X), and the storage stability of the ink was evaluated in accordance with the evaluation criteria shown below.

Particle diameter change rate (%) before and after storage={(dₛ−dᵢ)/dᵢ}×100 (X)
dₛ: D₅₀ of pigment in ink after storage
dᵢ: D₅₀ of pigment in ink immediately after preparation
A: The particle diameter change rate before and after storage was less than 50%.
B: The particle diameter change rate before and after storage was 5% or more and less than 10%.
C: The particle diameter change rate before and after storage was 10% or more.

TABLE 1-9

| | | Particle | Color | | Storage |
|---|---|---|---|---|---|
| | | diameter | developability | Chroma | stability |
| Example | 1-1 | A | A | A | A |
| | 1-2 | B | B | B | A |
| | 1-3 | A | A | A | A |
| | 1-4 | B | A | A | A |
| | 1-5 | A | A | A | A |
| | 1-6 | B | B | B | B |
| | 1-7 | A | A | B | A |
| | 1-8 | B | A | B | A |
| | 1-9 | A | A | B | A |
| | 1-10 | A | A | A | A |
| | 1-11 | A | B | B | A |
| | 1-12 | B | A | A | B |
| | 1-13 | B | A | A | B |
| | 1-14 | B | A | A | B |
| | 1-15 | A | B | B | A |
| | 1-16 | A | B | B | A |
| | 1-17 | A | A | B | A |
| | 1-18 | B | A | B | A |
| | 1-19 | B | A | B | B |
| | 1-20 | B | A | B | B |
| Example | 1-21 | B | A | A | B |
| | 1-22 | B | A | A | B |
| | 1-23 | B | A | A | B |
| | 1-24 | A | B | A | A |
| | 1-25 | A | B | B | A |
| | 1-26 | B | A | B | A |
| | 1-27 | B | A | A | A |
| | 1-28 | B | A | A | B |
| | 1-29 | B | A | A | A |
| | 1-30 | A | B | A | A |
| | 1-31 | A | B | B | A |
| | 1-32 | A | A | B | A |
| | 1-33 | A | B | B | A |
| | 1-34 | B | A | A | B |
| Comparative | 1-1 | C | C | C | C |
| Example | 1-2 | C | C | C | C |
| | 1-3 | C | C | C | C |
| | 1-4 | B | C | C | B |
| | 1-5 | C | C | C | C |

TABLE 2-10

| | | Particle | Color | | Storage |
|---|---|---|---|---|---|
| | | diameter | developability | Chroma | stability |
| Example | 2-1 | A | A | A | A |
| | 2-2 | B | B | B | A |
| | 2-3 | A | A | A | A |
| | 2-4 | B | A | A | A |
| | 2-5 | A | A | A | A |
| | 2-6 | B | B | B | B |
| | 2-7 | A | A | B | A |
| | 2-8 | B | B | B | B |
| | 2-9 | A | A | B | A |
| | 2-10 | A | A | B | A |
| | 2-11 | A | A | A | B |
| | 2-12 | A | A | A | B |
| | 2-13 | B | B | B | A |
| | 2-14 | B | A | A | A |
| | 2-15 | A | B | B | A |
| | 2-16 | B | A | A | B |
| | 2-17 | B | A | A | A |
| | 2-18 | B | A | A | B |
| | 2-19 | B | B | A | A |
| | 2-20 | B | A | B | B |
| | 2-21 | B | A | A | B |
| Example | 2-22 | B | A | A | B |
| | 2-23 | B | A | A | B |
| | 2-24 | B | A | A | B |
| | 2-25 | A | B | A | A |
| | 2-26 | A | B | B | A |
| | 2-27 | B | A | B | A |
| | 2-28 | A | A | A | A |
| | 2-29 | B | A | A | B |
| | 2-30 | B | A | A | A |
| | 2-31 | A | B | A | A |
| | 2-32 | A | B | B | A |
| | 2-33 | A | A | B | A |
| | 2-34 | A | B | B | A |
| | 2-35 | B | A | B | B |
| Comparative | 2-1 | C | C | C | C |
| Example | 2-2 | C | C | C | C |
| | 2-3 | C | C | C | C |
| | 2-4 | C | C | C | C |
| | 2-5 | C | B | B | C |
| | 2-6 | C | C | C | C |

According to the present disclosure, the composition for image recording excellent in storage stability, which is capable of recording an image having high color developability and high chroma, can be provided. In addition, according to the present disclosure, the method of producing a composition for image recording excellent in storage stability, which is capable of recording an image having high color developability and high chroma, can be provided.

The present disclosure is not limited to the above-mentioned embodiments, and various changes and modifications may be made without departing from the spirit and scope of the present disclosure. Accordingly, the following claims are attached to make the scope of the present disclosure public.

While the present disclosure has been described with reference to embodiments, it is to be understood that the present disclosure is not limited to the disclosed embodiments. The scope of the following claims is to be accorded the broadest interpretation so as to encompass all such modifications and equivalent structures and functions.

1. A composition for image recording comprising a pigment composition containing a yellow monoazo pigment and a compound represented by the following general formula (1-1) or (2-1) different from the yellow monoazo pigment: 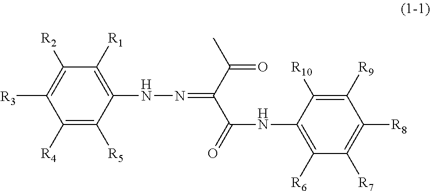
in the general formula (1-1), R₁ to R₁₀ each independently represent a hydrogen atom, an alkyl group, a halogenated alkyl group, an alkoxy group, an acyl group, a halogen atom, a nitro group, an alkoxycarbonyl group, or an acyloxy group, provided that R₃ or R₄ represents a substituent represented by the following general formula (1-2): 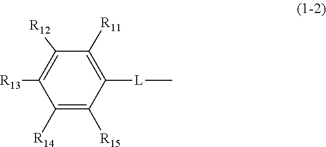
in the general formula (1-2), L represents a single bond, an ether bond (—O—), an ester bond (—O—C(═O)— or —C(═O)—O—), or a carbonyl group (—C(═O)—), and R₁₁ to R₁₅ each independently represent a hydrogen atom, an alkyl group, a halogenated alkyl group, an alkoxy group, a halogen atom, or a nitro group; and 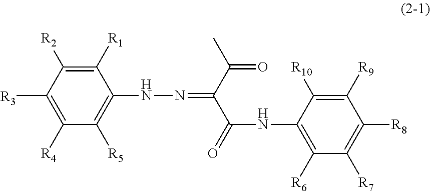
in the general formula (2-1), R₁ to R₅ each independently represent a hydrogen atom, an alkoxy group, or a halogen atom, provided that not more than one of R₁, R₃, and R₄ represents a hydrogen atom, and R₆ to R₁₀ each independently represent a hydrogen atom, an alkyl group, a halogenated alkyl group, an alkoxy group, an acyl group, a halogen atom, a nitro group, an alkoxycarbonyl group, or an acyloxy group, provided that R₆ does not represent a hydrogen atom.

2. The composition for image recording according to claim 1, wherein a content (% by mass) of the compound represented by the general formula (1-1) or (2-1) is 0.001 times or more and 0.100 times or less in terms of mass ratio with respect to a content (% by mass) of the yellow monoazo pigment.

3. The composition for image recording according to claim 1, wherein, in the general formula (1-2), L represents a single bond or an ether bond (—O—).

4. The composition for image recording according to claim 1, wherein, in the general formula (1-1), R₆ represents a methoxy group, and R₇ to R₁₀ each represent a hydrogen atom.

5. The composition for image recording according to claim 1, wherein, in the general formula (2-1), R₆ represents a methoxy group, and R₇ to R₁₀ each represent a hydrogen atom.

6. The composition for image recording according to claim 1, wherein, in the general formula (2-1), R₁ represents a methoxy group, R₃ and R₄ each independently represent a methoxy group or a chlorine atom, and R₂ and R₅ each represent a hydrogen atom.

7. The composition for image recording according to claim 1, wherein the pigment composition is a surface-treated product having a particle surface treated with a rosin.

8. The composition for image recording according to claim 7, wherein a content (% by mass) of the rosin is 0.001 times or more and 0.050 times or less in terms of mass ratio with respect to a content (% by mass) of the yellow monoazo pigment.

9. The composition for image recording according to claim 1, wherein the yellow monoazo pigment is C.I. Pigment Yellow 74.

10. The composition for image recording according to claim 1, wherein the pigment composition is formed by physical adsorption of the compound represented by the general formula (1-1) or (2-1) on a particle surface of the yellow monoazo pigment.

11. The composition for image recording according to claim 1, wherein the composition for image recording is an aqueous ink for ink jet.

12. A method of producing a composition for image recording comprising a pigment composition containing a yellow monoazo pigment and a compound represented by the following general formula (1-1) or (2-1) different from the yellow monoazo pigment,
the method comprising a step of simultaneously synthesizing the yellow monoazo pigment and the compound represented by the following general formula (1-1) or (2-1) by coupling a diazo component mixture (c1) containing a diazo component (a1) and a diazo component (b1) each obtained by converting an aniline derivative into a diazonium salt, and a coupler component (c2) that is an acetoacetanilide derivative to provide a crude product of the pigment composition: 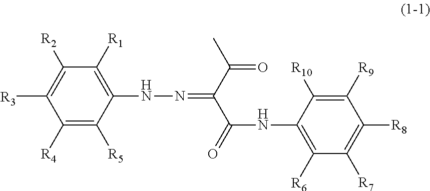
in the general formula (1-1), R₁ to R₁₀ each independently represent a hydrogen atom, an alkyl group, a halogenated alkyl group, an alkoxy group, an acyl group, a halogen atom, a nitro group, an alkoxycarbonyl group, or an acyloxy group, provided that R₃ or R₄ represents a substituent represented by the following general formula (1-2): 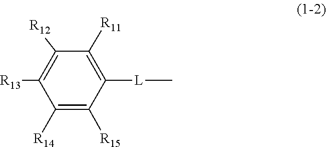
in the general formula (1-2), L represents a single bond, an ether bond (—O—), an ester bond (—O—C(═O)— or —C(═O)—O—), or a carbonyl group (—C(═O)—), and R₁₁ to R₁₅ each independently represent a hydrogen atom, an alkyl group, a halogenated alkyl group, an alkoxy group, a halogen atom, or a nitro group; and 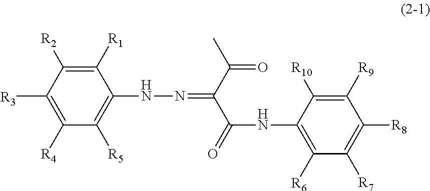
in the general formula (2-1), R₁ to R₅ each independently represent a hydrogen atom, an alkoxy group, or a halogen atom, provided that not more than one of R₁, R₃, and R₄ represents a hydrogen atom, and R₆ to R₁₀ each independently represent a hydrogen atom, an alkyl group, a halogenated alkyl group, an alkoxy group, an acyl group, a halogen atom, a nitro group, an alkoxycarbonyl group, or an acyloxy group, provided that R₆ does not represent a hydrogen atom.

13. The method of producing a composition for image recording according to claim 12, further comprising a step of subjecting the crude product of the pigment composition to solvent salt milling to provide the pigment composition.

14. A method of producing a composition for image recording comprising a pigment composition containing a yellow monoazo pigment and a compound represented by the following general formula (1-1) or (2-1) different from the yellow monoazo pigment, the method comprising a step of subjecting a pretreatment mixture containing a crude product of the yellow monoazo pigment and the compound represented by the following general formula (1-1) or (2-1) to solvent salt milling to provide the pigment composition: 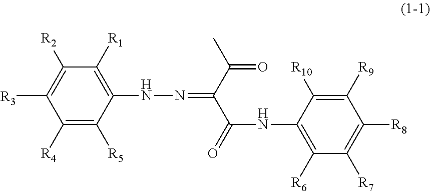
in the general formula (1-1), R₁ to R₁₀ each independently represent a hydrogen atom, an alkyl group, a halogenated alkyl group, an alkoxy group, an acyl group, a halogen atom, a nitro group, an alkoxycarbonyl group, or an acyloxy group, provided that R₃ or R₄ represents a substituent represented by the following general formula (1-2): 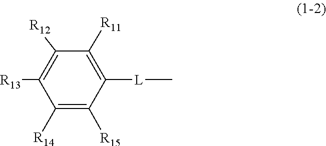
in the general formula (1-2), L represents a single bond, an ether bond (—O—), an ester bond (—O—C(═O)— or —C(═O)—O—), or a carbonyl group (—C(═O)—), and R₁₁ to R₁₅ each independently represent a hydrogen atom, an alkyl group, a halogenated alkyl group, an alkoxy group, a halogen atom, or a nitro group; and 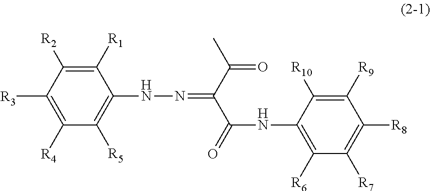
in the general formula (2-1), R₁ to R₅ each independently represent a hydrogen atom, an alkoxy group, or a halogen atom, provided that not more than one of R₁, R₃, and R₄ represents a hydrogen atom, and R₆ to R₁₀ each independently represent a hydrogen atom, an alkyl group, a halogenated alkyl group, an alkoxy group, an acyl group, a halogen atom, a nitro group, an alkoxycarbonyl group, or an acyloxy group, provided that R₆ does not represent a hydrogen atom.

15. The method of producing a composition for image recording according to claim 14, further comprising
a step of dissolving at least part of a crude product mixture containing the crude product of the yellow monoazo pigment and a crude product of the compound represented by the general formula (1-1) or (2-1) in an organic solvent, and
a step of removing at least part of the organic solvent from the crude product mixture to physically adsorb the compound represented by the general formula (1-1) or (2-1) on a particle surface of the yellow monoazo pigment to provide the pretreatment mixture.
